(19) United States
(12) Patent Application Publication
(10) Pub. No.: US 2025/0154323 A1
(43) Pub. Date: May 15, 2025

(54) THIONOLACTONES AS ADDITIVES FOR VINYL NETWORK DEGRADATION

(71) Applicant: Massachusetts Institute of Technology, Cambridge, MA (US)

(72) Inventors: Jeremiah A. Johnson, Boston, MA (US); Peyton Shieh, Cambridge, MA (US); Sipei Li, East Boston, MA (US); Gavin Kiel, Cambridge, MA (US); Elisabeth Prince, Cambridge, MA (US)

(73) Assignee: Massachusetts Institute of Technology, Cambridge, MA (US)

(21) Appl. No.: 18/837,184

(22) PCT Filed: Feb. 8, 2023
(86) PCT No.: PCT/US2023/062223

§ 371 Date: Aug. 8, 2024

Related U.S. Application Data
(60) Provisional application No. 63/308,497, filed on Feb. 10, 2022.
(60) Provisional application No. 63/308,492, filed on Feb. 9, 2022.

(51) Int. Cl. C08G 75/045

(52) U.S. Cl. CPC C08G 75/045

(57) ABSTRACT

The introduction of low levels of cleavable comonomer additives into existing vinyl polymerization processes may facilitate the production of chemically deconstructable and recyclable variants with otherwise equivalent properties. The present disclosure describes cleavable comonomer approach as a viable strategy toward circular vinyl polymers. The present disclosure describes copolymers comprising m1 instances of the first repeating unit of Formula (i); m2 instances of the second repeating unit of Formula (ii-A) or (ii-B); and optionally one or more types of additional repeating units. The disclosure also provides compounds of the formula: or a tautomer or salt thereof. The present disclosure further describes methods of preparation, compositions, and kits.

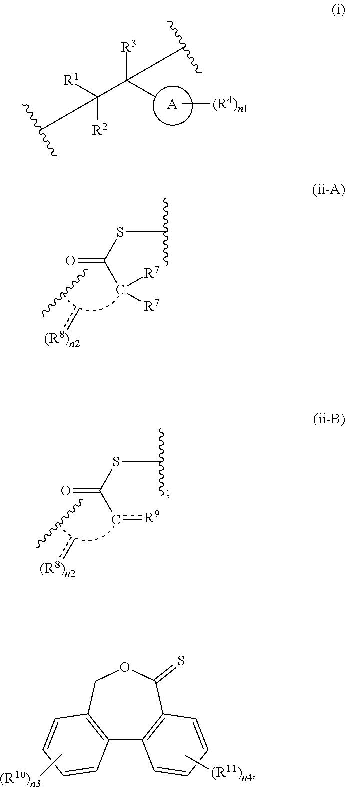

### RELATED APPLICATIONS

The present patent application claims priority to U.S. Provisional Patent Application Nos. 63/308,492 and 63/308,497, filed Feb. 9, 2022 and Feb. 10, 2022, respectively, each of which is incorporated herein by reference in its entirety.

### BACKGROUND OF THE INVENTION

Due to their low cost, versatile thermomechanical properties, and amenability to wide range of synthesis and processing conditions, materials derived from polystyrene (PS) and styrenic copolymers are ubiquitous, with applications ranging from commodity consumer products like tires and packaging to engineering applications like coatings and composites.¹ Nevertheless, the strong carbon-carbon bonds that comprise the backbone of polystyrene cause environmental persistence and offer limited opportunities for chemical recycling or upcycling. While polystyrene can be converted to styrene when heated above its ceiling temperature (˜400° C.)² or engineered to thermally degrade into low molecular weight fragments,³ such processes are energy intensive, yield complex product mixtures, do not address environmental persistence, and may not apply to all forms of polystyrene (PS, e.g. copolymers, especially crosslinked variants).

### SUMMARY OF THE INVENTION

The introduction of low levels of cleavable comonomer additives into existing vinyl polymerization processes may facilitate the production of chemically deconstructable and recyclable variants with otherwise equivalent properties without requiring new monomer feedstocks, significantly raising costs, or altering manufacturing processes, which could enable rapid implementation. The present disclosure describes cleavable comonomer approach as a viable strategy toward circular vinyl polymers.

In some aspects, the present disclosure describes copolymers comprising:
m1 instances of the first repeating unit of Formula i:

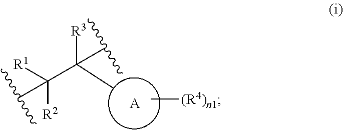

m2 instances of the second repeating unit of Formula ii-A or ii-B:

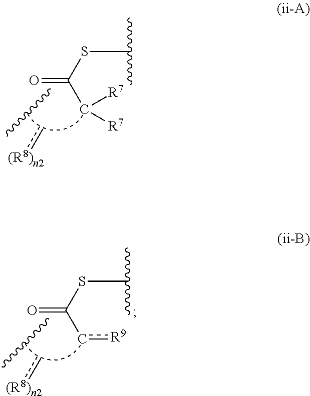

and
optionally one or more types of additional repeating units;
   wherein:
the copolymer is substantially not crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}R^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}C(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
[symbol] is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
   when attached to a carbon atom: halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, ═O, ═S, or ═NR^{b};
   when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
   when attached to a sulfur atom: ═O;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
   provided that:
none of R¹, R², R³, R⁴, Ring A, R⁷, and R⁸ comprise one or more non-aromatic unsaturated CC bonds;
none of the additional monomers comprise two or more non-aromatic unsaturated CC bonds;
the second repeating unit is not of the formula;

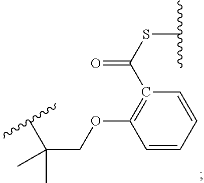

and
if the first repeating unit is of the formula:

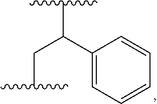

then the second repeating unit is not of the formula:

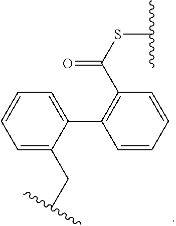

In another aspect, the present disclosure provides compounds of the formula:

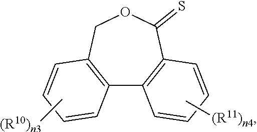

or a tautomer or salt thereof, wherein:
X¹ is S or O;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom; and
n3 is 0, 1, 2, 3, or 4, n4 is 0, 1, 2, 3, or 4, and at least one of n3 and n4 is 1, 2, 3, or 4; provided that no instance of R¹⁰ and R¹¹ comprises one or more non-aromatic unsaturated CC bonds.

In some aspects, the compounds disclosed herein are of the formula:

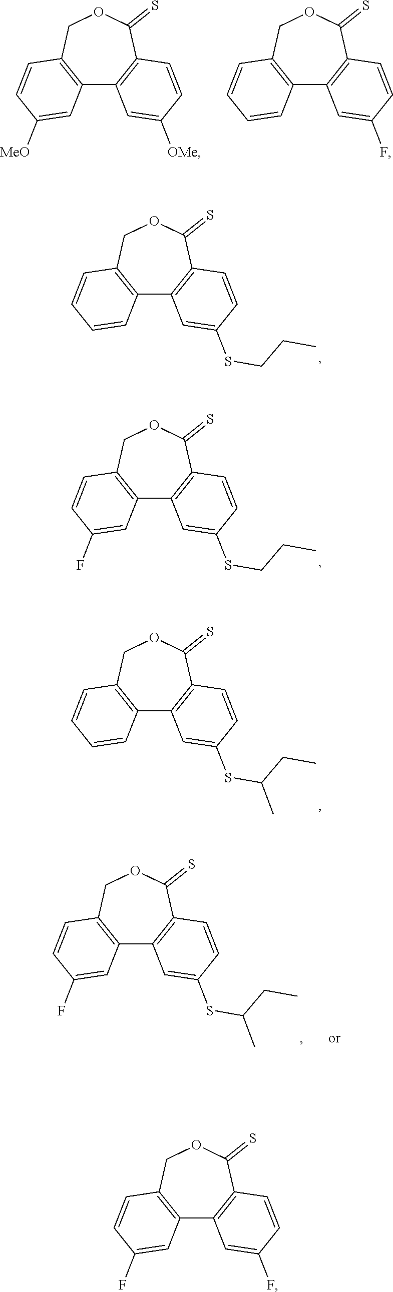

or a tautomer or salt thereof.

The present further discloses methods of preparing the copolymers as described herein, wherein the method comprises polymerizing the first monomer, the second monomer, the third monomer, and optionally one or more types of the additional monomers, as described herein. The present disclosure further describes compositions comprising the copolymers as described herein, and kits comprising a copolymer as described herein or composition thereof, and instructions for using the copolymer or composition thereof.

Typically, crosslinked polymers, especially when the crosslinked polymer's backbone does not include deconstructable moieties (e.g., esters), are difficult to deconstruct. The introduction of low levels of cleavable comonomer additives into crosslinked polymers may facilitate the production of chemically deconstructable and recyclable crosslinked polymers with otherwise equivalent properties without requiring new monomer feedstocks, significantly raising costs, or altering manufacturing processes, which could enable rapid implementation. The present disclosure describes cleavable comonomer approach as a viable strategy toward circular vinyl polymers. In some aspects, the present disclosure describes copolymers. The present further discloses methods of preparing the copolymer as described herein, wherein the method comprises polymerizing the first monomer, the second monomer, the third monomer, and optionally one or more types of the additional monomers, as described herein. The present disclosure further describes compositions comprising the copolymers as described herein, and kits comprising a copolymer as described herein or composition thereof, and instructions for using the copolymer or composition thereof.

The copolymers described herein may be useful for enabling the manufacturing of chemically deconstructable variants of existing polymers without compromising thermomechanical properties and following existing manufacturing protocols, which may offer a path to rapidly introduce circularity to otherwise difficult-to-recycle plastics (e.g., polystyrene).

The details of certain embodiments of the invention are set forth in the Detailed Description of Certain Embodiments, as described below. Other features, objects, and advantages of the invention will be apparent from the Definitions, Figures, Examples, Clauses, and Claims. The aspects described herein are not limited to specific embodiments, methods, apparati, or configurations, and as such can, of course, vary. The terminology used herein is for the purpose of describing particular aspects only and, unless specifically defined herein, is not intended to be limiting.

### BRIEF DESCRIPTION OF THE DRAWINGS

The figures are exemplary and do not limit the scope of the present disclosure.

The figures are exemplary and do not limit the scope of the present disclosure.

FIG. 1A shows a cleavable comonomer strategy for chemical re/upcycling of PS. FIG. 1B shows a chemically deconstructable and recyclable PS.

FIG. 2A shows isolation of deconstructable PS with F_{DOT}=2.6, 5.8, 11, 22, and 55% (dPS(F_{DOT})), DOT homopolymer (pDOT), and pure PS control (PS-L), and deconstruction of the former into the corresponding monofunctional OS(Pr—OS(F_{DOT})) and “oligo-DOT” (oDOT) fragments; ^{a}f_{DOT}=molar equiv of DOT in monomer feed; ^{b}Conversions were measured by ¹H NMR analysis using 1,3,5-trimethoxybenzene as internal standard. ^{c}F_{DOT}=molar equiv of ring-opened, DOT-derived units in isolated polymer (calculated by ¹H NMR spectroscopy as described in the SI); ^{d}Mₙ=number average molar mass of isolated polymer/oligomer; ^{e}Ð_{M}=Molar mass dispersity of isolated polymer/oligomer. FIGS. 2B and 2C shows partial IR spectra (FIG. 2B) and partial ¹H NMR spectra (FIG. 2C) for the dPS(F_{DOT}) series. FIG. 2D shows SEC traces for dPS(F_{DOT}) and pDOT, and the corresponding deconstruction fragments Pr—OS(F_{DOT}) and oDOT.

FIG. 3 shows the deconstruction of a model copolymer (dPS(11)) into difunctional OS with high end group fidelity. “Conversion” represents the consumption of thioester units, as determined by ¹H NMR spectroscopy; Mₙ=number average molar mass; Ð_{M}=Molar mass dispersity. Inset 1. SEC traces of dPS(11) and the isolated OS fragments. Inset 2. ¹H NMR spectra before (top) and after (bottom) a representative dPS(11) deconstruction.

FIG. 4 shows the oxidative repolymerization of thiol-OS(11) affords rPS(11) with a molecular weight distribution nearly identical to that of dPS(11).

FIG. 5 shows a circular, high molecular weight PS.

FIGS. 6A to 6C show the thermal and thermomechanical characterization of the high Mw polymers. FIG. 6A: DSC traces from the second heating ramp at 10° C./min; FIG. 6B: TGA traces acquired at 20° C./min; FIG. 6C: DMA temperature sweeps at constant amplitude and frequency. E′=elastic modulus; E″=loss modulus.

FIG. 7 shows the three general routes to functionalized DOT derivatives (substituted DOTs).

FIG. 8A shows a synthesis of substituted DOTs. “dPS” refers to deconstructable PS. FIG. 8B shows the substituent effects on the copolymerization of styrene with X-Y-DOT. Consumption of each X-Y-DOT plotted as a function of total monomer conversion. A hypothetical random polymerization is shown as a dotted line with a slope of 1 (i.e. X-Y-DOT consumption is equal to total consumption for the entire polymerization). The curve for the unmodified DOT is close to that of a random copolymerization. Fluorine and thioether substituents make X-Y-DOT more reactive relative to styrene, whereas methoxy substituents make DOT less reactive. Additionally, a comparison of the curves for F-DOT and F2-DOT suggests that each benzene ring can be used to tune reactivity and that the contribution from each ring is additive (this is also apparent when comparing SPr-DOT and SPr—F-DOT).

FIG. 9 shows the ¹H NMR Spectrum (400 MHZ, chloroform-d, d₁=60 s) of a saturated solution of DOT in styrene. The saturated solution was prepared as described above.

FIG. 10 shows the ¹H NMR spectra of dPS(11) in benzene-d₆ (left) and dichloromethane-d₂ (right) used for quantification of dyad content (using the former) and F_{DOT} (using both).

FIG. 11 shows the SEC traces (normalized by area) of the isolated oligomers from the deconstruction studies shown in Table 2.

FIG. 12 shows two plausible mechanisms for the formation of DTO during deconstruction of dPS(F_{DOT}).

FIG. 13, top panel, shows that treatment of pDOT with a catalytic amount of thiolate (0.3 equiv of each of PrSH and NEt₃ relative to thioester repeat units) in DMF solution produced, after ˜20 min at RT, DTO in 50% yield as the only observable species other than starting pDOT. After 13 h, the yield increased to >98%. FIG. 13, bottom panel, shows that at each timepoint, the amount of PrSH was identical.

FIGS. 14A to 14B show that the discovery that pDOT can quantitatively deconstruct into a pure small molecule with catalytic thiolate is expected to have broad implications, but more definitive evidence that self-immolation is operative is provided by the experiment shown FIG. 14A. Treatment of a DMF solution of pDOT with NH₂Pr (3 equiv) produced, after 1 h at RT, DTO in 86% yield. The only way that DTO could form here is via an intramolecular, self-immolative cyclization as shown in FIG. 14B. After 40 h at RT, the expected amide product was ultimately formed in 95% yield via ring-opening of DTO. In some experiments, DTO was observed as an intermediate.

FIG. 15A shows an alternative route to chemically circular PS. FIG. 15B shows two attempts at te-OS(11) recycling via polycondensation.

FIG. 16 shows the monofunctional macromolecular model system for disulfide formation.

FIG. 17 shows the number average degree of polymerization dispersity for repolymerized fragments through a step-growth mechanism containing a mixture of mono- and bi-functional OS fragments.

FIG. 18 shows the dispersity of molecular weight for repolymerized chains with a given number of OS fragments.

FIG. 19 shows the effect of cyclic polymer formation on the number average molecular weight of linear repolymerized strands for an initial N value of 10.

FIG. 20 shows the SEC traces for synthesis of rPS(2.5)-hMW under standard conditions and at 50× dilution.

FIGS. 21A to 21B show the basic thermal characterizations of low M_{w} dPS, pDOT, and PS-L. (FIG. 21A) Thermal gravimetric analysis (TGA) traces; (FIG. 21B) Differential scanning calorimetry (DSC) traces; (FIG. 21C) and (FIG. 21D) Summary of decomposition temperatures and T_{g} values obtained from TGA and DSC traces, respectively.

FIG. 22 shows the ¹H NMR Spectra (400 MHZ, benzene-d₆) of isolated dPS(F_{DOT}) from solvent screen presented in Table 1, Entries 1-6. Spectra are normalized to the local maxima of the styrenic resonances at 1.6 ppm. TMB=1,3,5-trimethoxybenzene.

FIG. 23 shows the ¹H NMR Spectra (400 MHZ, benzene-d₆) of isolated X-Y-dPS samples, corresponding to Table 1, Entries 7-11. Spectra are normalized to the local maxima of the styrenic resonances at 1.6 ppm. TMB=1,3,5-trimethoxybenzene.

FIG. 24 shows the ATR-IR spectra for virgin PS(PS-L) and dPS with variable composition (dPS(F_{DOT})) corresponding to the entries of Table 2.

FIGS. 25A to 25B show the ¹H NMR Spectra (400 MHZ, benzene-d₆) of virgin PS(PS-L), dPS with variable composition (dPS(F_{DOT})), and DOT homopolymer (pDOT) corresponding to the entries of Table 2 of the main text. (FIG. 25A) Spectra (omitting pDOT) normalized to the local maxima of the styrenic resonances at 1.6 ppm, enabling qualitative comparison of F_{DOT}. The spectrum for dPS(11) is bolded. (FIG. 25B) Same spectra (including pDOT) normalized to the maximum peak intensity between 3.8 and 4.6 ppm, enabling qualitative comparison of relative amounts of St-DOT and DOT-DOT dyads.

FIG. 26 shows the SEC traces for virgin PS(PS-L), dPS with variable composition (dPS(F_{DOT})), and DOT homopolymer (pDOT) corresponding to the entries of Table 2 of the main text.

FIGS. 27A to 27B show the SEC traces for the isolated polymers (left-hand side) shown in Table 1 of the main text. The right-hand side two traces are for the fragments after treatment with n-propylamine for 3 (dotted) and 7 (solid) days at RT in air.

FIGS. 28A to 28B show the ¹H NMR Spectra (400 MHZ, benzene-d₆) of Pr—OS(F_{DOT}) and oDOT corresponding to the entries of Table 2 of the main text. (FIG. 28A) Spectra (omitting oDOT and Pr—OS(55)) normalized to the local maxima of the styrenic resonances at 1.6 ppm, enabling qualitative comparison of end group concentration. The spectrum for Pr—OS(11) is bolded. (FIG. 28B) Same spectra (including oDOT and Pr—OS(55)) normalized to the maximum peak intensity between 4.8 and 5.7 ppm.

FIG. 29 shows the SEC traces for isolated oligomers obtained upon deconstruction of dPS(F_{DOT}) with n-propylamine, corresponding to Table 2 in the main text. The intensities of the traces were normalized by area.

FIG. 30 shows the comparison of ¹H NMR spectra of dPS(11) and the isolated product after deconstruction with propylamine (Pr—OS(11)).

FIG. 31 shows the comparison of ¹H NMR spectra of dPS(11) and the isolated product after deconstruction with allylamine (allyl-OS(11)).

FIG. 32 shows the comparison of ¹H NMR spectra of dPS(11) and the isolated product (te-OS(11)) after deconstruction with EtSH/DBU.

FIG. 33 shows the comparison of ¹H NMR spectra of dPS(11) and the isolated product (thiol-OS(11)) after deconstruction with cysteamine hydrochloride/DBU.

FIG. 34 shows the SEC traces for isolated oligomers (thiol-(F_{DOT})-hMW) obtained upon deconstruction of dPS(F_{DOT})-hMW with cysteamine hydrochloride/DBU.

FIG. 35 shows the ¹H NMR Spectra (400 MHZ, benzene-d₆) of crude (top) and precipitated (bottom) thiol-OS(2.5)-hMW.

FIG. 36 shows the ¹H NMR Spectra (400 MHZ, benzene-d₆) of crude (top) and precipitated (bottom) thiol-OS(5.0)-hMW.

FIG. 37 shows the SEC traces for crude (“aq wkp”) and precipitated (black) rPS(11).

FIG. 38 shows the comparison of ¹H NMR spectra of isolated rPS(2.5)-hMW (bottom) and precursor thiol-OS(2.5)-hMW (top).

FIG. 39 shows the comparison of ¹H NMR spectra of isolated rPS(5.0)-hMW (bottom) and precursor thiol-OS(5.0)-hMW (top).

FIG. 40 shows the comparison of ¹H NMR spectra of rPS(2.5)-hMW and rPS(5.0)-hMW. Spectra are normalized to the local maxima of the styrenic resonances at 1.6 ppm.

FIGS. 41A to 41B show lower DOT incorporation gives larger fragments as expected. Choice of solvent may affect degradation to small fragments.

FIG. 42 shows a synthesis of more-soluble, substituted DOTs. In some experiments, solubility is increased with minimal perturbation of electronic properties.

FIG. 43 shows a mechanism of copolymerization

FIGS. 44A to 44B show that temperature may play an insignificant role in 2-SBu-DOT reactivity between 65° and 105° C. FIG. 44A: a reaction scheme. FIG. 44B: 2-SBu-DOT (DOT*) conversion curves.

FIGS. 45A to 45B show a spontaneous homopolymerization of 2-SBu-DOT on the benchtop. See Roth & Coworkers, Macromolecules, 2020, 53, 539-547. FIG. 45A: a reaction scheme. FIG. 45B: ¹H NMR results.

FIG. 46 shows the molecular weight control can be achieved with nitroxide-mediated polymerization (NMP). See Hawker, et al., JACS, 1999, 121, 16, 3904-3920.

FIG. 47 shows three concise routes to substituted DOTs.

FIG. 48A shows a synthesis (top panel) and deconstruction (bottom panel) of a cross-linked copolymer. FIG. 48B shows a comparison of characteristic regions of ¹H NMR spectra of fragments from network (SPr-te-OS(5)-X) and linear (te-OS(11)) dPS deconstruction. FIG. 48C shows ¹H NMR and SEC results of the deconstruction products (fragments) of FIG. 48A.

FIG. 49 shows a common cleavable comonomer strategy to vinyl networks (top panel) and a “drop-in” cleavable comonomer strategy to vinyl networks (bottom panel).

FIG. 50 shows a strategy for preparing a target material: “vinyl ester resins”. “1.5” is the number average degree of polymerization of the PEG linkers.

FIG. 51 shows the results of a screening of mono-vinyl diluents for the best combination of solubility, reactivity, and mechanical properties.

FIG. 52 shows a synthesis of St/BPAEDA/DOT networks with varying DOT content. Protocol: 1) Cure; 2) Extract (for quantification of monomer consumption); 3) Dry.

FIG. 53 shows degradation experiment results of the resin and networks of FIG. 52. The results show that the BPAEDA:DOT ratio may be important for degradability. “Expt” refers to “experiment”.

FIG. 54 shows ATR-IR results of the St/BPAEDA/DOT networks of FIG. 52. The results show that a higher DOT loading may result in a higher thioester concentration for networks.

FIG. 55A shows a synthesis of BnA/BPAEDA/DOT networks with varying DOT content.

FIG. 55B shows degradation experiment results of the resin and networks of FIG. 55A. FIG. 55C shows ATR-IR results of the BnA/BPAEDA/DOT networks of FIG. 55A.

FIG. 56A shows a scheme for the degradation of BnA/BPAEDA/DOT networks of FIG. 55A. FIG. 56B shows that all three DOT equivalents give degradable (homogeneous solution being formed) materials. The broad molecular weight range may be at least partly due to formation of poly-disulfides.

FIG. 57 shows an efficient route to more soluble substituted DOTs.

FIG. 58 shows a development toward a solvent-free system with substituted DOTs (left panel) and degradation experiment results (right panel).

FIG. 59A shows a synthesis of BnA/BPAEDA/SPr—F-DOT networks with varying SPr—F-DOT content. FIG. 59B shows degradation experiment results of the resin and networks of FIG. 59A. FIG. 59C shows ATR-IR results of the BnA/BPAEDA/SPr—F-DOT networks of FIG. 59A. “DOT*” refers to SPr—F-DOT.

FIG. 60 shows a solvent-free synthesis of BnA/BPAEDA/SBu-F-DOT networks.

### DEFINITIONS

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various isomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC), supercritical fluid chromatography (SFC), and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, Stereochemistry of Carbon Compounds (McGraw-Hill, NY, 1962); and Wilen, Tables of Resolving Agents and Optical Resolutions p. 268 (E. L. Eliel, Ed., Univ. of Notre Dame Press, Notre Dame, IN 1972). The present disclosure additionally encompasses compounds described herein as individual isomers substantially free of other isomers, and alternatively, as mixtures of various isomers.

In a formula, the bond [symbol] is a single bond, the dashed line - - - is a single bond or absent, and the bond [symbol] or [symbol] is a single or double bond.

Unless otherwise provided, a formula depicted herein includes compounds that do not include isotopically enriched atoms and also compounds that include isotopically enriched atoms. Compounds that include isotopically enriched atoms may be useful as, for example, analytical tools, and/or probes in biological assays.

The term “aliphatic” includes both saturated and unsaturated, nonaromatic, straight chain (i.e., unbranched), branched, acyclic, and cyclic (i.e., carbocyclic) hydrocarbons. In some embodiments, an aliphatic group is optionally substituted with one or more functional groups (e.g., halo, such as fluorine). As will be appreciated by one of ordinary skill in the art, “aliphatic” is intended herein to include alkyl, alkenyl, alkynyl, cycloalkyl, cycloalkenyl, and cycloalkynyl moieties.

When a range of values (“range”) is listed, it is intended to encompass each value and sub-range within the range. A range is inclusive of the values at the two ends of the range unless otherwise provided. For example, “an integer between 1 and 4” refers to 1, 2, 3, and 4. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

“Alkyl” refers to a radical of a straight-chain or branched saturated hydrocarbon group having from 1 to 20 carbon atoms (“C₁₋₂₀ alkyl”). In some embodiments, an alkyl group has 1 to 12 carbon atoms (“C₁₋₁₂ alkyl”). In some embodiments, an alkyl group has 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈) and the like. Unless otherwise specified, each instance of an alkyl group is independently optionally substituted, e.g., unsubstituted (an “unsubstituted alkyl”) or substituted (a “substituted alkyl”) with one or more substituents. In certain embodiments, the alkyl group is unsubstituted C₁₋₁₂ alkyl (e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu or s-Bu), unsubstituted isobutyl (i-Bu)). In certain embodiments, the alkyl group is substituted C₁₋₁₂ alkyl (such as substituted C₁₋₆ alkyl, e.g., —CH₂F, —CHF₂, —CF₃, —CH₂CH₂F, —CH₂CHF₂, —CH₂CF₃, or benzyl (Bn)). The attachment point of alkyl may be a single bond (e.g., as in —CH₃), double bond (e.g., as in ═CH₂), or triple bond (e.g., as in ═CH). The moieties ═CH₂ and ═CH are also alkyl.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl” or “C₁₋₂₀ heteroalkyl”). In certain embodiments, a heteroalkyl group refers to a saturated group having from 1 to 12 carbon atoms and 1 or more heteroatoms within the parent chain (“heteroC₁₋₁₂ alkyl”). In certain embodiments, a heteroalkyl group refers to a saturated group having from 1 to 10 carbon atoms and 1 or more heteroatoms within the parent chain (“heteroC₁₋₁₀ alkyl”). In some embodiments, a heteroalkyl group is a saturated group having 1 to 9 carbon atoms and 1 or more heteroatoms within the parent chain (“heteroC₁₋₉ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 7 carbon atoms and 1 or more heteroatoms within the parent chain (“heteroC₁₋₇ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 5 carbon atoms and 1 or 2 heteroatoms within the parent chain (“heteroC₁₋₅ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, a heteroalkyl group is a saturated group having 2 to 6 carbon atoms and 1 or 2 heteroatoms within the parent chain (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₀ alkyl. In certain embodiments, the heteroalkyl group is a substituted heteroC₁₋₁₀ alkyl.

In some embodiments, an alkyl group is substituted with one or more halogens. “Perhaloalkyl” is a substituted alkyl group as defined herein wherein all of the hydrogen atoms are independently replaced by a halogen, e.g., fluoro, bromo, chloro, or iodo. In some embodiments, the alkyl moiety has 1 to 8 carbon atoms (“C₁₋₈ perhaloalkyl”). In some embodiments, the alkyl moiety has 1 to 6 carbon atoms (“C₁₋₆ perhaloalkyl”). In some embodiments, the alkyl moiety has 1 to 4 carbon atoms (“C₁₋₄ perhaloalkyl”). In some embodiments, the alkyl moiety has 1 to 3 carbon atoms (“C₁₋₃ perhaloalkyl”). In some embodiments, the alkyl moiety has 1 to 2 carbon atoms (“C₁₋₂ perhaloalkyl”). In some embodiments, all of the hydrogen atoms are replaced with fluoro. In some embodiments, all of the hydrogen atoms are replaced with chloro. Examples of perhaloalkyl groups include —CF₃, —CF₂CF₃, —CF₂CF₂CF₃, —CCl₃, —CFCl₂, —CF₂Cl, and the like.

“Alkenyl” refers to a radical of a straight-chain or branched hydrocarbon group having from 2 to 20 carbon atoms, one or more (e.g., two, three, or four, as valency permits) carbon-carbon double bonds, and no triple bonds (“C₂₋₂₀ alkenyl”). In some embodiments, an alkenyl group has 2 to 10 carbon atoms (“C₂₋₁₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently optionally substituted, e.g., unsubstituted (an “unsubstituted alkenyl”) or substituted (a “substituted alkenyl”) with one or more substituents. In certain embodiments, the alkenyl group is unsubstituted C₂₋₁₀ alkenyl. In certain embodiments, the alkenyl group is substituted C₂₋₁₀ alkenyl. In an alkenyl group, a C═C double bond for which the stereochemistry is not specified (e.g., —CH═CHCH₃ or

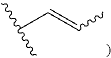

may be in the (E)- or (Z)-configuration.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 20 carbon atoms, at least one double bond, and 1 or more heteroatoms within the parent chain (“heteroC₂₋₂₀ alkenyl” or “C₂₋₂₀ heteroalkenyl”). In certain embodiments, a heteroalkenyl group refers to a group having from 2 to 12 carbon atoms, at least one double bond, and 1 or more heteroatoms within the parent chain (“heteroC₂₋₁₂ alkenyl”). In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

“Alkynyl” refers to a radical of a straight-chain or branched hydrocarbon group having from 2 to 20 carbon atoms, one or more (e.g., two, three, or four, as valency permits) carbon-carbon triple bonds, and optionally one or more double bonds (“C₂₋₂₀ alkynyl”). In some embodiments, an alkynyl group has 2 to 10 carbon atoms (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently optionally substituted, e.g., unsubstituted (an “unsubstituted alkynyl”) or substituted (a “substituted alkynyl”) with one or more substituents. In certain embodiments, the alkynyl group is unsubstituted C₂₋₁₀ alkynyl. In certain embodiments, the alkynyl group is substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 20 carbon atoms, at least one triple bond, and 1 or more heteroatoms within the parent chain (“heteroC₂₋₂₀ alkynyl” or “C₂₋₂₀ heteroalkynyl”). In certain embodiments, a heteroalkynyl group refers to a group having from 2 to 12 carbon atoms, at least one triple bond, and 1 or more heteroatoms within the parent chain (“heteroC₂₋₁₂ alkynyl”). In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

“Carbocyclyl” or “carbocyclic” refers to a radical of a non-aromatic cyclic hydrocarbon group having from 3 to 13 ring carbon atoms (“C₃₋₁₃ carbocyclyl”) and zero heteroatoms in the non-aromatic ring system. In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or contain a fused, bridged, or spiro ring system such as a bicyclic system (“bicyclic carbocyclyl”). Carbocyclyl can be saturated, and saturated carbocyclyl is referred to as “cycloalkyl.” In some embodiments, carbocyclyl is a monocyclic, saturated carbocyclyl group having from 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is unsubstituted C₃₋₁₀ cycloalkyl. In certain embodiments, the cycloalkyl group is substituted C₃₋₁₀ cycloalkyl. Carbocyclyl can be partially unsaturated. Carbocyclyl may include zero, one, or more (e.g., two, three, or four, as valency permits) C═C double bonds in all the rings of the carbocyclic ring system that are not aromatic or heteroaromatic. Carbocyclyl including one or more (e.g., two or three, as valency permits) C═C double bonds in the carbocyclic ring is referred to as “cycloalkenyl.” Carbocyclyl including one or more (e.g., two or three, as valency permits) C≡C triple bonds in the carbocyclic ring is referred to as “cycloalkynyl.” Carbocyclyl includes aryl. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently optionally substituted, e.g., unsubstituted (an “unsubstituted carbocyclyl”) or substituted (a “substituted carbocyclyl”) with one or more substituents. In certain embodiments, the carbocyclyl group is unsubstituted C₃₋₁₀ carbocyclyl. In certain embodiments, the carbocyclyl group is a substituted C₃₋₁₀ carbocyclyl. In certain embodiments, the carbocyclyl is substituted or unsubstituted, 3- to 7-membered, and monocyclic. In certain embodiments, the carbocyclyl is substituted or unsubstituted, 5- to 13-membered, and bicyclic.

In some embodiments, “carbocyclyl” is a monocyclic, saturated carbocyclyl group having from 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is unsubstituted C₃₋₁₀ cycloalkyl. In certain embodiments, the cycloalkyl group is substituted C₃₋₁₀ cycloalkyl.

“Heterocyclyl” or “heterocyclic” refers to a radical of a 3- to 13-membered non-aromatic ring system having ring carbon atoms and 1 to 4 ring heteroatoms, wherein each heteroatom is independently selected from nitrogen, oxygen, and sulfur (“3-13 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or a fused, bridged, or spiro ring system such as a bicyclic system (“bicyclic heterocyclyl”). A heterocyclyl group can be saturated or can be partially unsaturated. Heterocyclyl may include zero, one, or more (e.g., two, three, or four, as valency permits) double bonds in all the rings of the heterocyclic ring system that are not aromatic or heteroaromatic. Partially unsaturated heterocyclyl groups includes heteroaryl. Heterocyclyl bicyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently optionally substituted, e.g., unsubstituted (an “unsubstituted heterocyclyl”) or substituted (a “substituted heterocyclyl”) with one or more substituents. In certain embodiments, the heterocyclyl group is unsubstituted 3-10 membered heterocyclyl. In certain embodiments, the heterocyclyl group is substituted 3-10 membered heterocyclyl. In certain embodiments, the heterocyclyl is substituted or unsubstituted, 3- to 7-membered, and monocyclic. In certain embodiments, the heterocyclyl is substituted or unsubstituted, 5- to 13-membered, and bicyclic.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has one ring heteroatom selected from nitrogen, oxygen, and sulfur.

Exemplary 3-membered heterocyclyl groups containing one heteroatom include azirdinyl, oxiranyl, or thiiranyl. Exemplary 4-membered heterocyclyl groups containing one heteroatom include azetidinyl, oxetanyl and thietanyl. Exemplary 5-membered heterocyclyl groups containing one heteroatom include tetrahydrofuranyl, dihydrofuranyl, tetrahydrothiophenyl, dihydrothiophenyl, pyrrolidinyl, dihydropyrrolyl and pyrrolyl-2,5-dione. Exemplary 5-membered heterocyclyl groups containing two heteroatoms include dioxolanyl, oxasulfuranyl, disulfuranyl, and oxazolidin-2-one. Exemplary 5-membered heterocyclyl groups containing three heteroatoms include triazolinyl, oxadiazolinyl, and thiadiazolinyl. Exemplary 6-membered heterocyclyl groups containing one heteroatom include piperidinyl, tetrahydropyranyl, dihydropyridinyl, and thianyl. Exemplary 6-membered heterocyclyl groups containing two heteroatoms include piperazinyl, morpholinyl, dithianyl, and dioxanyl. Exemplary 6-membered heterocyclyl groups containing two heteroatoms include triazinanyl. Exemplary 7-membered heterocyclyl groups containing one heteroatom include azepanyl, oxepanyl and thiepanyl. Exemplary 8-membered heterocyclyl groups containing one heteroatom include azocanyl, oxecanyl, and thiocanyl. Exemplary 5-membered heterocyclyl groups fused to a Co aryl ring (also referred to herein as a 5,6-bicyclic heterocyclic ring) include indolinyl, isoindolinyl, dihydrobenzofuranyl, dihydrobenzothienyl, benzoxazolinonyl, and the like. Exemplary 6-membered heterocyclyl groups fused to an aryl ring (also referred to herein as a 6,6-bicyclic heterocyclic ring) include tetrahydroquinolinyl, tetrahydroisoquinolinyl, and the like.

“Aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has six ring carbon atoms (“C₆ aryl”; e.g., phenyl). In some embodiments, an aryl group has ten ring carbon atoms (“C₁₀ aryl”; e.g., naphthyl such as 1-naphthyl and 2-naphthyl). In some embodiments, an aryl group has fourteen ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently optionally substituted, e.g., unsubstituted (an “unsubstituted aryl”) or substituted (a “substituted aryl”) with one or more substituents. In certain embodiments, the aryl group is unsubstituted C₆₋₁₄ aryl. In certain embodiments, the aryl group is substituted C₆₋₁₄ aryl.

“Heteroaryl” refers to a radical of a 5-10 membered monocyclic or bicyclic 4n+2 aromatic ring system (e.g., having 6 or 10 π electrons shared in a cyclic array) having ring carbon atoms and 1-4 ring heteroatoms provided in the aromatic ring system, wherein each heteroatom is independently selected from nitrogen, oxygen and sulfur (“5-10 membered heteroaryl”). In heteroaryl groups that contain one or more nitrogen atoms, the point of attachment can be a carbon or nitrogen atom, as valency permits. Heteroaryl bicyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused (aryl/heteroaryl) ring system. Bicyclic heteroaryl groups wherein one ring does not contain a heteroatom (e.g., indolyl, quinolinyl, carbazolyl, and the like) the point of attachment can be on either ring, e.g., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently optionally substituted, e.g., unsubstituted (“unsubstituted heteroaryl”) or substituted (“substituted heteroaryl”) with one or more substituents. In certain embodiments, the heteroaryl group is unsubstituted 5-14 membered heteroaryl. In certain embodiments, the heteroaryl group is substituted 5-14 membered heteroaryl.

Exemplary 5-membered heteroaryl groups containing one heteroatom include pyrrolyl, furanyl and thiophenyl. Exemplary 5-membered heteroaryl groups containing two heteroatoms include imidazolyl, pyrazolyl, oxazolyl, isoxazolyl, thiazolyl, and isothiazolyl. Exemplary 5-membered heteroaryl groups containing three heteroatoms include triazolyl, oxadiazolyl, and thiadiazolyl. Exemplary 5-membered heteroaryl groups containing four heteroatoms include tetrazolyl. Exemplary 6-membered heteroaryl groups containing one heteroatom include pyridinyl. Exemplary 6-membered heteroaryl groups containing two heteroatoms include pyridazinyl, pyrimidinyl, and pyrazinyl. Exemplary 6-membered heteroaryl groups containing three or four heteroatoms include triazinyl and tetrazinyl, respectively. Exemplary 7-membered heteroaryl groups containing one heteroatom include azepinyl, oxepinyl, and thiepinyl. Exemplary 5,6-bicyclic heteroaryl groups include indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include naphthyridinyl, pteridinyl, quinolinyl, isoquinolinyl, cinnolinyl, quinoxalinyl, phthalazinyl, and quinazolinyl.

“Partially unsaturated” refers to a group that includes at least one double or triple bond. The term “partially unsaturated” is intended to encompass rings having multiple sites of unsaturation, but is not intended to include aromatic groups (e.g., aryl or heteroaryl groups) as herein defined. Likewise, “saturated” refers to a group that does not contain a double or triple bond, i.e., contains all single bonds.

In some embodiments, aliphatic, alkyl, alkenyl, alkynyl, carbocyclyl, heterocyclyl, aryl, and heteroaryl groups, as defined herein, are optionally substituted (e.g., “substituted” or “unsubstituted” alkyl, “substituted” or “unsubstituted” alkenyl, “substituted” or “unsubstituted” alkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In some embodiments, the heteroalkyl, heteroalkenyl, and heteroalkynyl are optionally substituted. In general, the term “substituted”, whether preceded by the term “optionally” or not, means that at least one hydrogen present on a group (e.g., a carbon or nitrogen atom) is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, any of the substituents described herein that results in the formation of a stable compound. The present disclosure contemplates any and all such combinations in order to arrive at a stable compound. For purposes of this disclosure, heteroatoms such as nitrogen may have hydrogen substituents and/or any suitable substituent as described herein which satisfy the valencies of the heteroatoms and results in the formation of a stable moiety.

Exemplary carbon atom substituents include halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR^{cc})₂, —CO₂R^{aa}, —OC(═O)R^{aa}, —OCO₂R^{aa}, —C(═O)N(R^{bb})R^{aa}, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O) NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR)₃⁺X⁻, —P(R^{cc})₄, —P(OR^{cc})₄, —OP(R^{cc})₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{aa})₂, —B(OR)₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
or two geminal hydrogens on a carbon atom are replaced with the group ═O, ═S, ═NN(R^{bb})₂, ═NNR^{bb}C(═O)R^{aa}, ═NNR^{bb}C(═O)OR^{a}, ═NNR^{bb}S(═O)₂R^{aa}, ═NR^{bb}, or ═NOR^{cc};
each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{bb} is, independently, selected from hydrogen, —OH, OR^{aa}, —N(RC)₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X is a counterion;
each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{dd} is, independently, selected from halogen, CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion;
each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and
each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O) (C₁₋₆ alkyl), —CO₂H, —CO₂(C₁₋₆ alkyl), OC(═O) (C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃-C(═S)N(C₁₋₆ alkyl)₂, —C(═S)NH(C₁₋₆ alkyl), —C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂. In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂, wherein R^{aa} is hydrogen, substituted (e.g., substituted with one or more halogen) or unsubstituted C₁₋₆ alkyl, an oxygen protecting group when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group. In certain embodiments, the carbon atom substituents are independently halogen, substituted (e.g., substituted with one or more halogen) or unsubstituted C₁₋₆ alkyl, —OR^{aa}, —SR^{aa}, —N(R^{bb})₂, —CN, —SCN, or —NO₂. In certain embodiments, the carbon atom substituents are independently halogen, substituted (e.g., substituted with one or more halogen moieties) or unsubstituted C₁₋₆ alkyl, —OR^{aa}, —SR^{aa}, —N(R^{bb})₂, —CN, —SCN, or —NO₂, wherein R^{aa} is hydrogen, substituted (e.g., substituted with one or more halogen) or unsubstituted C₁₋₆ alkyl, an oxygen protecting group when attached to an oxygen atom, or a sulfur protecting group (e.g., acetamidomethyl, t-Bu, 3-nitro-2-pyridine sulfenyl, 2-pyridine-sulfenyl, or triphenylmethyl) when attached to a sulfur atom; and each R^{bb} is independently hydrogen, substituted (e.g., substituted with one or more halogen) or unsubstituted C₁₋₆ alkyl, or a nitrogen protecting group.

A “counterion” or “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, ClO₄⁻, OH⁻, H₂PO₄⁻, HCO₃⁻, HSO₄⁻, sulfonate ions (e.g., methansulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄]⁻, B(C₆F₅)₄⁻, BPh₄⁻, Al(OC(CF₃)₃)₄⁻, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

“Halo” or “halogen” refers to fluorine (fluoro, —F), chlorine (chloro, —Cl), bromine (bromo, —Br), or iodine (iodo, —I).

Nitrogen atoms can be substituted or unsubstituted as valency permits, and include primary, secondary, tertiary, and quaternary nitrogen atoms. Exemplary nitrogen atom substituents include hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C6-14 aryl, and 5-14 membered heteroaryl, or two R^{cc} groups attached to an N atom are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc} and R^{dd} are as defined above.

In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group. In certain embodiments, the nitrogen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a nitrogen protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the nitrogen atom substituents are independently substituted (e.g., substituted with one or more halogen) or unsubstituted C₁₋₆ alkyl or a nitrogen protecting group.

In certain embodiments, the substituent present on a nitrogen atom is a nitrogen protecting group (also referred to as an amino protecting group). Nitrogen protecting groups include —OH, —OR^{aa}, —N(R^{cc})₂, —C(═O)R^{aa}, —C(═O)N(R^{cc})₂, —CO₂R^{aa}, —SO₂R^{aa}, —C(═NR^{cc})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, C₁₋₁₀ alkyl (e.g., aralkyl, heteroaralkyl), C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl groups, wherein each alkyl, alkenyl, alkynyl, carbocyclyl, heterocyclyl, aralkyl, aryl, and heteroaryl is independently substituted with 0, 1, 2, 3, 4, or 5 R^{dd} groups, and wherein R^{aa}, R^{bb} R^{cc}, and R^{dd} are as defined herein. Nitrogen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Amide nitrogen protecting groups (e.g., —C(═O)R^{aa}) include formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxyacylamino) acetamide, 3-(p-hydroxyphenyl) propanamide, 3-(o-nitrophenyl) propanamide, 2-methyl-2-(o-nitrophenoxy) propanamide, 2-methyl-2-(o-phenylazophenoxy) propanamide, 4-chlorobutanamide, 3-methyl-3-nitrobutanamide, o-nitrocinnamide, N-acetylmethionine, o-nitrobenzamide, and o-(benzoyloxymethyl)benzamide.

Carbamate nitrogen protecting groups (e.g., —C(═O)OR^{aa}) include methyl carbamate, ethyl carbamate, 9-fluorenylmethyl carbamate (Fmoc), 9-(2-sulfo) fluorenylmethyl carbamate, 9-(2,7-dibromo) fluoroenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido)benzyl carbamate, 1,1-dimethyl-3-(N,N-dimethylcarboxamido) propyl carbamate, 1,1-dimethylpropynyl carbamate, di(2-pyridyl)methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, and 2,4,6-trimethylbenzyl carbamate.

Sulfonamide nitrogen protecting groups (e.g., —S(═O)₂R^{aa}) include p-toluenesulfonamide (Ts), benzenesulfonamide, 2,3,6,-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), β-trimethylsilylethanesulfonamide (SES), 9-anthracenesulfonamide, 4 (4′,8′-dimethoxynaphthylmethyl)benzenesulfonamide (DNMBS), benzylsulfonamide, trifluoromethylsulfonamide, and phenacylsulfonamide.

Other nitrogen protecting groups include phenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyrrolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)mesityl]methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten) acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys).

In certain embodiments, a nitrogen protecting group is Bn, Boc, Cbz, Fmoc, trifluoroacetyl, triphenylmethyl, acetyl, or Ts.

In certain embodiments, the oxygen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or an oxygen protecting group. In certain embodiments, the oxygen atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or an oxygen protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the oxygen atom substituents are independently substituted (e.g., substituted with one or more halogen) or unsubstituted C₁₋₆ alkyl or an oxygen protecting group.

In certain embodiments, the substituent present on an oxygen atom is an oxygen protecting group (also referred to herein as an “hydroxyl protecting group”). Oxygen protecting groups include —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃⁺X⁻, —P(OR^{cc})₂, —P(OR)₃⁺X⁻, —P(═O)(R^{aa})₂, —P(═O)(OR)₂, and —P(═O)(N(R^{bb})₂)₂, wherein X″, R^{aa}, R^{bb}, and Rec are as defined herein. Oxygen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Exemplary oxygen protecting groups include methyl, methoxylmethyl (MOM), methylthiomethyl (MTM), t-butylthiomethyl, (phenyldimethylsilyl) methoxymethyl (SMOM), benzyloxymethyl (BOM), p-methoxybenzyloxymethyl (PMBM), (4-methoxyphenoxy)methyl(p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4 dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di(p-methoxyphenyl)phenylmethyl, tri (p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl) xanthenyl, 9-(9-phenyl-10-oxo) anthryl, 1,3-benzodisulfuran-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio) pentanoate (levulinoyldithioacetal), pivaloate, adamantoate, crotonate, 4-methoxycrotonate, benzoate, p-phenylbenzoate, 2,4,6-trimethylbenzoate (mesitoate), alkyl methyl carbonate, 9-fluorenylmethyl carbonate (Fmoc), alkyl ethyl carbonate, alkyl 2,2,2-trichloroethyl carbonate (Troc), 2-(trimethylsilyl)ethyl carbonate (TMSEC), 2-(phenylsulfonyl)ethyl carbonate (Psec), 2-(triphenylphosphonio)ethyl carbonate (Peoc), alkyl isobutyl carbonate, alkyl vinyl carbonate alkyl allyl carbonate, alkyl p-nitrophenyl carbonate, alkyl benzyl carbonate, alkyl p-methoxybenzyl carbonate, alkyl 3,4-dimethoxybenzyl carbonate, alkyl o-nitrobenzyl carbonate, alkyl p-nitrobenzyl carbonate, alkyl S-benzyl thiocarbonate, 4-ethoxy-1-naphthyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy) butyrate, 2-(methylthiomethoxymethyl)benzoate, 2,6-dichloro-4-methylphenoxyacetate, 2,6-dichloro-4-(1,1,3,3-tetramethylbutyl) phenoxyacetate, 2,4-bis(1,1-dimethylpropyl) phenoxyacetate, chlorodiphenylacetate, isobutyrate, monosuccinoate, (E)-2-methyl-2-butenoate, o-(methoxyacyl)benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

In certain embodiments, an oxygen protecting group is silyl, TBDPS, TBDMS, TIPS, TES, TMS, MOM, THP, t-Bu, Bn, allyl, acetyl, pivaloyl, or benzoyl.

In certain embodiments, the sulfur atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a sulfur protecting group. In certain embodiments, the sulfur atom substituents are independently substituted (e.g., substituted with one or more halogen) or unsubstituted C₁₋₆ alkyl, —C(═O)R^{aa}, —CO₂R^{aa}, —C(═O)N(R^{bb})₂, or a sulfur protecting group, wherein R^{aa} is hydrogen, substituted (e.g., substituted with one or more halogen) or unsubstituted C₁₋₆ alkyl, or an oxygen protecting group when attached to an oxygen atom; and each R^{bb} is independently hydrogen, substituted (e.g., substituted with one or more halogen) or unsubstituted C₁₋₆ alkyl, or a nitrogen protecting group. In certain embodiments, the sulfur atom substituents are independently substituted (e.g., substituted with one or more halogen) or unsubstituted C₁₋₆ alkyl or a sulfur protecting group.

In certain embodiments, the substituent present on a sulfur atom is a sulfur protecting group (also referred to as a “thiol protecting group”). Sulfur protecting groups include —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃⁺X⁻, —P(OR^{cc})₂, —P(OR^{cc})₃⁺X⁻, —P(═O)(R^{aa})₂, —P(═O)(OR^{cc})₂, and —P(═O)(N(R^{bb})₂)₂, wherein R^{aa}, R^{bb}, and R^{cc} are as defined herein. Sulfur protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, a sulfur protecting group is acetamidomethyl, t-Bu, 3-nitro-2-pyridine sulfenyl, 2-pyridine-sulfenyl, or triphenylmethyl.

The “molecular weight” of —R, wherein —R is any monovalent moiety, is calculated by subtracting the atomic weight of a hydrogen atom from the molecular weight of the molecule R—H. The “molecular weight” of -L-, wherein -L- is any divalent moiety, is calculated by subtracting the combined atomic weight of two hydrogen atoms from the molecular weight of the molecule H-L-H.

In certain embodiments, the molecular weight of a substituent is lower than 200, lower than 150, lower than 100, lower than 50, or lower than 25 g/mol. In certain embodiments, a substituent consists of carbon, hydrogen, fluorine, chlorine, bromine, iodine, oxygen, sulfur, nitrogen, and/or silicon atoms. In certain embodiments, a substituent consists of carbon, hydrogen, fluorine, chlorine, bromine, and/or iodine atoms. In certain embodiments, a substituent consists of carbon, hydrogen, and/or fluorine atoms. In certain embodiments, a substituent does not comprise one or more, two or more, or three or more hydrogen bond donors. In certain embodiments, a substituent does not comprise one or more, two or more, or three or more hydrogen bond acceptors.

The term “leaving group” is given its ordinary meaning in the art of synthetic organic chemistry and refers to an atom or a group capable of being displaced by a nucleophile. Examples of suitable leaving groups include halogen (such as F, Cl, Br, or I (iodine)), alkoxycarbonyloxy, aryloxycarbonyloxy, alkanesulfonyloxy, arenesulfonyloxy, alkyl-carbonyloxy (e.g., acetoxy), arylcarbonyloxy, aryloxy, methoxy, N,O-dimethylhydroxylamino, pixyl, and haloformates. In some cases, the leaving group is a sulfonic acid ester, such as toluenesulfonate (tosylate, -OTs), methanesulfonate (mesylate, -OMs), p-bromobenzenesulfonyloxy (brosylate, -OBs), —OS(═O)₂(CF₂)₃CF₃ (nonaflate, —ONf), or trifluoromethanesulfonate (triflate, —OTf). In some cases, the leaving group is a brosylate, such as p-bromobenzenesulfonyloxy. In some cases, the leaving group is a nosylate, such as 2-nitrobenzenesulfonyloxy. In some embodiments, the leaving group is a sulfonate-containing group. In some embodiments, the leaving group is a tosylate group. The leaving group may also be a phosphineoxide (e.g., formed during a Mitsunobu reaction) or an internal leaving group such as an epoxide or cyclic sulfate. Other examples of leaving groups are water, ammonia, alcohols, ether moieties, thioether moieties, zinc halides, magnesium moieties, diazonium salts, and copper moieties.

The term “salt” refers to ionic compounds that result from the neutralization reaction of an acid and a base. A salt is composed of one or more cations (positively charged ions) and one or more anions (negative ions) so that the salt is electrically neutral (without a net charge). Salts of the compounds of this disclosure include those derived from inorganic and organic acids and bases. Examples of acid addition salts are salts of an amino group formed with inorganic acids such as hydrochloric acid, hydrobromic acid, phosphoric acid, sulfuric acid, and perchloric acid, or with organic acids such as acetic acid, oxalic acid, maleic acid, tartaric acid, citric acid, succinic acid, or malonic acid or by using other methods known in the art such as ion exchange. Other salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. Salts derived from appropriate bases include alkali metal, alkaline earth metal, ammonium and N⁺(C₁₋₄ alkyl)₄ salts. Representative alkali or alkaline earth metal salts include sodium, lithium, potassium, calcium, magnesium, and the like. Further salts include ammonium, quaternary ammonium, and amine cations formed using counterions such as halide, hydroxide, carboxylate, sulfate, phosphate, nitrate, lower alkyl sulfonate, and aryl sulfonate.

“Compounds” include, e.g., small molecules and macromolecules. Macromolecules include, e.g., polymers, peptides, proteins, carbohydrates, monosaccharides, oligosaccharides, polysaccharides, nucleoproteins, mucoproteins, lipoproteins, synthetic polypeptides or proteins, glycoproteins, steroids, nucleic acids, DNAs, RNAs, nucleotides, nucleosides, oligonucleotides, antisense oligonucleotides, lipids, hormones, vitamins, and cells.

The term “small molecule” refers to molecules, whether naturally-occurring or artificially created (e.g., via chemical synthesis) that have a relatively low molecular weight. Typically, a small molecule is an organic compound (i.e., it contains carbon). The small molecule may contain multiple carbon-carbon bonds, stereocenters, and other functional groups (e.g., amines, hydroxyl, carbonyls, and heterocyclic rings, etc.). In certain embodiments, the molecular weight of a small molecule is not more than 2,000 g/mol. In certain embodiments, the molecular weight of a small molecule is not more than 1,500 g/mol. In certain embodiments, the molecular weight of a small molecule is not more than 1,000 g/mol, not more than 900 g/mol, not more than 800 g/mol, not more than 700 g/mol, not more than 600 g/mol, not more than 500 g/mol, not more than 400 g/mol, not more than 300 g/mol, not more than 200 g/mol, or not more than 100 g/mol. In certain embodiments, the molecular weight of a small molecule is at least 100 g/mol, at least 200 g/mol, at least 300 g/mol, at least 400 g/mol, at least 500 g/mol, at least 600 g/mol, at least 700 g/mol, at least 800 g/mol, or at least 900 g/mol, or at least 1,000 g/mol. Combinations of the above ranges (e.g., at least 200 g/mol and not more than 500 g/mol) are also possible. In certain embodiments, the small molecule is a therapeutically active agent such as a drug (e.g., a molecule approved by the U.S. Food and Drug Administration as provided in the Code of Federal Regulations (C.F.R.)). The small molecule may also be complexed with one or more metal atoms and/or metal ions. In this instance, the small molecule is also referred to as a “small organometallic molecule.” Preferred small molecules are biologically active in that they produce a biological effect in animals, preferably mammals, more preferably humans. Small molecules include radionuclides and imaging agents. In certain embodiments, the small molecule is a drug. Preferably, though not necessarily, the drug is one that has already been deemed safe and effective for use in humans or animals by the appropriate governmental agency or regulatory body. For example, drugs approved for human use are listed by the FDA under 21 C.F.R. §§ 330.5, 331 through 361, and 440 through 460, incorporated herein by reference; drugs for veterinary use are listed by the FDA under 21 C.F.R. §§ 500 through 589, incorporated herein by reference. All listed drugs are considered acceptable for use in accordance with the present disclosure.

The term “polymer” refers to a compound comprising eleven or more covalently connected repeating units. In certain embodiments, a polymer is naturally occurring. In certain embodiments, a polymer is synthetic (e.g., not naturally occurring). In certain embodiments, the Mw of a polymer is between 1,000 and 2,000, between 2,000 and 10,000, between 10,000 and 30,000, between 30,000 and 100,000, between 100,000 and 300,000, between 300,000 and 1,000,000, g/mol, inclusive. In certain embodiments, the Mw of a polymer is between 2,000 and 1,000,000, g/mol, inclusive.

The term “average molecular weight” may encompass the number average molecular weight (Mₙ), weight average molecular weight (M_{w}), higher average molecular weight (M_{z} or M_{z}+1), GPC/SEC (gel permeation chromatography/size-exclusion chromatography)-determined average molecular weight (Mₚ), and viscosity average molecular weight (Mᵥ). Average molecular weight may also refer to average molecular weight as determined by gel permeation chromatography.

The term “degree of polymerization” (DP) refers to the number of repeating units in a polymer. In certain embodiments, the DP is determined by a chromatographic method, such as gel permeation chromatography. For a homopolymer, the DP refers to the number of repeating units included in the homopolymer. For a copolymer of two types of monomers (e.g., a first monomer and a second monomer) wherein the molar ratio of the two types of monomers is about 1:1, the DP refers to the number of repeating units of either one of the two type of monomers included in the copolymer. For a copolymer of two types of monomers (e.g., a first monomer and a second monomer) wherein the molar ratio of the two types of monomers is not about 1:1, two DPs may be used. A first DP refers to the number of repeating units of the first monomer included in the copolymer, and a second DP refers to the number of repeating units of the second monomer included in the copolymer. Unless provided otherwise, a DP of “xx”, wherein xx is an integer, refers to the number of repeating units of either one of the two types of monomers of a copolymer of two types of monomers (e.g., a first monomer and a second monomer) wherein the molar ratio of the two types of monomers is about 1:1. Unless provided otherwise, a DP of “xx-yy”, wherein xx and yy are integers, refers to xx being the number of repeating units of the first monomer, and yy being the number of repeating units of the second monomer, of a copolymer of two types of monomers (e.g., a first monomer and a second monomer) wherein the molar ratio of the two types of monomers is not about 1:1.

The term “ring-opening metathesis polymerization (ROMP)” refers to a type of olefin metathesis chain-growth polymerization that is driven by the relief of ring strain in cyclic olefins (e.g. norbornene or cyclopentene). The catalysts used in the ROMP reaction (“metathesis catalyst”) include RuCl₃/alcohol mixture, bis(cyclopentadienyl)dimethylzirconium (IV), dichloro[1,3-bis(2,6-isopropylphenyl)-2-imidazolidinylidene](benzylidene) (tricyclohexylphosphine) ruthenium (II), dichloro[1,3-Bis(2-methylphenyl)-2-imidazolidinylidene](benzylidene) (tricyclohexylphosphine) ruthenium (II), dichloro[1,3-bis(2,4,6-trimethylphenyl)-2-imidazolidinylidene][3-(2-pyridinyl) propylidene]ruthenium (II), dichloro(3-methyl-2-butenylidene)bis(tricyclopentylphosphine) ruthenium (II), dichloro[1,3-bis(2-methylphenyl)-2-imidazolidinylidene](2-isopropoxyphenylmethylene) ruthenium (II) (Grubbs C571), dichloro(benzylidene)bis(tricyclohexylphosphine) ruthenium (II) (Grubbs I), dichloro[1,3-bis(2,4,6-trimethylphenyl)-2-imidazolidinylidene](benzylidene) (tricyclohexylphosphine) ruthenium (II) (Grubbs II), and dichloro[1,3-bis(2,4,6-trimethylphenyl)-2-imidazolidinylidene](benzylidene)bis(3-bromopyridine) ruthenium (II) (Grubbs III).

The term “v/v” refers to volume per volume and is used herein to express concentrations of monomers. Unless otherwise provided, a percent concentration of a second monomer in a first monomer is expressed in v/v. For example, a mixture of a first monomer and 10% second monomer refers to a mixture of a first monomer and a second monomer, wherein the volume of the second monomer is 10% of the combined volumes of the first and second monomers.

The disclosure is not intended to be limited in any manner by the above exemplary listing of substituents. Additional terms may be defined in other sections of this disclosure.

### DETAILED DESCRIPTION OF CERTAIN EMBODIMENTS

Many common polymers, especially vinyl polymers like polystyrene, are inherently difficult to chemically recycle and are environmentally persistent. The introduction of low levels of cleavable comonomer additives into existing vinyl polymerization processes could facilitate the production of chemically deconstructable and recyclable variants with otherwise equivalent properties without requiring new monomer feedstocks, significantly raising costs, or altering manufacturing processes. Disclosed herein are cleavable comonomer additives that allow for chemical deconstruction and recycling of polystyrene, one of the most common commodity polymers. Deconstructable PS of varied molar mass bearing varied amounts of randomly incorporated thioester backbone linkages can be selectively depolymerized to yield well-defined thiol-terminated fragments that are suitable for oxidative repolymerization to generate a recycled polystyrene of nearly identical molar mass to the parent material, in excellent yield. The thermomechanical properties of deconstructable polystyrene and its recycled products were very similar to those of virgin polystyrene.

### Polymers, and Methods of Preparation, Compositions, and Kits Thereof

In certain aspects, the present disclosure relates to a copolymer comprising:
m1 instances of the first repeating unit of Formula i:

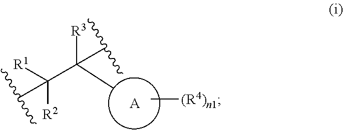

m2 instances of the second repeating unit of Formula ii-A or ii-B:

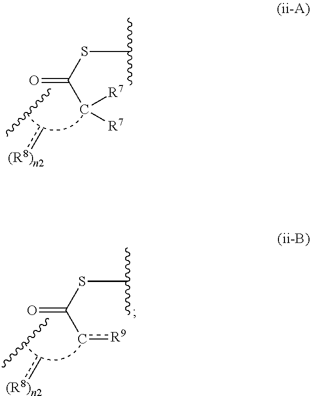

and
optionally one or more types of additional repeating units;
   wherein:
the copolymer is substantially not crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
[symbol] is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
   when attached to a carbon atom:halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR'S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, ═O, ═S, or ═NR^{b};
   when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
   when attached to a sulfur atom: ═0;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
   provided that:
none of R¹, R², R³, R⁴, Ring A, R⁷, and R⁸ comprise one or more non-aromatic unsaturated CC bonds;
none of the additional monomers comprise two or more non-aromatic unsaturated CC bonds;
the second repeating unit is not of the formula

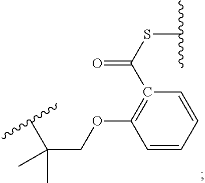

and
if the first repeating unit is of the formula:

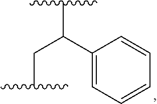

then the second repeating unit is not of the formula:

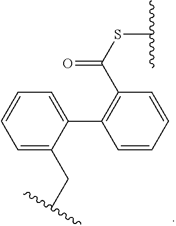

In certain embodiments, the copolymer as described herein is prepared by a method comprising polymerizing a first monomer, a second monomer, and optionally one or more types of additional monomers, wherein:
the first monomer is of Formula I:

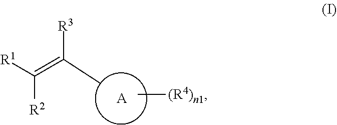

or a tautomer or salt thereof; and
the second monomer is of Formula II-A or II-B:

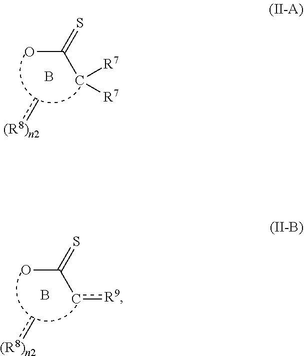

or a tautomer or salt thereof, wherein

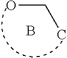

is Ring B, and Ring B is a heterocyclic ring; provided that:
Ring B does not comprise one or more non-aromatic unsaturated CC bonds;
the second monomer is not of the formula:

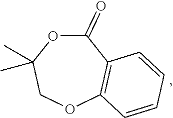

or a tautomer thereof; and
if the first monomer is unsubstituted styrene, then the second monomer is not of the formula:

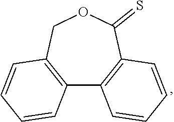 [SMILES: S=C1OCc2ccccc2-c2ccccc21]

or a tautomer thereof. In certain embodiments, the copolymer is prepared by polymerizing the first monomer, the second monomer, and optionally one or more types of the additional monomers.

In another aspect, the present disclosure provides a method of preparing the copolymer comprising polymerizing the first monomer, the second monomer, and optionally one or more types of the additional monomers.

The copolymers described herein comprise m1 instances of a first repeating unit of Formula i:

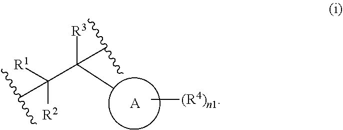

In certain embodiments, Formula (i) contains the substituents R¹, R², and R³. In certain embodiments, R¹, R², and R³ are each independently hydrogen, halogen, or substituted or unsubstituted alkyl.

In certain embodiments, Formula (i) contains the substituents R⁴. In certain embodiments, each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom.

In certain embodiments, at least one instance of R⁴ is halogen (e.g., F). In certain embodiments, at least one instance of R⁴ is substituted or unsubstituted alkyl (e.g., unsubstituted C₁₋₆ alkyl, e.g., Me).

In certain embodiments, Ring A is aryl. In certain embodiments, Ring A is phenyl.

In certain embodiments, n1 is 0. In certain embodiments, n1 is 1.

In another aspect, the present disclosure describes a copolymer comprising:
m1 instances of the first repeating unit of Formula i′:

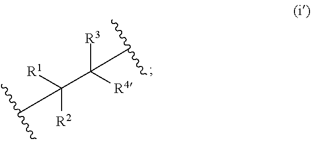

m2 instances of the second repeating unit of Formula ii-A or ii-B:

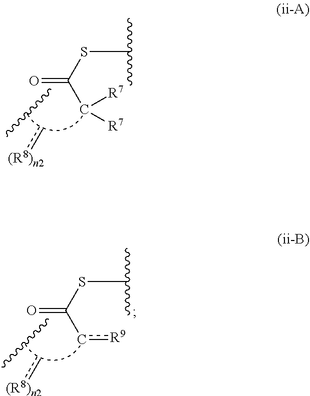

m3′ instances of a crosslinker, wherein the crosslinker is a polyradical of a small molecule, wherein the polyradical is at least tetravalent; and
optionally one or more types of additional repeating units;
   wherein:
the copolymer is substantially crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
R⁴′ is halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR'S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
[symbol] is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
   when attached to a carbon atom:halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, ═O, ═S, or ═NR^{b};
   when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, C(═O)N(R^{b})₂, —C(═NR^{b})R^{b}, —C(═NR^{b})OR^{b}, C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
   when attached to a sulfur atom: ═O;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
provided that if the first repeating unit is of the formula:

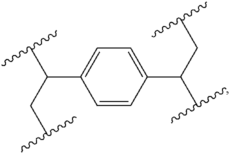

and the crosslinker is of the formula:

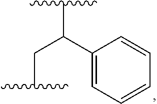 [SMILES: *CC(*)c1ccccc1]

then the second repeating unit is not of the formula:

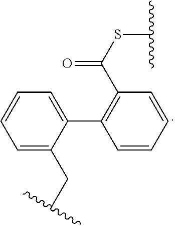

In certain embodiments, the copolymer is prepared by a method comprising polymerizing a first monomer, a second monomer, a third monomer, and optionally one or more additional monomers, wherein:
the first monomer is of Formula I′:

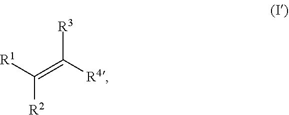

or a tautomer or salt thereof;
the second monomer is of Formula II-A or II-B:

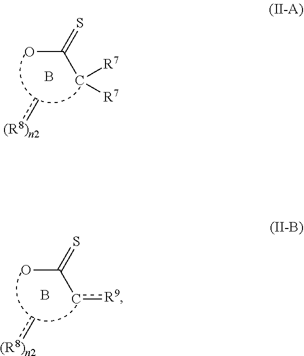

or a tautomer or salt thereof, wherein

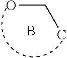

is Ring B, and Ring B is a heterocyclic ring; and
the third monomer is a small molecule comprising two or more non-aromatic unsaturated CC bonds;
provided that if the first monomer is unsubstituted styrene, and the third monomer is unsubstituted 1,4-divinylbenzen, then the second monomer is not of the formula:

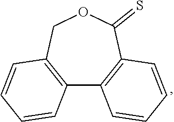 [SMILES: S=C1OCc2ccccc2-c2ccccc21]

or a tautomer thereof.

In certain embodiments, the method comprises polymerizing the first monomer, the second monomer, the third monomer, and optionally one or more types of the additional monomers.

The copolymers described herein comprise m1 instances of a first repeating unit of formula i′:

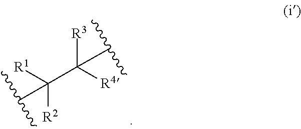

In certain embodiments, the repeating unit for formula (i′) contains the substituents R¹, R², or R³, In certain embodiments, R¹, R², and R³ are each independently hydrogen, halogen, or substituted or unsubstituted alkyl.

In certain embodiments, R⁴′ is halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}R^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom. In certain embodiments, R⁴′ is-C(═O)OR^{a}. In certain embodiments, R⁴′ is —C(═O)N(R^{a})₂, provided that at least one R^{a} is not hydrogen. In certain embodiments, at least one R^{a} is substituted or unsubstituted alkyl. In certain embodiments, at least one R^{a} is substituted or unsubstituted alkyl.

In certain embodiments, R⁴′ is substituted or unsubstituted phenyl. In certain embodiments, R⁴′ is unsubstituted phenyl. In certain embodiments, R⁴′ is halogen (e.g., F). In certain embodiments, R⁴′ is substituted or unsubstituted alkyl (e.g., unsubstituted C₁₋₆ alkyl, e.g., Me).

In certain embodiments, none of R¹, R², R³, R⁴′, R⁷, R⁸, and Ring B comprise one or more non-aromatic unsaturated CC bonds.

In certain embodiments, Formula I′ is of the formula;

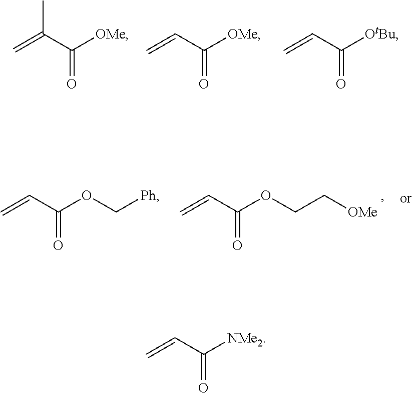

In certain embodiments, the first repeating unit is of the formula:

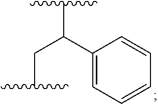

or
the first monomer is unsubstituted styrene.

The copolymers described herein comprise m2 instances of the second repeating unit of Formula ii-A or ii-B:

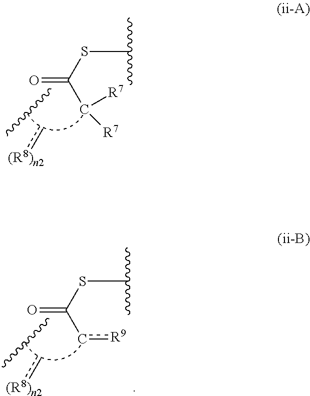

In certain embodiments, [symbol] is alkylene, preferably, C₂₋₅ alkylene. In certain embodiments, [symbol] is C₁ alkylene. In certain embodiments, [symbol] is C₂ alkylene. In certain embodiments, [symbol] is C₃ alkylene. In certain embodiments, [symbol] is C₄ alkylene. In certain embodiments, [symbol] is C₅ alkylene. In certain embodiments, [symbol] is C₆ alkylene. In certain embodiments, [symbol] is C₇ alkylene. In certain embodiments, [symbol] is heteroalkylene. In certain embodiments, [symbol] is heteroalkylene, wherein the backbone atoms are 1, 2, 3, 4, 5, 6, or 7 carbon atoms and 1 or 2 oxygen atoms. In certain embodiments, Ring B is a monocyclic heterocyclic ring. In certain embodiments, Ring B is of the formula

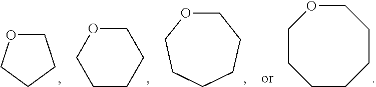

In certain embodiments, each instance of R⁷ is hydrogen. In certain embodiments, at least one instance of R⁷ is hydrogen. In certain embodiments, at least one instance of R⁷ is halogen (e.g., F). In certain embodiments, at least one instance of R⁷ is substituted or unsubstituted alkyl (e.g., unsubstituted C₁₋₆ alkyl, e.g., Me).

In certain embodiments, n2 is 0. In certain embodiments, n2 is 1. In certain embodiments, n2 is 2.

In certain embodiments, R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl. In certain embodiments, R⁹ or one instance of R⁷ and one instance of R⁸ are taken together with their intervening atoms to form substituted or unsubstituted phenyl, and/or two instances of R⁸ are taken together with their intervening atom or atoms to form substituted or unsubstituted phenyl.

In certain embodiments, the second repeating unit is of the formula:

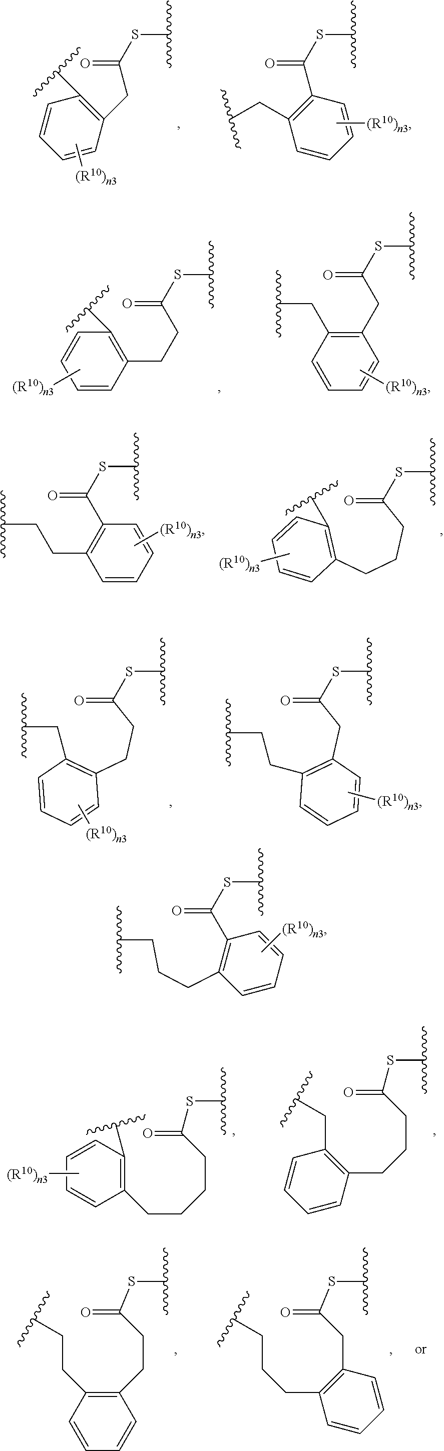

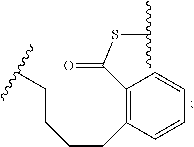

or
the second monomer is of the formula:

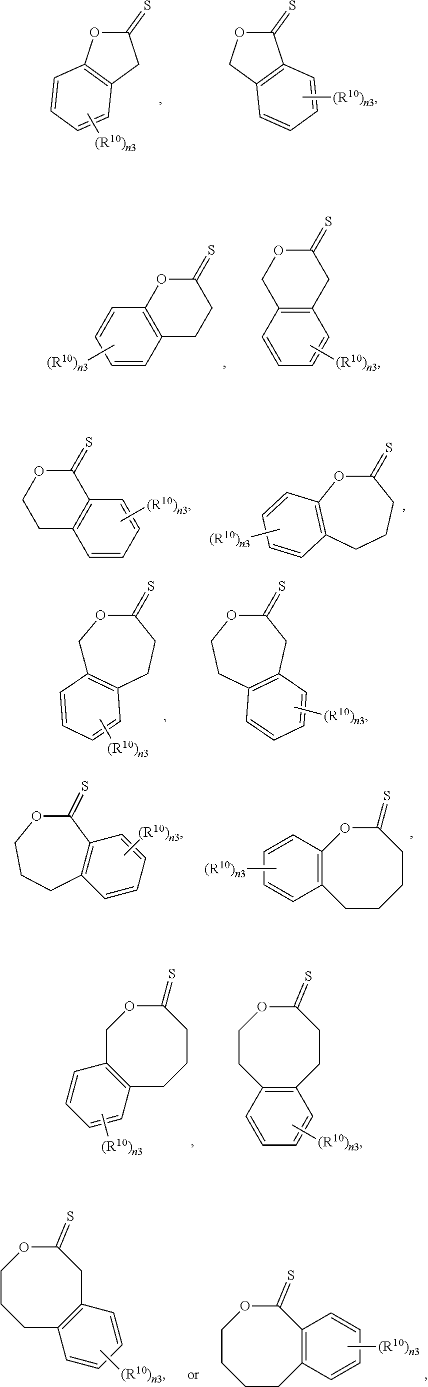

or a tautomer or salt thereof;
wherein:
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom; and
n3 is 0, 1, 2, 3, or 4;
   provided that no instance of R¹⁰ comprises one or more non-aromatic unsaturated CC bonds. In certain embodiments, the second repeating unit is of the formula:

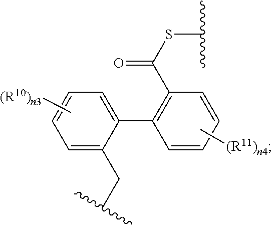

or the second monomer is of the formula:

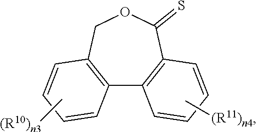

or a tautomer or salt thereof; wherein:
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NRS(═O)OR^{b}, —NR^{b}S(═O)SR^{b}, —NR^{b}S(═O)N(R^{b})₂, —NR^{b}S(═O)₂R^{b}, —NR^{b}s (═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom; and
n3 is 0, 1, 2, 3, or 4, n4 is 0, 1, 2, 3, or 4, and at least one of n3 and n4 is 1, 2, 3, or 4; provided that no instance of R¹⁰ and R¹¹ comprises one or more non-aromatic unsaturated CC bonds. In certain embodiments, the second repeating unit is of the formula:

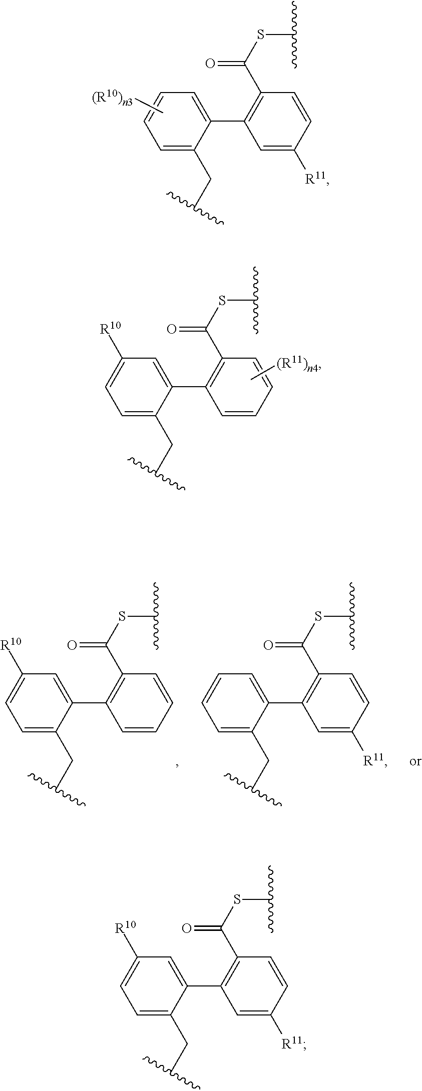

or
the second monomer is of the formula:

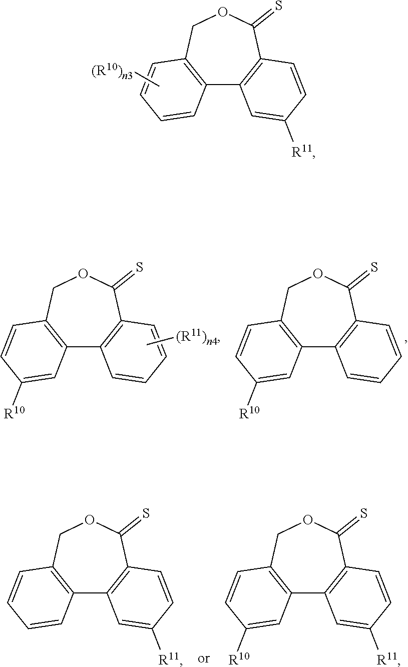

or a tautomer or salt thereof.

In certain embodiments, X¹ is S.

In certain embodiments, wherein n3 is 1. In certain embodiments, wherein n3 is 2.

In certain embodiments, wherein n4 is 1. In certain embodiments, wherein n4 is 2.

In certain embodiments, at least one instance of R¹⁰ or R¹¹ is substituted or unsubstituted alkyl, —O(substituted or unsubstituted alkyl), or —S(substituted or unsubstituted alkyl). In certain embodiments, at least one instance of R¹⁰ or R¹¹ is substituted or unsubstituted, C₂₋₆ alkyl, —O(substituted or unsubstituted, C₂₋₆ alkyl), or —S(substituted or unsubstituted, C₂₋₆ alkyl). In certain embodiments, at least one instance of R¹⁰ or R¹¹ is substituted or unsubstituted, C₂₋₆ alkyl, —O(substituted or unsubstituted, C₁₋₆ alkyl), or —S(substituted or unsubstituted, C₁₋₆ alkyl). In certain embodiments, at least one instance of R¹⁰ or R¹¹ is halogen, preferably, fluoro. In certain embodiments, at least one instance of R¹⁰ or R¹¹ is unsubstituted C₂₋₆ alkyl, —O(unsubstituted C₁₋₆ alkyl), or —S(unsubstituted C₁₋₆ alkyl). In certain embodiments, at least one instance of R¹⁰ or R¹¹ is —OR^{b}. In certain embodiments, at least one instance of R¹⁰ or R¹¹ is —O(substituted or unsubstituted alkyl). In certain embodiments, at least one instance of R¹⁰ or R¹¹ is —O(unsubstituted C₁₋₆ alkyl) (e.g., —OMe). In certain embodiments, at least one instance of R¹⁰ or R¹¹ is —SR^{b}. In certain embodiments, at least one instance of R¹⁰ or R¹¹ is —S(substituted or unsubstituted alkyl). In certain embodiments, at least one instance of R¹⁰ or R¹¹ is —S(unsubstituted C₁₋₆ alkyl). In certain embodiments, at least one instance of R¹⁰ or R¹¹ is —S(unsubstituted C₃₋₆ alkyl).

In certain embodiments, the second repeating unit is of the formula:

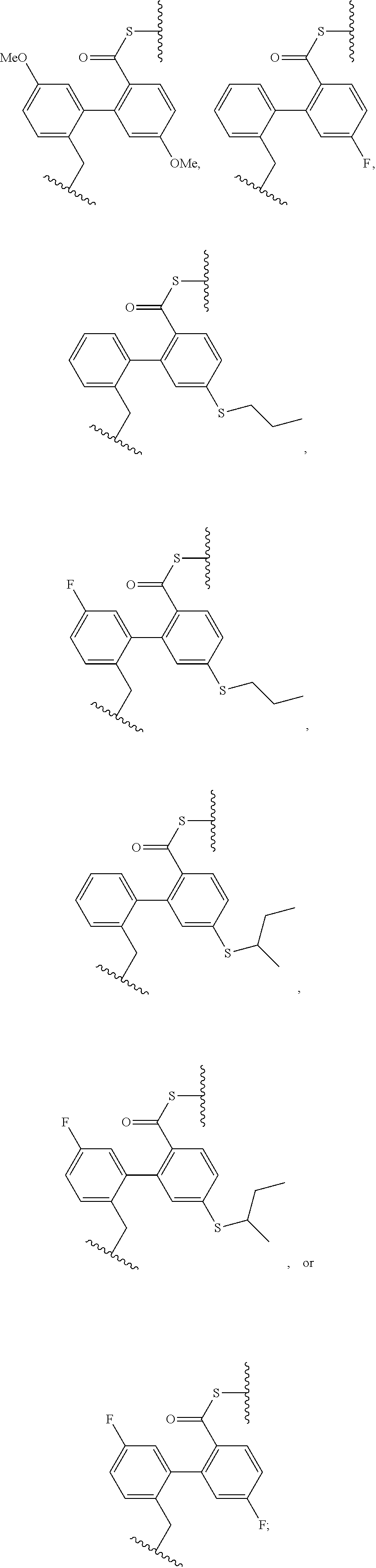

or
the second monomer is of the formula:

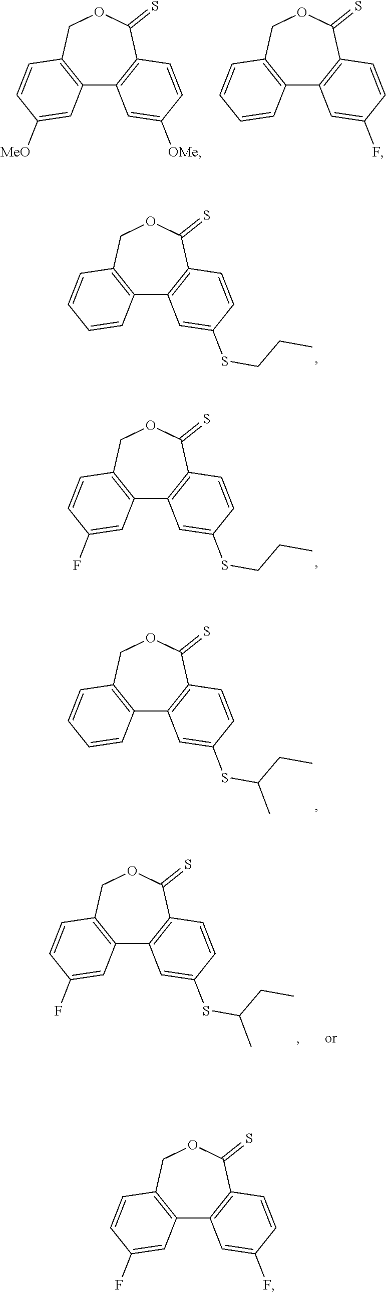

or a tautomer or salt thereof. In certain embodiments, the second repeating unit is of the formula:

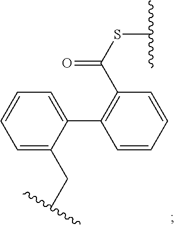

or the second monomer is of the formula:

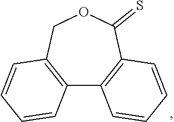 [SMILES: S=C1OCc2ccccc2-c2ccccc21]

or a tautomer thereof.
In certain embodiments, the second monomer is of the formula:

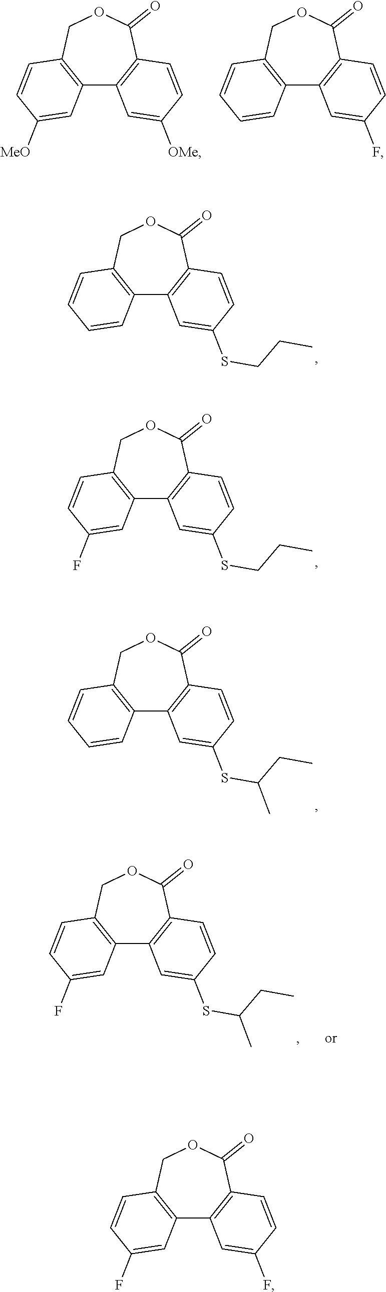

or a tautomer or salt thereof.

In certain embodiments, the second repeating unit is not of the formula:

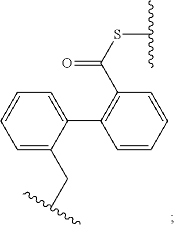

or
the second monomer is not of the formula:

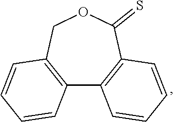 [SMILES: S=C1OCc2ccccc2-c2ccccc21]

or a tautomer thereof. In certain embodiments, the second repeating unit is not of the formula:

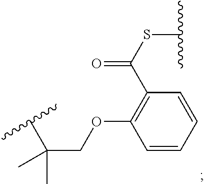

or
the second monomer is not of the formula:

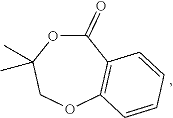

or a tautomer thereof.

In certain embodiments, the second repeating unit is not of the formula:

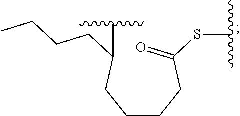

or
the second monomer is not of the formula:

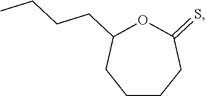

or a tautomer thereof.

In certain embodiments, the crosslinker is a polyradical of a small molecule. In certain embodiments, the polyradical is at least tetravalent. In certain embodiments, the crosslinker or third monomer does not comprise —C(═O)O— or —OC(═O)— in the backbone. In certain embodiments, the crosslinker or third monomer comprises only carbon atoms in the backbone. In certain embodiments, the third monomer comprises (non-aromatic C═C or non-aromatic C≡C)-L¹′-(non-aromatic C═C or non-aromatic C≡C), wherein L¹′ is substituted or unsubstituted, C₁₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₁₋₁₀₀₀ heteroalkylene, substituted or unsubstituted, C₂₋₁₀₀₀ heteroalkenylene, or substituted or unsubstituted, C₂₋₁₀₀₀ heteroalkynylene, optionally wherein one or more backbone carbon atoms of the C₁₋₁₀₀₀ alkylene, C₂₋₁₀₀₀ alkenylene, C₂₋₁₀₀₀ alkynylene, C₁₋₁₀₀₀ heteroalkylene, C₂₋₁₀₀₀ heteroalkenylene, or C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene. In certain embodiments, the crosslinker is of the formula:

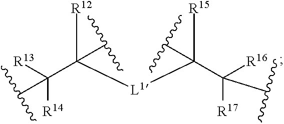

or
the third monomer is of the formula:

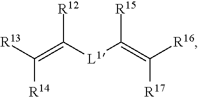

or a tautomer or salt thereof, wherein R¹², R¹³, R¹⁴, R¹⁵, R¹⁶, and R¹⁷ are each independently hydrogen, halogen, or substituted or unsubstituted alkyl. In certain embodiments, R¹², R¹³, R¹⁴, R¹⁵, R¹⁶, and R¹⁷ are each hydrogen.

In certain embodiments, L¹′ is substituted or unsubstituted, C₁₋₁₀₀₀ heteroalkylene, optionally wherein one or more backbone carbon atoms of the C₁₋₁₀₀₀ heteroalkylene are independently replaced with substituted or unsubstituted arylene. In certain embodiments, L¹′ is substituted or unsubstituted, C₁₀₋₁₀₀ heteroalkylene, optionally wherein one or more (e.g., 2 or 3) backbone carbon atoms of the C₁₀₋₁₀₀ heteroalkylene are independently replaced with substituted or unsubstituted arylene. In certain embodiments, L¹′ is substituted or unsubstituted, C₁₀₋₅₀ heteroalkylene, optionally wherein one or more (e.g., 2 or 3) backbone carbon atoms of the C₁₀₋₅₀ heteroalkylene are independently replaced with substituted or unsubstituted phenylene. In certain embodiments, the backbone heteroatoms of the heteroalkylene are oxygen. In certain embodiments, the optional substituents of the heteroalkylene are halogen (e.g., F), substituted or unsubstituted alkyl (e.g., unsubstituted C₁₋₆ alkyl, e.g., Me), or —O(substituted or unsubstituted alkyl) (e.g., —O(unsubstituted C₁₋₆ alkyl), e.g., —OMe). In certain embodiments, L¹′ is of the formula:

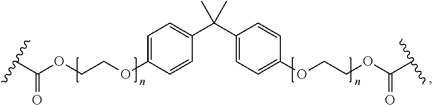

wherein each instance of n is independently 1, 2, 3, 4, or 5. In certain embodiments, the crosslinker is of the formula:

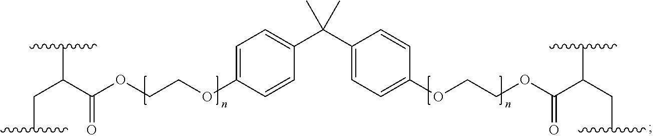

or
the third monomer is of the formula:

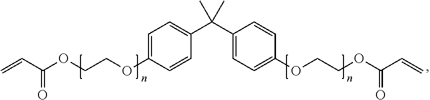

or a salt thereof, wherein each instance of n is independently 1, 2, 3, 4, or 5. In certain embodiments, L¹′ is substituted or unsubstituted arylene. In certain embodiments, L¹′ is unsubstituted 1,4-phenylene.

In certain embodiments, the molar ratio of the first repeating unit to the crosslinker or the molar ratio of the first monomer to the third monomer is between 2:1 and 10:1, between 10:1 and 30:1, or between 30:1 and 100:1, inclusive.

In certain embodiments, the crosslinking degree is between 0.1% and 0.3%, between 0.3% and 1%, between 1% and 3%, between 3% and 10%, between 10% and 20%, or between 20% and 50%, inclusive, mole:mole. In certain embodiments, the crosslinking degree is between 1% and 10%, inclusive, mole:mole.

In certain embodiments, the additional repeating units or the additional monomers, if present, do not comprise —C(═O)O— or —OC(═O)— in the backbone. In certain embodiments, the additional repeating units or the additional monomers, if present, comprise only carbon atoms in the backbone.

In certain embodiments, the step of polymerizing further comprises a radical initiator. In certain embodiments, the radical initiator is halogen (e.g., Cl₂), an azo compound, an organic peroxide, or an inorganic peroxide. n certain embodiments, the radical initiator is azobisisobutyronitrile.

In certain embodiments, the step of polymerizing further comprises a solvent. In certain embodiments, the step of polymerizing is substantially free (e.g., between 90% and 95%, between 95% and 97%, between 97% and 99%, or between 99% and 99.9%, inclusive, substantially free by weight) of a solvent. In certain embodiments, the solvent is substantially one single solvent. In certain embodiments, the solvent is a mixture of two or more (e.g., three) solvents (e.g., solvents described in this paragraph). In certain embodiments, the solvent is an organic solvent. In certain embodiments, the solvent is an aprotic solvent. In certain embodiments, the solvent is an ether solvent. In certain embodiments, the solvent is a ketone solvent. In certain embodiments, the solvent is an alkane solvent. In certain embodiments, the solvent is an alcohol solvent. In certain embodiments, the solvent is an aromatic organic solvent. In certain embodiments, the solvent is benzene, toluene, o-xylene, m-xylene, or p-xylene, or a mixture thereof. In certain embodiments, the solvent is a non-aromatic organic solvent. In certain embodiments, the solvent is acetonitrile, dioxane, or tetrahydrofuran, or a mixture thereof. In certain embodiments, the solvent is acetonitrile. In certain embodiments, the first solvent is acetone, chloroform, dichloromethane, diethyl ether, ethyl acetate, methyl tert-butyl ether, or 2-methyltetrahydrofuran, or a mixture thereof. In certain embodiments, the solvent is an inorganic solvent. In certain embodiments, the boiling point of the solvent at about 1 atm is between 30 and 50, between 50 and 70, between 70 and 100, between 100 and 130, between 130 and 160, or between 16° and 200° C., inclusive.

In certain embodiments, the temperature of the step of polymerizing is between 25 and 150, between 50 and 150, or between 7° and 120° C., inclusive. In certain embodiments, the time duration of the step of polymerizing is between 1 and 3 hours, between 3 and 8 hours, between 8 and 24 hours, between 1 and 3 days, or between 3 and 7 days, inclusive.

In certain embodiments, the molar ratio of the first repeating unit to the second repeating unit or the molar ratio of the first monomer to the second monomer is between 1:1 and 3:1, between 3:1 and 10:1, between 10:1 and 30:1, between 30:1 and 100:1, or between 100:1 and 300:1, inclusive. In certain embodiments, the molar ratio of the first repeating unit to the second repeating unit or the molar ratio of the first monomer to the second monomer is between 3:1 and 30:1, inclusive. In certain embodiments, molar ratio of the first repeating unit to the second repeating unit or the molar ratio of the first monomer to the second monomer is between 30:1 and 100:1, inclusive.

In certain embodiments, the copolymer is a random copolymer. In certain embodiments, the copolymer is a block copolymer.

In another aspect, the present disclosure provides a compound of the formula:

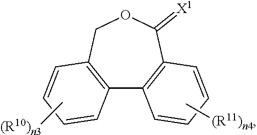

or a tautomer or salt thereof, wherein:
X¹ is S or O;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom; and
n3 is 0, 1, 2, 3, or 4, n4 is 0, 1, 2, 3, or 4, and at least one of n3 and n4 is 1, 2, 3, or 4; provided that no instance of R¹⁰ and R¹¹ comprises one or more non-aromatic unsaturated CC bonds.

In certain embodiments, the compound is of the formula:

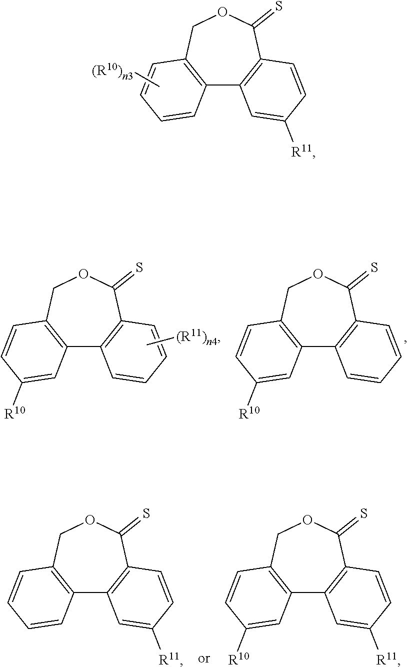

or a tautomer or salt thereof.

In certain embodiments, n3 is 1. In certain embodiments, n4 is 1.

In certain embodiments, R¹⁰ or R¹¹ is substituted or unsubstituted alkyl, —O(substituted or unsubstituted alkyl), or —S(substituted or unsubstituted alkyl). In certain embodiments, R¹⁰ or R¹¹ is substituted or unsubstituted, C₂₋₆ alkyl, —O(substituted or unsubstituted, C₂₋₆ alkyl), or —S(substituted or unsubstituted, C₂₋₆ alkyl).

In certain embodiments, the compound is of the formula:

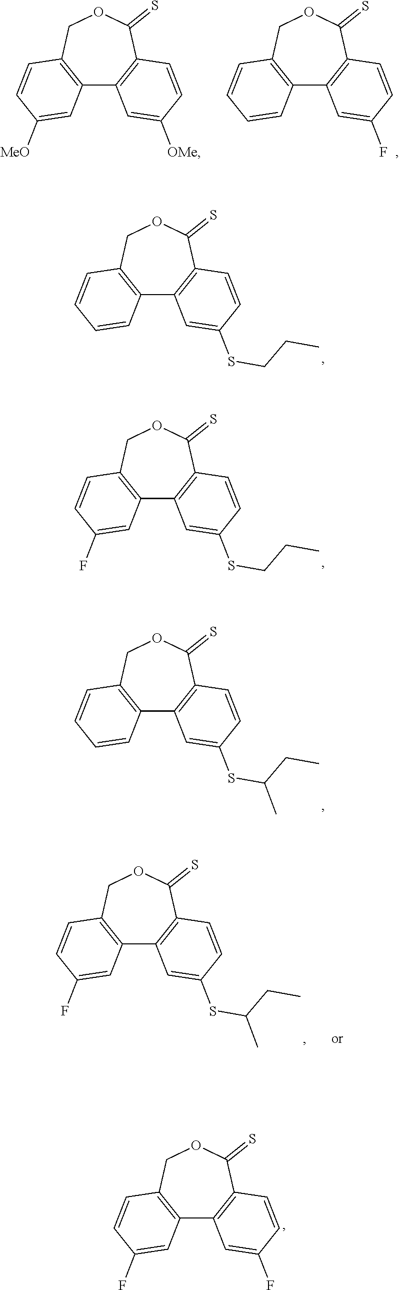

or a tautomer or salt thereof.

In another aspect, the present disclosure provides a homopolymer of the formula:

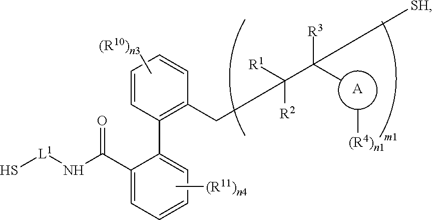

or a salt thereof, wherein:
m1 is an integer between 10 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR′, —SC(═O)SR^{b}, —SC(═O)N(R^{b})₂, —SC(═NR^{b})R^{b}, —SC(═NR^{b})OR^{b}, —SC(═NR^{b})SR^{b}, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n3 is 0, 1, 2, 3, or 4, n4 is 0, 1, 2, 3, or 4, and at least one of n3 and n4 is 1, 2, 3, or 4; and
L¹ is substituted or unsubstituted alkylene or substituted or unsubstituted heteroalkylene;
   provided that:
   provided that none of R¹, R², R³, R⁴, Ring A, R¹⁰, R¹¹, and L¹ comprise one or more non-aromatic unsaturated CC bonds.

In another aspect, the present disclosure provides a method of preparing the homopolymer comprising reacting the copolymer with a compound of the formula:

HS-L¹-NH₂,

or a salt thereof, in the presence of a base.

In certain embodiments, the homopolymer is the formula:

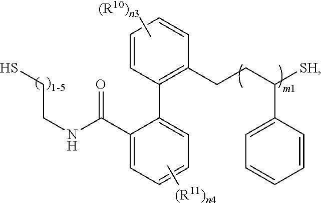

or a salt thereof.

In certain embodiments, the homopolymer is of the formula:

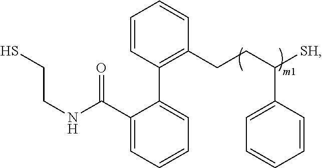

or a salt thereof.

In another aspect, the present disclosure provides a copolymer comprising m3 instances of the repeating unit of Formula iii:

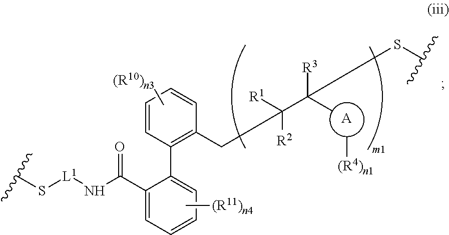

wherein:
m3 is an integer between 10 and 10,000, inclusive;
each instance of m1 is independently an integer between 10 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR'S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}s (═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n3 is 0, 1, 2, 3, or 4, n4 is 0, 1, 2, 3, or 4, and at least one of n3 and n4 is 1, 2, 3, or 4; and
L¹ is substituted or unsubstituted alkylene or substituted or unsubstituted heteroalkylene;
provided that none of R¹, R², R³, R⁴, Ring A, R¹⁰, R¹¹, and L¹ comprise one or more non-aromatic unsaturated CC bonds.

In another aspect, the present disclosure provides a method of preparing the copolymer comprising polymerizing the homopolymer in the presence of I₂ and an H—I scavenger.

In certain embodiments, the H—I scavenger is a base. In certain embodiments, the base is an aromatic amine, preferably, pyridine.

In certain embodiments, the base is 1,5,7-Triazabicyclo(4.4.0) dec-5-ene (TBD), 7-Methyl-1,5,7-triazabicyclo(4.4.0)dec-5-ene (MTBD), 1,8-Diazabicyclo[5.4.0]undec-7-ene (DBU), 1,5-Diazabicyclo[4.3.0]non-5-ene (DBN), 1,1,3,3-Tetramethylguanidine (TMG), Quinuclidine, 2,2,6,6-Tetramethylpiperidine (TMP), Pempidine (PMP), Tributlyamine, Triethylamine, 1,4-Diazabicyclo[2.2.2]octan (TED), Collidine, or 2,6-Lutidine (2,6-Dimethylpyridine).

In certain embodiments, Formula iii is:

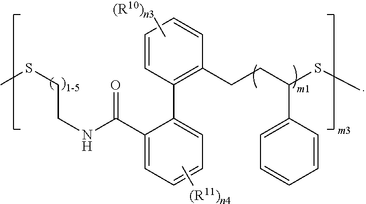

In certain embodiments, Formula iii is:

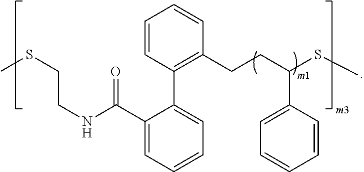

In certain embodiments, L¹ is substituted or unsubstituted alkylene. In certain embodiments, L¹ is unsubstituted C₂₋₆ alkylene.

In another aspect, the present disclosure provides a copolymer comprising:
m1 instances of the first repeating unit of Formula i′:

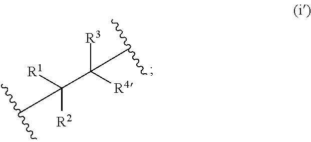

m2 instances of the second repeating unit of Formula ii-A or ii-B:

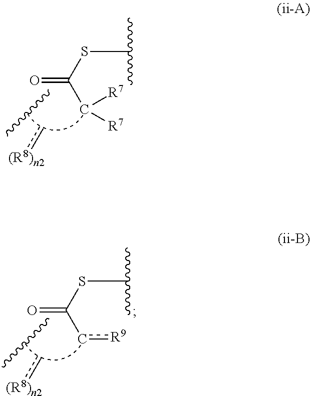

m3′ instances of a crosslinker, wherein the crosslinker is a polyradical of a small molecule, wherein the polyradical is at least tetravalent; and
optionally one or more types of additional repeating units;
   wherein:
the copolymer is substantially crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
R⁴′ is halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(—NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}s (═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}s (═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
[symbol] is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
   when attached to a carbon atom:halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR'S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, —O, —S, or ═NR^{b};
   when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
   when attached to a sulfur atom: ═O;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;

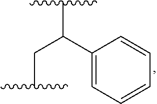 [SMILES: *CC(*)c1ccccc1]

provided that if the first repeating unit is of the formula:

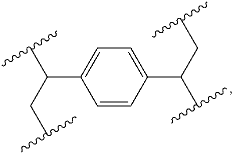

and the crosslinker is of the formula:

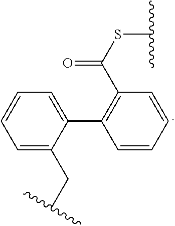 [SMILES: *Cc1ccccc1-c1ccccc1C(=O)S*]

then the second repeating unit is not of the formula:

In certain embodiments, the copolymer is prepared by a method comprising polymerizing a first monomer, a second monomer, a third monomer, and optionally one or more additional monomers, wherein:
the first monomer is of Formula I′:

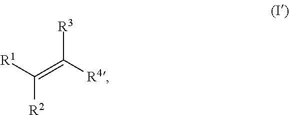

or a tautomer or salt thereof;
the second monomer is of Formula II-A or II-B:

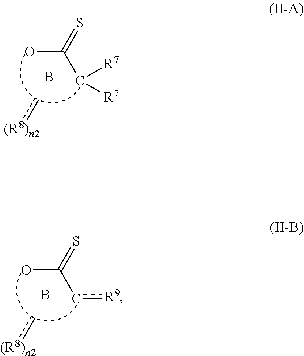

or a tautomer or salt thereof, wherein

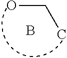

is Ring B, and Ring B is a heterocyclic ring; and
the third monomer is a small molecule comprising two or more non-aromatic unsaturated CC bonds;
provided that if the first monomer is unsubstituted styrene, and the third monomer is unsubstituted 1,4-divinylbenzen, then the second monomer is not of the formula:

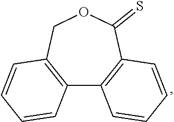 [SMILES: S=C1OCc2ccccc2-c2ccccc21]

or a tautomer thereof.

In another aspect, the present disclosure provides a method of preparing the copolymer comprising polymerizing the first monomer, the second monomer, the third monomer, and optionally one or more types of the additional monomers.

In certain embodiments, the crosslinker or third monomer does not comprise —C(═O)O— or —OC(═O)— in the backbone.

In certain embodiments, the crosslinker or third monomer comprises only carbon atoms in the backbone.

In certain embodiments, the third monomer comprises (non-aromatic C—C or non-aromatic C≡C)-L¹′-(non-aromatic C═C or non-aromatic C≡C), wherein L¹′ is substituted or unsubstituted, C₁₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₁₋₁₀₀₀ heteroalkylene, substituted or unsubstituted, C₂₋₁₀₀₀ heteroalkenylene, or substituted or unsubstituted, C₂₋₁₀₀₀ heteroalkynylene, optionally wherein one or more backbone carbon atoms of the C₁₋₁₀₀₀ alkylene, C₂₋₁₀₀₀ alkenylene, C₂₋₁₀₀₀ alkynylene, C₁₋₁₀₀₀ heteroalkylene, C₂₋₁₀₀₀ heteroalkenylene, or C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene.

In certain embodiments, the crosslinker is of the formula:

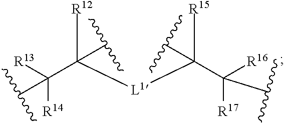

or
the third monomer is of the formula:

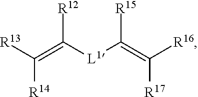

or a tautomer or salt thereof, wherein R¹², R¹³, R¹⁴, R¹⁵, R¹⁶, and R¹⁷ are each independently hydrogen, halogen, or substituted or unsubstituted alkyl.

In certain embodiments, R¹², R¹³, R¹⁴, R¹⁵, R¹⁶, and R¹⁷ are each hydrogen.

In certain embodiments, L¹′ is substituted or unsubstituted, C₁₋₁₀₀₀ heteroalkylene, optionally wherein one or more backbone carbon atoms of the C₁₋₁₀₀₀ heteroalkylene are independently replaced with substituted or unsubstituted arylene.

In certain embodiments, L¹′ is substituted or unsubstituted, C₁₀₋₁₀₀ heteroalkylene, optionally wherein one or more backbone carbon atoms of the C₁₀₋₁₀₀ heteroalkylene are independently replaced with substituted or unsubstituted arylene.

In certain embodiments, L¹′ is substituted or unsubstituted, C₁₀₋₅₀ heteroalkylene, optionally wherein one or more backbone carbon atoms of the C₁₀₋₅₀ heteroalkylene are independently replaced with substituted or unsubstituted phenylene.

In certain embodiments, L¹′ is of the formula:

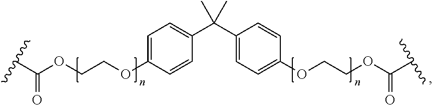

wherein each instance of n is independently 1, 2, 3, 4, or 5.

In certain embodiments, the crosslinker is of the formula:

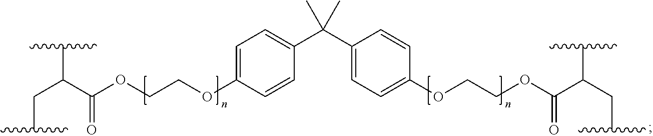

or
the third monomer is of the formula:

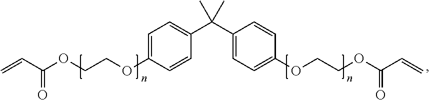

or a salt thereof, wherein each instance of n is independently 1, 2, 3, 4, or 5.

In certain embodiments, L¹′ is substituted or unsubstituted arylene. In certain embodiments, L¹′ is unsubstituted 1,4-phenylene.

In certain embodiments, m1 is an integer between 30 and 3,000, inclusive. In certain embodiments, m1 is an integer between 10 and 30, between 30 and 100, between 100 and 300, between 300 and 1,000, between 1,000 and 3,000, between 3,000 and 10,000, between 10,000 and 100,000, or between 100,000 and 1,000,000, inclusive.

In certain embodiments, m2 is an integer between 3 and 300, inclusive. In certain embodiments, m2 is an integer between 2 and 10, between 10 and 30, between 30 and 100, between 100 and 300, between 300 and 1,000, between 1,000 and 3,000, between 3,000 and 10,000, between 10,000 and 100,000, or between 100,000 and 1,000,000, inclusive.

In certain embodiments, m3 is an integer between 30 and 3,000, inclusive. In certain embodiments, m3 is an integer between 10 and 30, between 30 and 100, between 100 and 300, between 300 and 1,000, between 1,000 and 3,000, or between 3,000 and 10,000, inclusive.

In certain embodiments, R¹ is hydrogen. In certain embodiments, R¹ is substituted or unsubstituted alkyl. In certain embodiments, R¹ is unsubstituted C₁₋₆ alkyl (e.g., Me). In certain embodiments, R¹ is halogen (e.g., F).

In certain embodiments, R² is hydrogen. In certain embodiments, R² is substituted or unsubstituted alkyl. In certain embodiments, R² is unsubstituted C₁₋₆ alkyl (e.g., Me). In certain embodiments, R² is halogen (e.g., F).

In certain embodiments, R³ is hydrogen. In certain embodiments, R³ is substituted or unsubstituted alkyl. In certain embodiments, R³ is substituted or unsubstituted alkyl. In certain embodiments, R³ is unsubstituted C₁₋₆ alkyl (e.g., Me). In certain embodiments, R³ is halogen (e.g., F).

In certain embodiments, R⁴′ is —C(═O)OR^{a};

wherein R^{a} is substituted or unsubstituted alkyl, substituted or unsubstituted carbocyclyl, substituted or unsubstituted heterocyclyl, substituted or unsubstituted aryl, or substituted or unsubstituted heteroaryl.

In certain embodiments, R⁴′ is —C(═O)N(R^{a})₂;
wherein each R^{a} is independently hydrogen, substituted or unsubstituted alkyl, substituted or unsubstituted carbocyclyl, substituted or unsubstituted heterocyclyl, substituted or unsubstituted aryl, or substituted or unsubstituted heteroaryl;
provided that at least one R^{a} is not hydrogen.

In certain embodiments, at least one R^{a} is substituted or unsubstituted alkyl. In certain embodiments, at least one R^{a} is unsubstituted C₁₋₆ alkyl (e.g., Me, Et, i-Pr).

In certain embodiments, R⁴′ is substituted or unsubstituted phenyl. In certain embodiments, R⁴′ is not substituted or unsubstituted phenyl. In certain embodiments, R⁴′ is unsubstituted phenyl. In certain embodiments, R⁴′ is not unsubstituted phenyl.

In certain embodiments, none of R¹, R², R³, R⁴′, R⁷, R⁸, and Ring B comprise one or more non-aromatic unsaturated CC bonds.

In certain embodiments, Formula I′ is

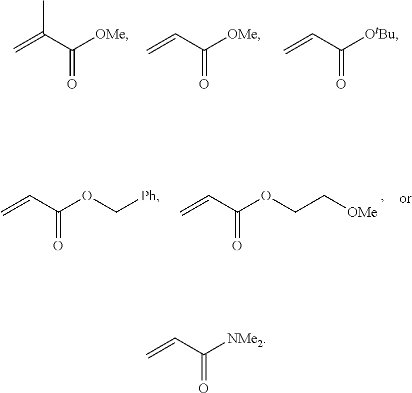

In certain embodiments, the molar ratio of the first repeating unit to the crosslinker or the molar ratio of the first monomer to the third monomer is between 2:1 and 10:1, between 10:1 and 30:1, or between 30:1 and 100:1, inclusive.

In certain embodiments, the crosslinking degree is between 0.1% and 0.3%, between 0.3% and 1%, between 1% and 3%, between 3% and 10%, between 10% and 20%, or between 20% and 50%, inclusive, mole:mole. In certain embodiments, the crosslinking degree is between 1% and 10%, inclusive, mole:mole. In certain embodiments, the crosslinking degree is between 20% and 30%, between 30% and 40%, or between 40% and 50%, inclusive, mole:mole.

In certain embodiments, the crosslinking degree is lower than 0.1%, mole:mole. In certain embodiments, the crosslinking degree is between 0.001% and 0.01% or between 0.01% and 0.1%, mole:mole, exclusive.

In certain embodiments, the crosslinking degree is determined by the consumption of the monomers that are polymerized to form the copolymer. In certain embodiments, the crosslinking degree is determined by nuclear magnetic resonance spectroscopy (NMR, e.g., Single-Sided NMR). In certain embodiments, the crosslinking degree is determined by a swelling test.

In another aspect, the present disclosure provides a homopolymer prepared by a method comprising polymerizing a compound as described herein, or a tautomer or salt thereof.

In certain embodiments, the number-average molecular weight of the copolymer or homopolymer as determined by gel permeation chromatography is between 20 kDa and 100 kDa, between 100 kDa and 300 kDa, between 300 kDa and 1,000 kDa, between 1,000 kDa and 3,000 kDa, or between 3,000 kDa and 10,000 kDa. In certain embodiments, the number-average molecular weight of the copolymer or homopolymer as determined by gel permeation chromatography is between 300 Da and 7 kDa, inclusive. In certain embodiments, the number-average molecular weight of the copolymer or homopolymer as determined by gel permeation chromatography is between 7 kDa and 100 kDa, inclusive. In certain embodiments, the number-average molecular weight of the copolymer or homopolymer as determined by gel permeation chromatography is between 100 kDa and 3,000 kDa, inclusive.

In certain embodiments, the copolymer or homopolymer is degradable. In certain embodiments, the copolymer or homopolymer is degradable after reacting the copolymer or homopolymer with a nucleophile.

Further disclosed herein is a method of degrading a copolymer or homopolymer as described herein comprising reacting the copolymer or homopolymer with a nucleophile. In certain embodiments, the nucleophile degrades the copolymer or homopolymer under ambient conditions.

In certain embodiments, the nucleophile is an amine. In certain embodiments, the nucleophile is an organic amine. In certain embodiments, the nucleophile is an organic aliphatic amine. In certain embodiments, the nucleophile is an organic aromatic amine. In certain embodiments, the nucleophile is (substituted or unsubstituted alkyl)₂-NH. In certain embodiments, the nucleophile is (substituted or unsubstituted alkyl)-NH₂. In certain embodiments, the nucleophile is (substituted or unsubstituted alkyl)-NH₂, preferably (unsubstituted C₂₋₆ alkyl)-NH₂. In certain embodiments, the nucleophile is (alkyl substituted at least with —SH)—NH₂, preferably HS—(CH₂)₂₋₆—NH₂. In certain embodiments, the nucleophile is a thiol. In certain embodiments, the nucleophile is (substituted or unsubstituted alkyl)-SH, preferably (unsubstituted C₂₋₆ alkyl)-SH. In certain embodiments, the nucleophile is a small molecule.

In certain embodiments, the average molecular weight of the copolymer is between 10 kDa and 10,000 kDa, inclusive. In certain embodiments, the average molecular weight of the copolymer is between 10 kDa and 30 kDa, between 30 kDa and 100 kDa, between 100 kDa and 1,000 kDa, between 1,000 kDa and 10,000 kDa, or between 10,000 kDa and 100,000 kDa, inclusive. In certain embodiments, the average molecular weight of the copolymer is between 10 kDa and 100 kDa, inclusive. In certain embodiments, the average molecular weight is as determined by gel permeation chromatography. In certain embodiments, the average molecular weight of the copolymer as determined by gel permeation chromatography is between 10 kDa and 100,000 kDa, inclusive. In certain embodiments, the number average polymerization degree is between 2 and 1,000, inclusive, with respect to the first monomer; and between 2 and 1,000, inclusive, with respect to the second monomer. In certain embodiments, the number average polymerization degree is between 10 and 200, inclusive, with respect to the first monomer; and between 10 and 200, inclusive, with respect to the second monomer. In certain embodiments, the number average polymerization degree is between 15 and 100, inclusive, with respect to the first monomer; and between 15 and 100, inclusive, with respect to the second monomer. In certain embodiments, the number average polymerization degree is between 2 and 1,000, between 10 and 1,000, between 100 and 1,000, between 2 and 100, between 10 and 100, between 2 and 10, inclusive, with respect to the first monomer. In certain embodiments, the number average polymerization degree is between 2 and 1,000, between 10 and 1,000, between 100 and 1,000, between 2 and 100, between 10 and 100, between 2 and 10, inclusive, with respect to the second monomer.

In certain embodiments, the dispersity (D) of the copolymer is between 1 and 2, between 1.1 and 2, between 1.3 and 2, between 1.5 and 2, between 1.1 and 1.5, between 1.1 and 1.3, between 1.3 and 2, between 1.3 and 1.5, between 1.5 and 2, inclusive.

In another aspect, the present disclosure provides a composition comprising:
the copolymer; and
   optionally an excipient.

In another aspect, the present disclosure provides a composition comprising:
the compound, or a tautomer or salt thereof; and
optionally an excipient.

In another aspect, the present disclosure provides a composition comprising:
the homopolymer; and
optionally an excipient.

Compositions described herein can be prepared by any method known in the art. In general, such preparatory methods include bringing the copolymer into association with an excipient, and/or one or more other accessory ingredients, and then, if necessary and/or desirable, shaping, and/or packaging the product into a desired unit. In certain embodiments, disclosed herein are compositions comprising a copolymer as described herein, and optionally an excipient. In certain embodiments, disclosed herein are compositions comprising a compound as described herein, or a tautomer or salt thereof; and optionally an excipient. In certain embodiments, disclosed herein are compositions comprising a homopolymer as described herein; and optionally an excipient. In certain embodiments, the excipient is a pharmaceutically acceptable excipient (e.g., water).

In another aspect, the present disclosure describes kits comprising a copolymer, compound, or composition as described herein; and instructions for using the copolymer, compound, homopolymer, or composition. In certain embodiments, the kit comprises a copolymer or composition as described herein; and instructions for using the copolymer or composition. In certain embodiments, the kit comprises a compound as described herein, or a tautomer or salt thereof, or composition as described herein; and instructions for using the compound, tautomer, salt, or composition. In certain embodiments, the kit comprises a homopolymer or composition as described herein; and instructions for using the homopolymer or composition. Kits may be commercial packs or reagent packs. The kits may further comprise a container (e.g., a vial, ampule, bottle, syringe, and/or dispenser package, or other suitable container). In certain embodiments, a kit further comprises instructions for using the copolymer (e.g., degrading the copolymer and/or reconstructing the copolymer).

### EXAMPLES

In order that the present disclosure may be more fully understood, the following examples are set forth. The synthetic and biological examples described in this application are offered to illustrate the compounds, pharmaceutical compositions, and methods provided herein and are not to be construed in any way as limiting their scope.

### Example 1

Many common polymers, especially vinyl polymers like polystyrene, are inherently difficult to chemically recycle and are environmentally persistent. The introduction of low levels of cleavable comonomer additives into existing vinyl polymerization processes could facilitate the production of chemically deconstructable and recyclable variants with otherwise equivalent properties without requiring new monomer feedstocks, significantly raising costs, or altering manufacturing processes, which could enable rapid implementation. Here, we report cleavable comonomer additives that allow for chemical deconstruction and recycling of polystyrene (PS), one of the most common commodity polymers. Deconstructable PS of varied molar mass (˜20-300 kDa) bearing varied amounts of randomly incorporated thioester backbone linkages (2.5-100 mol %) can be selectively depolymerized to yield well-defined thiol-terminated fragments (<10 kDa) that are suitable for oxidative repolymerization to generate a recycled polystyrene of nearly identical molar mass to the parent material, in excellent yield (80-95%). The thermomechanical properties of deconstructable PS bearing 2.5 mol % of cleavable linkages and its recycled products were very similar to those of virgin polystyrene. This work establishes the cleavable comonomer approach as a viable strategy toward circular vinyl polymers.

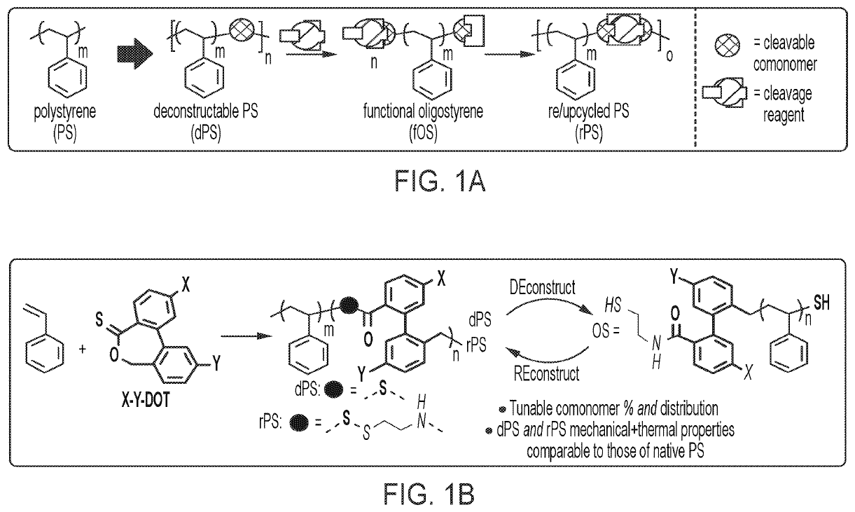

We have explored cleavable comonomers as additives for enabling the manufacturing of chemically deconstructable variants of existing polymers without compromising thermomechanical properties and following existing manufacturing protocols, which we believe offers a path to rapidly introduce circularity to otherwise difficult-to-recycle plastics.⁴⁻⁶ Given suitable comonomers, such a strategy could fit naturally into existing infrastructure for PS production (FIG. 1A), which already relies heavily on copolymerization to tune material properties. Indeed, while there have been many efforts toward the synthesis of chemically cleavable vinyl polymers, including PS,⁷⁻¹³ via comonomer approaches, a closed-loop cycle to produce recycled variants has proven elusive. A notable effort toward chemical recycling of PS was from Rimmer and Ebdon, who demonstrated that the olefinic backbone of styrene-butadiene copolymers can be cleaved via ozonolysis;⁹ however, the harsh conditions produced unwanted side products and would be challenging to scale, and repolymerization efforts were not discussed. A number of reports have described the introduction of cleavable esters into the main chain of PS through radical ring-opening polymerization (rROP)^{14,15} with cyclic ketene acetal (CKA) comonomers;¹⁰⁻¹³ however, these copolymers have invariably possessed strong composition gradients due to unfavorable reactivity ratios between styrene and CKA comonomers, precluding the ability to deconstruct the PS into low molecular weight, reusable fragments. Meanwhile, other cleavable comonomer classes for rROP, such as thionolactones,^{16,17} have been reported to not copolymerize at all with styrene; however, during our preparation of this manuscript, it was shown that the thionolactone dibenzo[c,e]oxepine-5(7H)-thione (DOT) can incorporate into PS under emulsion polymerization conditions, producing degradable latex particles.¹⁸ Nevertheless, despite significant progress for rROP with various copolymer compositions¹⁴⁻²² and attempts at repolymerization of oligomeric fragments obtained by other means,²³⁻²⁵ to our knowledge, circularity (i.e. production of recycled materials of comparable properties) via the comonomer approach has not been demonstrated for any vinyl polymer.

Herein, we realize chemically recyclable PS via the cleavable comonomer strategy. We show that DOT and novel DOT derivatives (X-Y-DOT) can be tailored undergo a nearly random copolymerization with styrene under standard free radical polymerization conditions to generate PS with main-chain thioesters over a range of molar masses (˜20-300 kDa) and comonomer compositions (2.5-100%). Treatment of these polymers with mild, readily available thiols, aminothiols, or allylamine enables their quantitative deconstruction to well-defined telechelic oligomeric fragments (<10 kDa) suitable for repolymerization. Closed-loop deconstruction and oxidative repolymerization of high molecular weight (300 kDa) PS bearing 2.5% of DOT is demonstrated, yielding recycled PS of equivalent molar mass and thermomechanical properties to virgin PS.

Synthesis of Deconstructable PS with Arbitrary Composition and Tunable Microstructure.

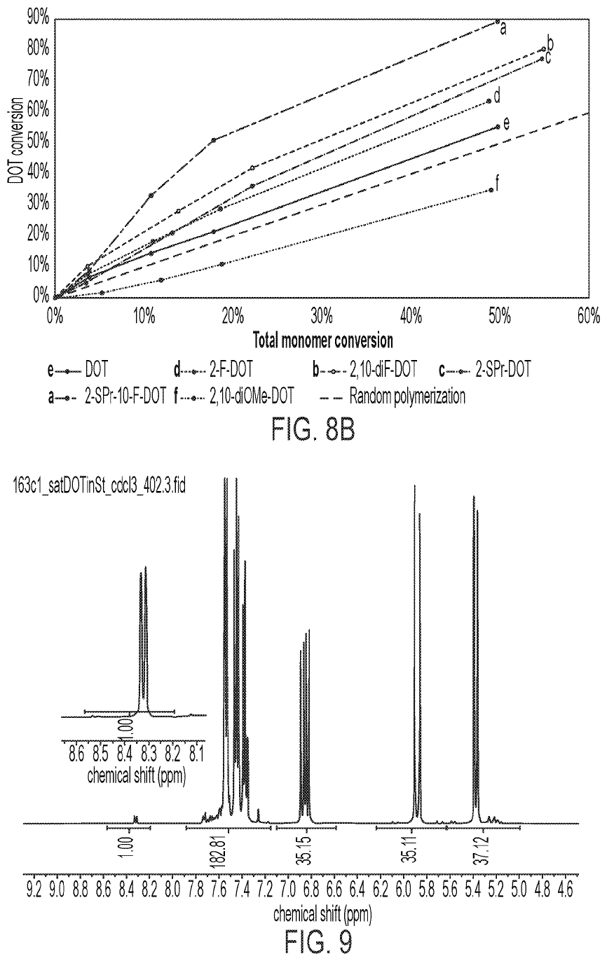

While it was previously reported that DOT does not copolymerize efficiently with styrene,¹⁶ the structural similarity between DOT and thionoester agents known to undergo chain transfer in styrene polymerization²⁶ inspired us to explore conditions for styrene/DOT copolymerization in more detail. Suspecting that substituents may offer a way to tune DOT copolymerization with styrene, we synthesized and screened a small library of DOT derivatives (X-Y-DOT) for their ability to copolymerize with styrene under free radical conditions using AIBN initiator and six solvents of varying polarity (Table 1). Remarkably, substantial incorporation of X-Y-DOT into the copolymers was observed in all cases. Moreover, the mole fraction of incorporated X-Y-DOT (F_{X-Y-DOT*}) was variable based on both the solvent and the DOT substituents, offering orthogonal handles to systematically tune the copolymer composition/microstructure (FIGS. 8A to 8B). Styrene and unmodified DOT were consumed in equal amounts when polymerized in toluene-ds, suggesting that a bulk polymerization (with a dielectric constant similar to toluene) could enable access to high molecular weight, random copolymers.

TABLE 1
Copolymerization of styrene and X-Y-DOT (~10:1 molar ratio) in various solvents.

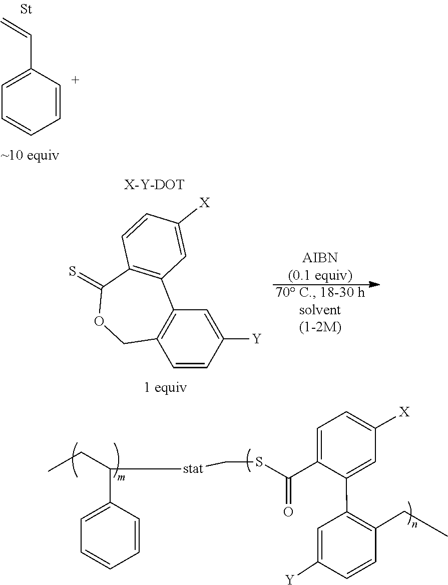

| | | | | | | X-Y- | | | | | | |
|---|---|---|---|---|---|---|---|---|---|---|---|---|
| | | | | | | DOT | St | Total | ƒ_{X-Y-} | F_{X-Y-} | | |
| | X-Y- | | | | Dielectric | Conv. | Conv. | Conv. | _{DOT} | _{DOT} | Mₙ | |
| Entry | DOT | X | Y | Solvent | constant | (%)^{a} | (%)^{a} | (%)^{a} | (%)^{b} | (%)^{c} | (kDa)^{d} | Ð_{M}^{e} |
| 1 | DOT | H | H | toluene- | 2.4 | 63 | 57 | 58 | 9.3 | 10.2 | 12.6 | 1.63 |
| | | | | d₈ | | | | | | | | |
| 2 | DOT | H | H | dioxane- | 2.3 | 50 | 57 | 56 | 9.1 | 8.0 | 15.7 | 1.61 |
| | | | | d₈ | | | | | | | | |
| 3 | DOT | H | H | o-DCB- | 9.9 | 53 | 63 | 62 | 9.1 | 7.8 | 15.7 | 1.62 |
| | | | | d₄ | | | | | | | | |
| 4 | DOT | H | H | DMF | 36.7 | 30 | 57 | 55 | 9.4 | 5.2 | 10.7 | 1.64 |
| 5 | DOT | H | H | MeCN | 37.5 | 27 | 49 | 47 | 9.2 | 5.2 | 8.9 | 1.62 |
| 6 | DOT | H | H | DMSO- | 46.7 | 23 | 66 | 62 | 8.8 | 3.3 | 15.3 | 1.71 |
| 7 | SPr-F- | SPr | F | toluene- | 2.4 | 89 | 53 | 57 | 9.6 | 15.0 | 12.7 | 1.66 |
| | DOT | | | d₈ | | | | | | | | |
| 8 | F₂- | F | F | toluene- | 2.4 | 80 | 52 | 55 | 9.2 | 13.4 | 12.0 | 1.69 |
| | DOT | | | d₈ | | | | | | | | |
| 9 | SPr- | SPr | H | toluene- | 2.4 | 77 | 52 | 55 | 10.3 | 14.4 | 12.7 | 1.65 |
| | DOT | | | d₈ | | | | | | | | |
| 10 | F- | F | H | toluene- | 2.4 | 63 | 47 | 49 | 9.1 | 11.7 | 10.7 | 1.64 |
| | DOT | | | d₈ | | | | | | | | |
| 11 | OMe₂- | OMe | OMe | toluene- | 2.4 | 35 | 51 | 49 | 12.6 | 9.0 | 7.8 | 1.69 |
| | DOT | | | d₈ | | | | | | | | |

All experiments were performed with 1-2 mol % AIBN initiator at a styrene concentration of 1-2M for 18-30 h at 70° C. in a J-Young NMR tube.
^{a}Conversions were measured by ¹H NMR analysis using 1,3,5-trimethoxybenzene as internal standard.
^{b}Molar equiv of X-Y-DOT in monomer feed;
^{c}Molar equiv of X-Y-DOT-derived units in isolated polymer;
^{d}Number average molar mass of isolated polymer;
^{e}Molar mass dispersity of isolated polymer.

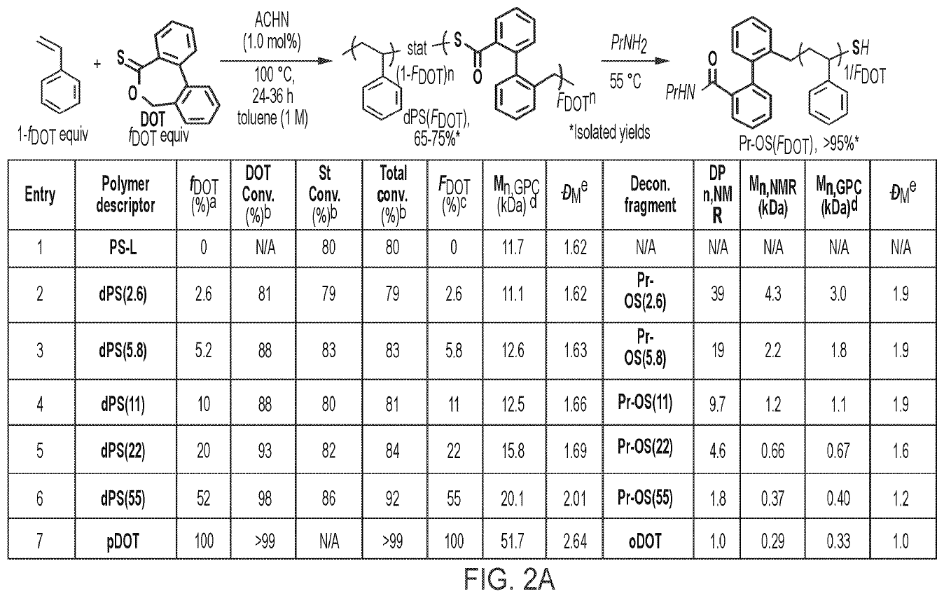

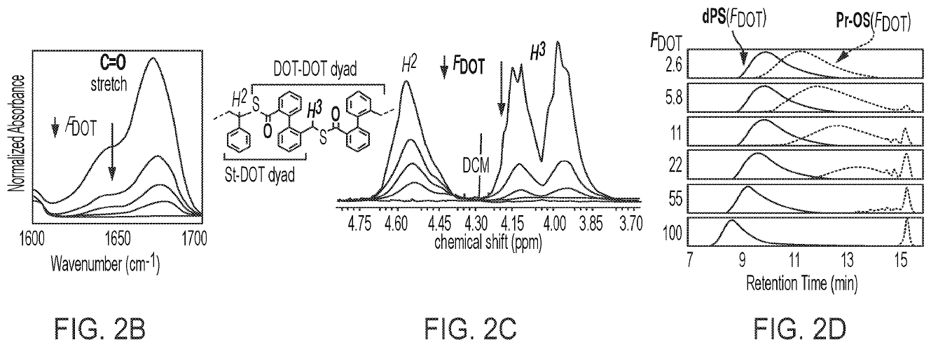

Following this procedure, but replacing AIBN with 1,1′-azobis(cyanocyclohexane) (ACHN), which enabled higher monomer conversions due to its slower decomposition half-life (t_{1/2}=10 h at 88° C.), copolymers with F_{DOT}=2.6-55% (dPS(F_{DOT}), FIGS. 2A to 2D) and F_{DOT}=100% (i.e. DOT homopolymer, pDOT) were synthesized. Size-exclusion chromatography (SEC) revealed that for relatively low levels of DOT incorporation (F_{DOT}=2.6-11%), which are most relevant for the recycling studies below, Ð_{M} and Mₙ were similar to PS homopolymer (PS-L) prepared under the same conditions. Larger molar masses were observed for F_{DOT}>11%, which can be partially explained by the larger mass of DOT (2.2× that of styrene), but may also reflect differences in termination mechanism or errors in SEC calibration as the copolymer compositions deviate from PS.

The incorporation of thioesters in the backbone of each deconstructable PS was supported by ATR-IR (FIG. 2B) and NMR (FIG. 2C) spectroscopies and deconstruction studies (FIGS. 2A and 2D). In the former, the intensities of peaks associated with the thioester C═O stretch (˜1620-1700 cm⁻¹) positively correlated with F_{DOT}. Meanwhile, ¹H NMR resonances in the 3.7-4.7 ppm region, which were assigned with the aid of ¹H-¹³C Heteronuclear Multiple Bond Correlation (HMBC) to protons adjacent to the thioester functionality, were used to measure F_{DOT} and gain insight into the copolymer microstructure. Significantly, these studies indicated that F_{DOT}≈f_{DOT} for all compositions tested. Deconstruction of these copolymers via thioester cleavage using n-propylamine (FIGS. 2A and 2D) yielded, in all cases, narrowly dispersed (Ð_{M}=1.0-1.9) oligomers with predictable molar masses based on an assumption of a random copolymerization. Combined, these results provide strong evidence for the nearly random copolymerization of DOT and styrene under these conditions, providing access to chemically deconstructable PS analogs.

Mild, Selective Chemical Deconstruction of dPS into Difunctional Oligostyrene Fragments.

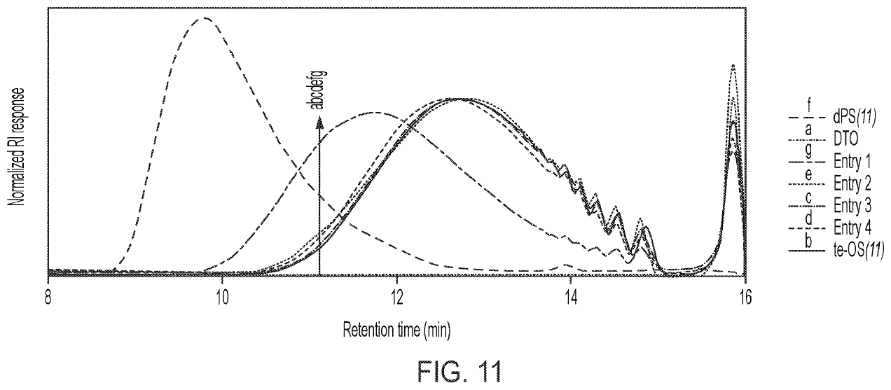

A key challenge that has precluded the realization of chemically circular vinyl polymers through the cleavable comonomer approach is the development of mild yet selective deconstruction conditions that can provide α,ω-functionalized, well-defined oligomeric products in high yield and purity that are suitable for repolymerization. Here, we suspected that the use of either thiolate or bifunctional amine nucleophiles for PS deconstruction could solve these challenges. Under optimized conditions, treatment of dPS(11) with either of three readily available cleaving agents—allylamine, ethanethiol, or cysteamine (Scheme 2)—afforded α,ω-functionalized oligostyrene fragments allyl-OS(11), te-OS(11), and thiol-OS(11), respectively, in excellent yields and high purities. These products differ only in the nature of the reactive group at the a terminus (allyl, thioester, and thiol, respectively), and each would in principle be suitable for step-growth repolymerization. Polar solvents are known to best facilitate thioester cleavage;²⁷ indeed, DMF was an excellent solvent for these deconstruction reactions (Table 2 and FIG. 11). Notably, however, neat allylamine and ethanethiol were most effective for the synthesis of allyl-OS(11) and te-OS(11), which avoids the need for an additional organic solvent.

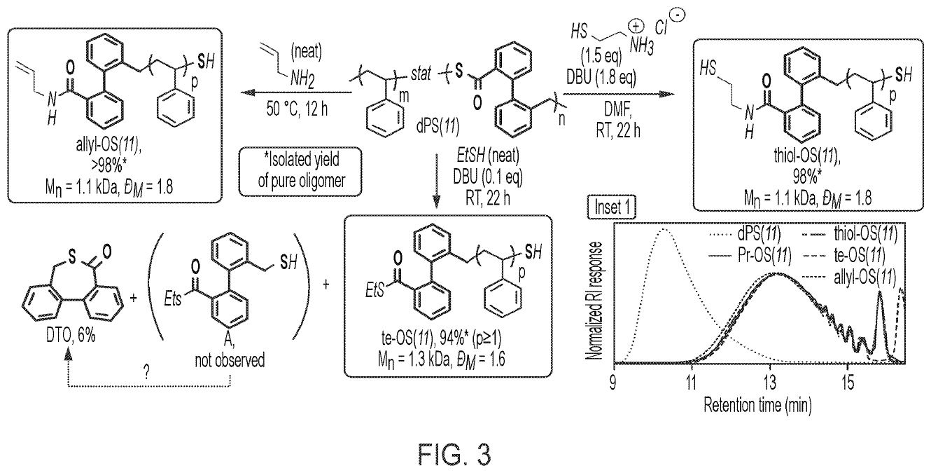

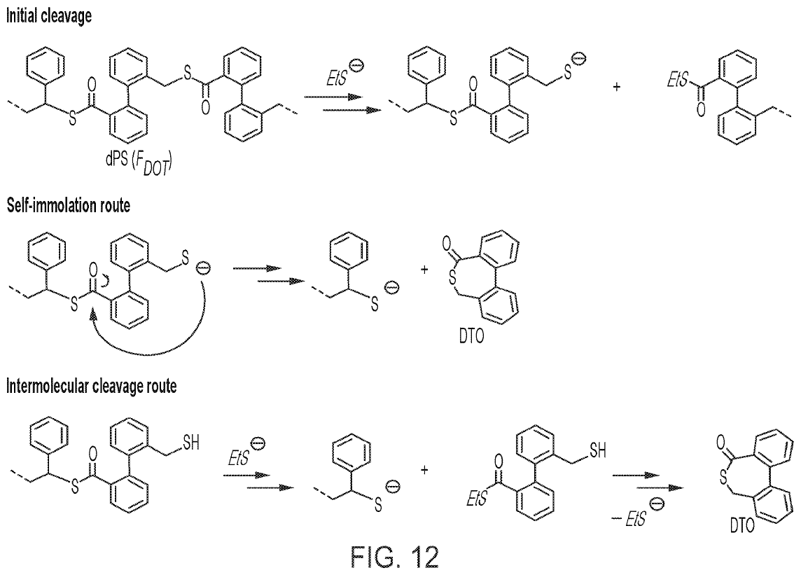

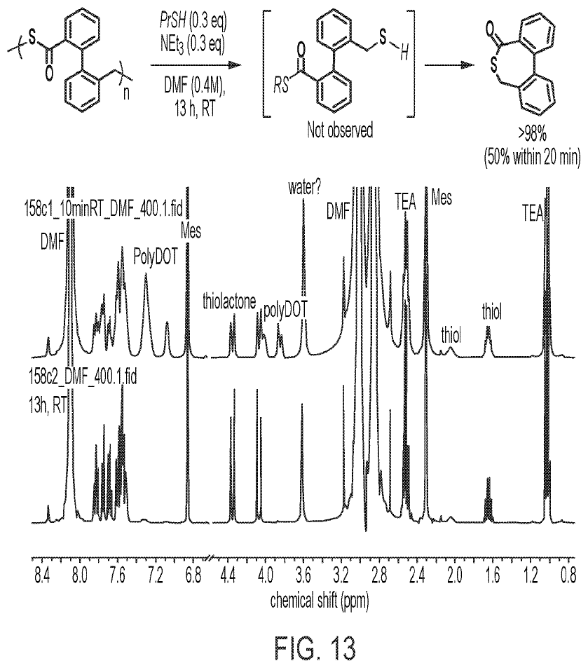

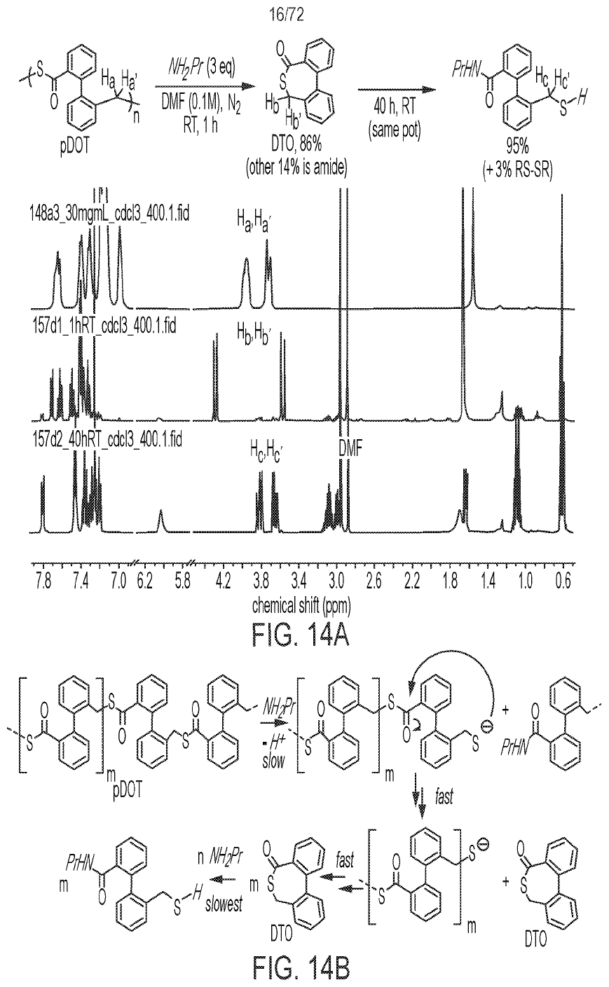

The extent of thioester cleavage was quantified by ¹H NMR spectroscopy (FIG. 3, Inset 2). The resonances for methine and methylene protons a to the thioester functionality in the polymer (4.3-4.7 ppm and 3.8-4.2 ppm, respectively, in benzene-d₆) shifted upfield to 3.3-3.8 ppm upon thioester cleavage, indicating formation of thiol functionality. In the case of allyl-OS(11) and thiol-OS(11), all observable fragments possessed the structure depicted in Scheme 2, and end-group concentrations matched those expected from the concentration of thioester functionality in the polymer, suggesting quantitative yields of the desired deconstruction products. By contrast, oligomer te-OS(11) was obtained in 94% yield (by mass) along with dibenzo[c,e]thiepin-5(7H)-one (DTO) in 6% yield. The latter could arise either from the cyclization of putative species A or from a self-immolative²⁸ process involving DOT-DOT dyads in the copolymer backbone (FIG. 12). Strong evidence that a self-immolative mechanism can operate is provided by the observation that pDOT undergoes self-immolative deconstruction to form DTO>98% yield (FIGS. 13 and 14A to 14B). DTO is expected to be inert under many conceivable repolymerization strategies, and thus its removal prior to repolymerization may not be necessary.

### Repolymerization of Oligostyrene Fragments to Generate Recycled PS

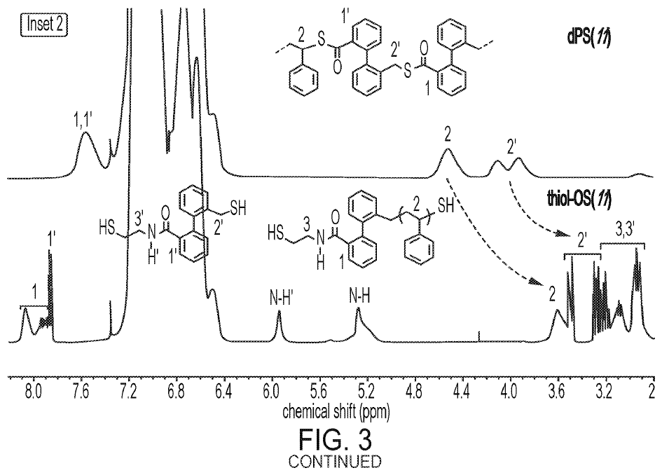

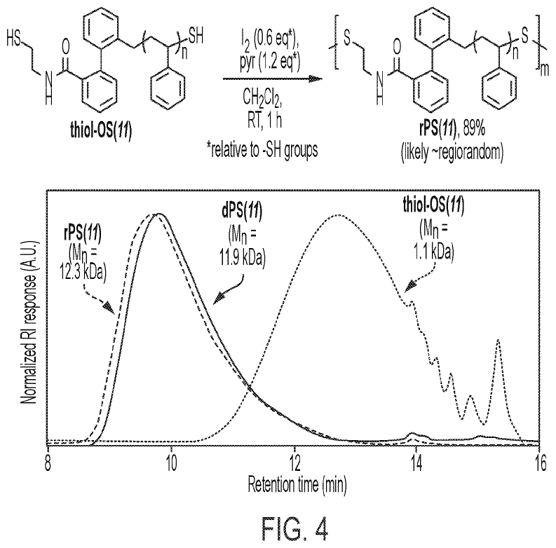

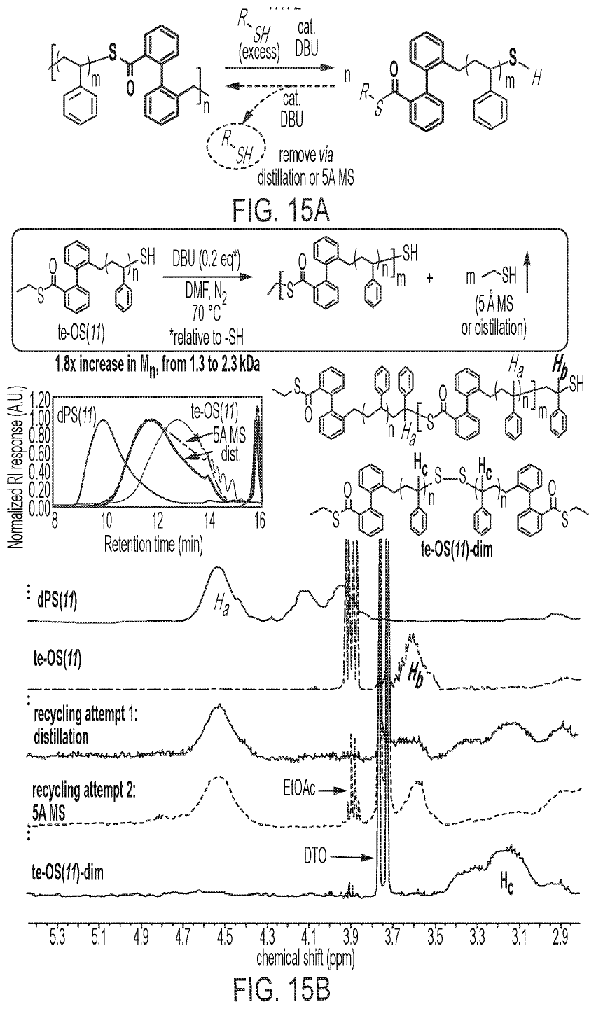

Next, we sought conditions for the polymerization of the new difunctional fragments to regenerate PS. We first explored polycondensation of te-OS(11) through removal of ethanethiol (FIGS. 15A to 15B), which could in principle furnish the original dPS(11); however, we observed only a two-fold increase in molecular weight, suggesting that such a route may be viable but requires further optimization. Meanwhile, initial success with oxidative polymerization of thiol-OS(11) (FIG. 4) led us to explore this approach in more depth, as such step-growth couplings would be atom economical and potentially amenable to a wide range of conditions under which the thiol/disulfide redox couple can be manipulated. Furthermore, precedent on the polycondensation of thiol-terminated PS provided a starting point.^{29,30}

First, disulfide bond formation conditions were optimized using small-molecule and monofunctional macromolecular models (Table 3 and FIGS. 15A to 15B). The use of 12 as oxidant in the presence of pyridine as H—I scavenger provided quantitative yield and was rapid, convenient, and reliable. Indeed, treatment of thiol-OS(11) (Mₙ=1.1 kDa) with these reagents in dichloromethane solvent followed by precipitation from methanol afforded recycled polymer rPS(11) (Mₙ=12.3 kDa) in 89% isolated yield. The molecular weight distribution of rPS(11) was nearly identical to that for dPS(11); the slight increase in Mₙ may be attributable to the inserted group from the cleavage reagent. Theoretical considerations suggest that the presence of monofunctional fragments in thiol-OS(11) derived from end groups in dPS(11) will limit the Mₙ to the value of the original dPS(11) plus the mass of the cleavage reagent. This “molecular weight memory” effect suggests that recycled PS can be generated from deconstructed PS in excellent yield.

### Decagram Synthesis of Chemically Recyclable, High Molecular Weight PS.

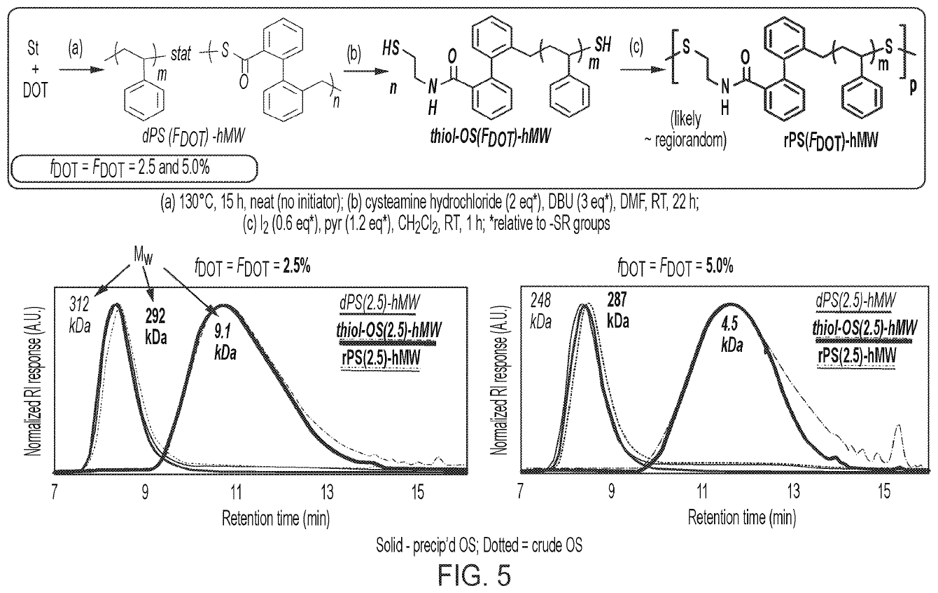

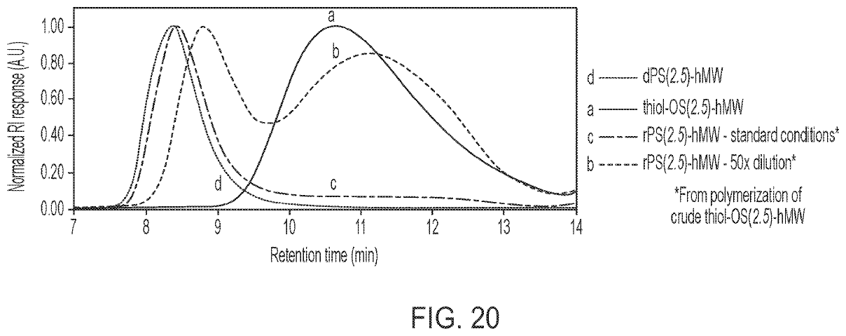

Having demonstrated proof-of-concept for chemical recycling of relatively low molecular weight PS on small scales, we next sought to apply a similar workflow to high molecular weight PS on larger scale (FIG. 5), as the useful thermomechanical properties of PS appear at around 10× entanglement molecular weight, which is ˜18 kDa.³¹ Therefore, we screened conditions to obtain high molecular weight deconstructable PS(Table 4). Remarkably, when bulk mixtures of styrene and DOT were heated at 130° C. for 15 h in the absence of an exogenous initiator, 15-20 g each of dPS(2.5)-hMW and dPS(5.0)-hMW with M_{w} values of 312 and 248 kDa, respectively, and f_{DOT}=F_{DOT} were isolated. Deconstruction of these samples into thiol-OS(2.5)-hMW and thiol-OS(5.0)-hMW proceeded in >98% isolated yields to give fragments with M_{w}=9.1 and 4.5 kDa, ÐM≈2, and high end group fidelity. Finally, oxidative repolymerization of these crude fragments, without any purification, afforded rPS(2.5)-hMW and rPS(5.0)-hMW, in which 68% (212 kDa) and 62% (154 kDa) of the M_{w} of dPS(2.5)-hMW and dPS(5.0)-hMW, respectively, was recovered. These values were improved to a remarkable 94% (292 kDa) and 116% (287 kDa) if the OS fragments were first precipitated from methanol, perhaps due to removal of small-molecule impurities that hinder the step-growth repolymerization process. The overall isolated yields of rPS(2.5)-hMW and rPS(5.0)-hMW from the deconstruction/precipitation/recycling cycle were 80-85%. If the intermediate precipitation is forgone, such yields improve to 90-95%. The SEC traces of the recycled PS samples showed some tailing toward low molecular weights, which can likely be attributed to cyclic polymers formed during the oxidative repolymerization (FIG. 20). Nevertheless, these results show that it is possible to synthesize high molecular weight deconstructable PS on decagram scales under industrially relevant bulk conditions, deconstruct those polymers into low mass fragments, and repolymerize them under mild conditions to generate recycled PS with nearly equivalent molar mass, in excellent yields.

### “PS-Like” Thermal and Thermomechanical Properties at Low Comonomer Loading.

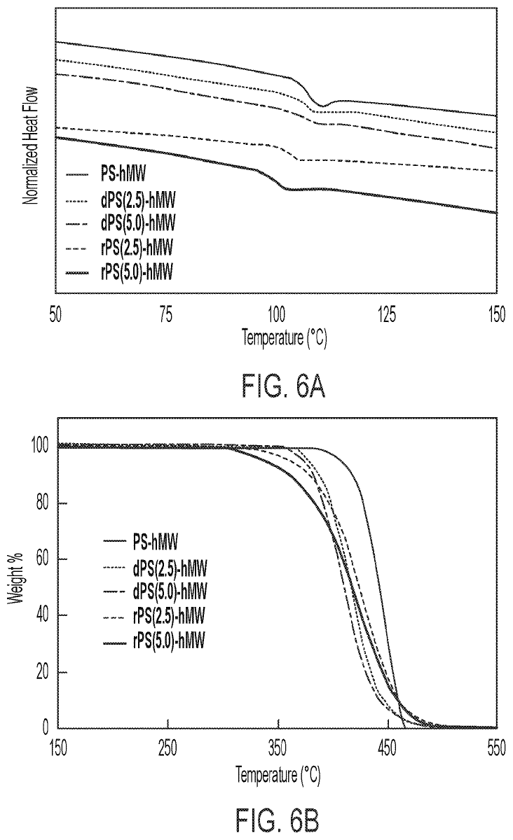

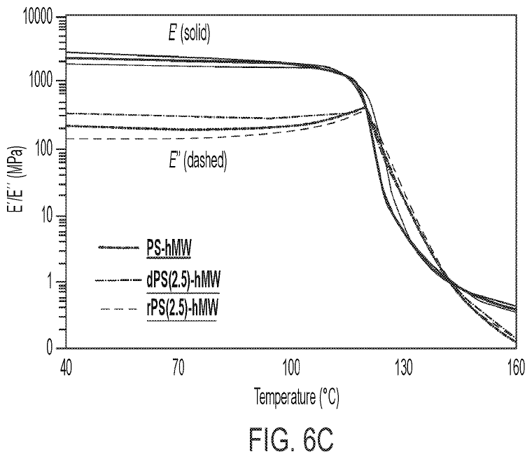

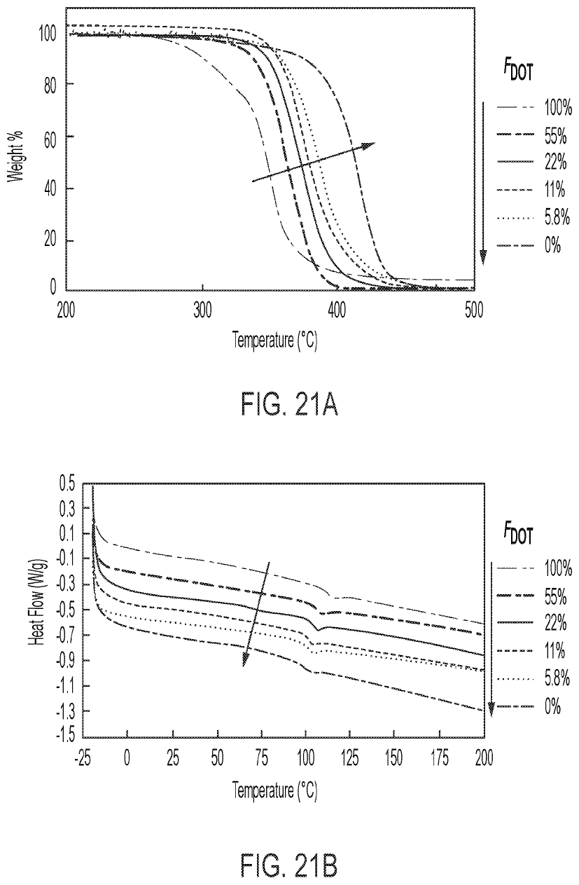

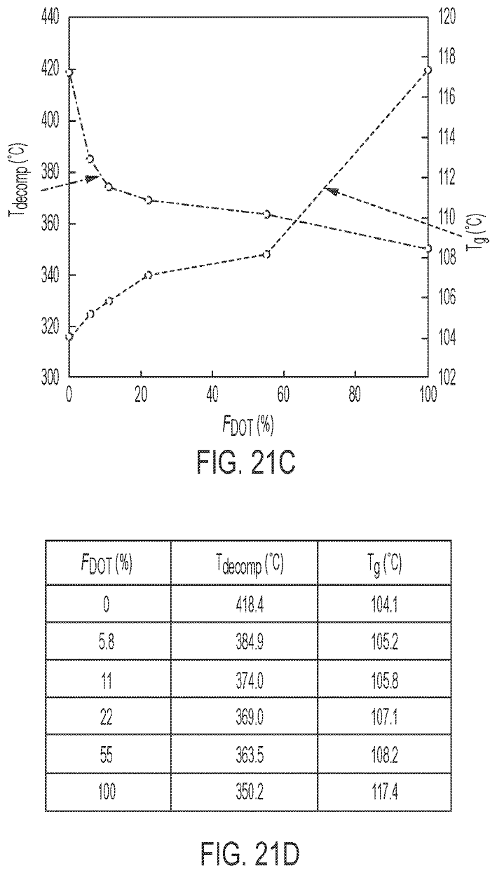

The thermal properties of the high M_{w} polymers were probed using differential scanning calorimetry (DSC, FIG. 4a) and thermal gravimetric analysis (TGA, FIG. 6B; see FIGS. 21A to 21D for analogous studies on the full series of low M_{w} dPS). An identical glass transition temperature (T_{g}) of 107° C. was obtained for dPS(2.5)-hMW, dPS(5.0)-hMW, and virgin PS prepared under identical conditions (PS-hMW). The T_{g} values for the recycled samples showed only slight decreases (103 and 100° C. for rPS(2.5)-hMW and rPS(5.0)-hMW, respectively). The thermal decomposition temperatures at 5% mass loss (T_{d}, 5%) were slightly lower for the deconstructable PS samples (378 and 372° C. for dPS(2.5)-hMW and dPS(5.0)-hMW, respectively) relative to PS-hMW (408° C.), whereas those for the recycled PS samples dropped further to 360 and 337° C. for rPS(2.5)-hMW and rPS(5.0)-hMW, respectively. Despite the small-to-modest decreases in T_{d,5%} values, all polymers retained excellent thermal processing windows, from a low of 237° C. for rPS(5.0)-hMW to a high of 271° C. for dPS(2.5)-hMW (compared to 301° C. for PS-hMW).

Given that dPS2.5-hMW and rPS2.5-hMW displayed thermal properties similar to virgin PS, and that these samples involved the lowest cleavable comonomer loading, which is advantageous from a manufacturing perspective, we investigated their thermomechanical properties using dynamic mechanical analysis (DMA) (FIG. 6C). Compression molded rectangular bars of each sample displayed nearly identical temperature sweep curves compared to virgin, non-destructible PS-hMW. Elastic moduli (E′) ranged from 1.9-2.7 GPa, in good agreement with reported values for virgin PS(1-3 GPa³²).

Herein, we have shown that cleavable comonomers can be used to impart chemical circularity to the commodity polymer polystyrene. Looking forward, this concept has numerous implications for sustainable polymer design. First, it provides a roadmap for the development of “drop-in” additives that are compatible with current polymerization techniques (e.g. free radical polymerization) that leverage existing infrastructure, which may facilitate rapid adoption compared to systems that depend on new chemistries. Second, because the properties of deconstructable copolymers prepared using cleavable comonomers can be very similar to those of virgin materials, they can avoid the property-sustainability tradeoff that plagues many attempts to deploy novel polymers. Third, while we herein demonstrate these concepts for PS, we expect them to apply broadly to other vinyl polymers prepared using radical polymerization. Moreover, cleavable comonomers can presumably be designed for any polymer chemistry of interest, which will provide numerous opportunities for fundamental synthetic, theoretical, and analytical advances in polymer sciences.

### General Considerations

Unless otherwise stated, all reactions were performed in dry solvents under an atmosphere of nitrogen, using either standard Schlenk techniques or a glovebox. “Room temperature”, “RT”, or “ambient temperature” refers to ˜22° C. Reaction temperatures represent the oil bath temperature (with a fully submersed, stirred solution) unless otherwise stated.

### Materials and Purification Methods

### Styrene Purification

Styrene was purchased from Sigma Aldrich (ReagentPlus®, >=99%; SKU: S4972), stored at ˜2° C., and used within 3 months of purchase. Immediately before each use, it was freed from the stabilizer (4-tert-butylcatechol) as follows. A syringe was packed with basic alumina equal in mass to the amount of styrene to be purified. The alumina plug was solvated with styrene, then one column volume of styrene was eluted and discarded. The desired mass of styrene was then collected and used immediately.

### Reagent/Solvent Sources and Purification

N,N-Dimethylformamide (DMF) used for polymer deconstruction was purchased Alfa Aesar (stock no: 43465, anhydrous, amine free, 99.9%), transferred to a Strauss flask containing 4 Å molecular sieves (5% by mass), and freed from O₂ and residual amine by removal of 3-5% of the volume in vacuo. Cysteamine hydrochloride was recrystallized from absolute EtOH and stored in a desiccator. 2,2′-Azobis(2-methylpropionitrile) (AIBN) and 1,1′-azobis(cyanocyclohexane) (ACHN) were recrystallized from MeOH and absolute EtOH, respectively, and stored at ˜2° C. Lawesson's reagent was purchased from Oakwood Chemical and used as received. All other reagents and solvents were purchased from commercial suppliers and used as received.

### Chromatography

Column chromatography was carried out using Fischer Chemical 40-63 μm, 230-400 mesh silica gel. Preparatory thin layer chromatography (prep TLC) was carried out using Analtech Silica Gel GF UNIPLATES (1000 μm, 20×20 cm). For prep TLC, in a typical procedure, 35-50 mg of material was loaded onto one side of the plate and the solvent front was allowed to elute halfway up (i.e. 70-100 mg can be separated per plate).

### Precipitation

Polymer precipitations carried out in this study were typically performed as follows. The crude polymer was dissolved in CH₂Cl₂ (˜10 mL/g for low M_{w} samples and ˜15 mL/g for high M_{w} samples) and this solution was added dropwise to a 10-fold excess of rapidly stirred MeOH (5-fold was sufficient in the case of decagram-scale purifications to avoid impractical volumes of solvent). The precipitate was collected on a medium porosity fritted funnel and the solid was quantitatively transferred to the frit with the aid of additional MeOH. The solid was allowed to dry in a stream of air on the frit for ˜1 h, then this procedure was repeated the indicated number of times. To avoid excessive mechanical losses, especially on a small scale, CH₂Cl₂ was used to quantitatively recombine the precipitated solid before each subsequent precipitation. After the final precipitation, residual solvents were removed from the sample under high vacuum until the mass remained constant (>12 h at RT or 3 h at 50° C. were both found to be generally effective).

### Analytical Methods

### Nuclear Magnetic Resonance (NMR) Spectroscopy

Unless otherwise noted, NMR spectra were acquired at ambient temperature (˜22° C.) at the MIT Department of Chemistry Instrumentation Facility using Bruker AVANCE III DRX 400 or Neo 500 spectrometers. Chemical shifts (δ) are given in ppm and referenced to residual solvent peaks for ¹H NMR spectra (δ=7.26 ppm for chloroform-d, δ=7.16 for benzene-d₆, δ=5.32 for dichloromethane-d₂, and δ=2.09 for toluene-d₈) and for ¹³C {¹H} NMR spectra (δ=77.16 ppm for chloroform-d).

### High Resolution Mass Spectrometry (HRMS)

HRMS measurements were obtained on a JEOL AccuTOF system at the MIT Department of Chemistry Instrumentation Facility.

### Size Exclusion Chromatography (SEC)

Analytical gel permeation chromatography was performed on a Tosoh EcoSEC HLC-8320 with dual TSKgel SuperH3000 columns and an ethanol-stabilized chloroform mobile phase. Sample concentrations were ˜1 mg/mL. Samples were filtered through 0.2 μm PTFE syringe filters before injection into the instrument. Molecular weight values were calculated according to linear polystyrene calibration standards. All SEC traces were referenced to a toluene internal standard.

### Thermal Gravimetric Analysis (TGA)

TGA studies were performed on ˜2-3 mg samples. Analyses were performed on a TGA/DSC 2 STAR System (Mettler-Toledo) equipped with a Gas Controller GC 200 Star System. Studies were performed under a constant stream of nitrogen gas at a temperature ramp of 20° C./min.

### Differential Scanning Calorimetry (DSC)

DSC studies were performed on ˜6-8 mg samples. Analyses were performed on a TGA/DSC 2 STAR System (Mettler-Toledo) equipped with a RCS1-3277 DSC cell and a DSC1-0107 cooling system. Each sample was sealed in an aluminum pan and subjected to three heating/cooling cycles from −20° C. to 200° C. at a rate of 10° C./min. The T_{g} values were recorded from the second heating ramp using the maximum absolute value of the derivative of heat flow with respect to temperature. DSC traces on the second and third heating cycles were identical for all samples reported herein.

### Dynamic Mechanical Analysis (DMA)

DMA was performed on a Discovery DMA 850 System (TA). Samples with dimensions ca. 2.5×1.0×12 mm (w×t×1), prepared as described below, were tested in tensile mode. Measurements were recorded at a frequency of 1 Hz and an amplitude of 0.1% strain from c.a. 40-180° C. at a heating rate of 3° C./min with a data sampling interval of 3 s/pt, using a 125% force tracking and 0.01 N preload force. Data were collected using Trios software and exported to Microsoft Excel for analysis. Experiments were performed at the MIT Institute for Soldier Nanotechnologies. Reported modulus values in the main text are for measurements made at 40° C.

### Compression Molding for DMA Sample Preparation

Rectangular bars for DMA were prepared by compression molding of MeOH-precipitated samples. The solid was iteratively pressed into disks of 28 mm diameter and 1.5 mm thickness. First, eight circular samples were prepared by filling a die with PS and pressing at 4 tons pressure, 50° C. for 1 minute. Next, each of these samples was combined with another under identical conditions to produce four samples. This process was repeated once more to yield two disks, which were then pressed together under 4 tons of pressure at 130° C. for 10 minutes to yield a single transparent disk. Rectangular bars were cut from this disk and sanded to uniformity.

### Evidence for Polymer Stability Under the Processing Conditions

The stability of each polymer (PS-hMW, dPS(2.5)-hMW, and rPS(2.5)-hMW) under the compression molding conditions described above was assessed by SEC analysis of pre- and post-processed material. The molecular weight distributions displayed no detectable changes in all cases.

### General Route to Functionalized DOT Derivatives for Modifications of Reactivity and Solubility.

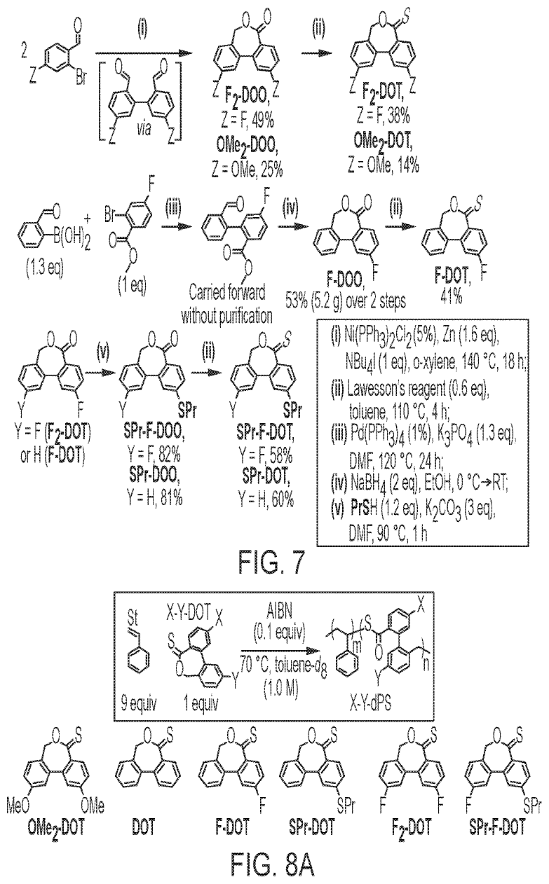

Three different DOT functionalization strategies were developed, all culminating in a thionation with Lawesson's reagent to produce the desired DOT derivative (FIG. 7). These only differ in the details of the synthesis of the dibenzo[c,e]oxepin-5 (7H)-one (DOO) precursor to the DOT derivative.

### Determination of the Solubility of DOT in Styrene

The solubility of DOT in styrene at 22° C. was determined by quantitative ¹H NMR spectroscopy to be 1.0 molar equiv of DOT per 35 molar equiv of styrene, as described here. First, a saturated solution of DOT in styrene was prepared. To a vial containing 20 mg (0.088 mmol) of freshly recrystallized DOT was added 145 mg (16 equiv) of styrene. This mixture was vortexed for ˜5 min and then allowed to stand for 10 min. A lot of solid DOT remained. The mixture was passed through a 0.2 μm filter into an NMR tube (the temperature during filtration was 22° C.). The mixture was then diluted with chloroform-d and analyzed by quantitative ¹H NMR spectroscopy (FIG. 9).

Measurement of Dyad Content and F_{DOT} by ¹H NMR Spectroscopy

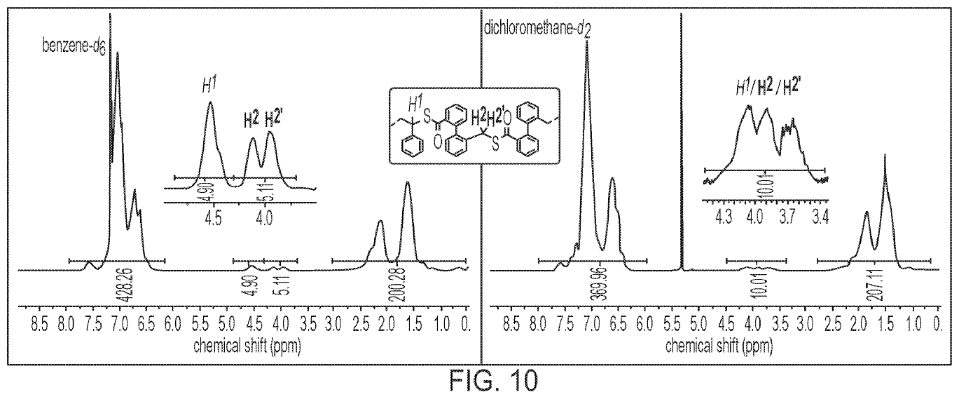

The protocol for F_{DOT} measurement by ¹H NMR spectroscopy is described in detail here for dPS(11) using the ¹H NMR spectra shown in FIG. 10, and it was identical for all dPS(F_{DOT}) and dPS(F_{DOT})-hMW samples prepared herein. Overlap of styrenic chemical shifts with those of DOT units necessitated an indirect approach. Since the methine and methylene resonances alpha to the thioester unit (H¹ and H²/H²′ in FIG. 10) displayed no overlap with styrenic resonances, they were used to quantify ring-opened DOT content. This calculation requires a knowledge of the relative amounts of methine (H¹) and methylene (H²/H^{2′}) resonances, which in turn provide % DOT-DOT dyads and % St-DOT dyads. Fortunately, in benzene-d₆ solvent, these resonances do not overlap (in contrast to chloroform-d and dichloromethane-d₂).

The content of DOT-terminated dyads for dPS(11) is calculated as follows (note: the other two dyads, St-St and DOT-St, are not derived here):

$$\% DOT - DOT = ( 5.11 / 2 ) / ( 5.11 / 2 + 4.9 ) = 34 \%$$

$$\% St - DOT = 4.9 / ( 5.11 / 2 + 4.9 ) = 66 \%$$

Likewise, using the arbitrary units of the benzene-d₆ ¹H NMR spectrum:

$$Relative mol of DOT = 4.90 + 5.11 / 2 = 7.46$$

Next, we use the aromatic region for determining St content. Since there is chemical shift overlap with solvent residual in benzene-d₆, for greatest accuracy we use the dichloromethane-d₂ ¹H NMR spectrum to indirectly obtain an integration of the aromatic region of 367, which was determined by normalizing that spectrum such that the integration of the 3.4-4.4 ppm region is 4.90+5.11=10.01. Thus, subtracting out the integration of DOT-derived resonances, which are indirectly obtained by the relative mol of DOT derived above, we get:

$$Relative mol of St = ( 367 - 7.46 * 7 ) / 5 = 63.$$

### Finally,

$${F}_{D O T} = ( mol DOT units ) / ( mol DOT units + mol St units ) = 1 / 1 ( mol St units / mol DOT units ) ) = 1 / ( 1 + ( 63. / 7.46 ) = 0.0 \; 106 or 10.6 \% .$$

### Thiolate-Mediated Deconstruction Conditions: Initial Screening

The optimal conditions in the main text employ neat EtSH as cleavage reagent, but initial studies were performed with PrSH as nucleophile at 0.1 M thioester concentration in DMF solvent (Table 2 and FIG. 11). Remarkably, only 2 equiv of PrSH is required to cleave >95% of the thioester bonds, and equilibrium is reached within 1 hr at RT with DBU as catalyst.

TABLE 2
Initial studies on the thiolate-mediated deconstruction of dPS(11).

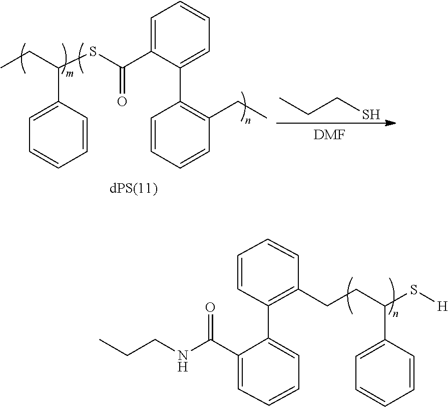

| | | | M_{n,SEC} | |
|---|---|---|---|---|
| Entry | Conditions^{a} | Conversion^{b} | (kDa)^{d} | Ð_{M}^{e} |
| 1 | PrSH (3 eq), NEt₃ (3 eq), | 65% | 2.2 | 1.8 |
| | 110° C., 3 h | | | |
| 2 | PrSH (6 eq), NEt₃ (6 eq), | 88% | 1.3 | 1.7 |
| | 110° C., 18 h | | | |
| 3 | PrSH (6 eq), DBU (1 eq), | >98%^{c} | 1.3 | 1.6 |
| | RT, 1 h | | | |
| 4 | PrSH (2 eq), DBU (0.3 eq), | 95%^{c} | 1.4 | 1.6 |
| | RT, 1 h | | | |

Data is for crude oligomer isolated evaporation of volatile materials under vacuum.
^{a}Reactions were performed under N₂ at 0.1M thioester concentration;
^{b}Consumption of thioester units, determined by ¹H NMR spectroscopy;
^{c}Unchanged after 22 h;
^{d}M_{n,SEC} = number average molar mass;
^{e}Ð_{M} = Molar mass dispersity.

Self-Immolation in the Deconstruction of dPS(F_{DOT}) and DOT Homopolymer (pDOT)

The observation of the thiolactone DTO in an amount equal to the % of DOT-DOT dyads in dPS(11) upon treatment of the latter with thiolate motivated us to investigate the possibility that such dyads may deconstruct in a catalytic, i.e. self-immolative,¹ process like that shown FIG. 12.

### Preliminary Studies Toward Te—OS(11) Polycondensation for PS Recycling

As shown in FIG. 15A, the polycondensation of the thioester-thiol terminated oligomers produced herein could in principle serve as means to furnish the original dPS(note: in practice, since DTO is produced in an amount equal to the % of DOT-DOT dyads and is potentially unreactive, such dyads may be absent in the recycled version). Given that it only took 2 equiv of 1-propanethiol to achieve 95% cleavage of in-chain thioester groups (Table 2, entry 4), we anticipated that thermodynamics may require the removal of the byproduct thiol for the reverse process to be feasible. Thus, since ethanethiol should be easier to remove both due to its smaller size and lower boiling point (35° C. vs. 68° C. for 1-propanethiol), we switched the nucleophile in the deconstruction step to ethanethiol (which gives the fully characterized oligomer te-OS(11) used herein).

The two experiments were performed concurrently, and they only differ by method of EtSH removal. A 1.8× increase in Mₙ was observed in each case, and the appearance of resonances at 4.5 ppm in the ¹H NMR spectra (benzene-d₆) provide strong evidence that the desired thioester formation is occurring.

Inspection of the 3.0-3.5 ppm region of these spectra indicate that oxidation to disulfide (te-OS(11)-dim) is an important side reaction, which likely occurs due to adventitious O₂ that is difficult to fully remove in small scale experiments (100 mg of oligomer, ˜0.05 mmol thiol end group concentration). This was verified by comparison with an independently synthesized te-OS(11)-dim sample. As expected, these resonances are much less prominent in 5A MS reaction since it was run in a sealed tube. The other factor that likely limited further Mₙ growth is the relatively large amount of DBU that was used (0.2 equiv), which could hinder efforts to push the equilibrium toward polymer since it may hinder the ability to remove thiol. These small-scale experimentation challenges prompted us to quickly sideline these studies in favor of the dithiol polyoxidation presented in the main text. We note, however, that these challenges are expected to be easier to mitigate on a larger scale.

### Optimization of Disulfide Formation on a Model System

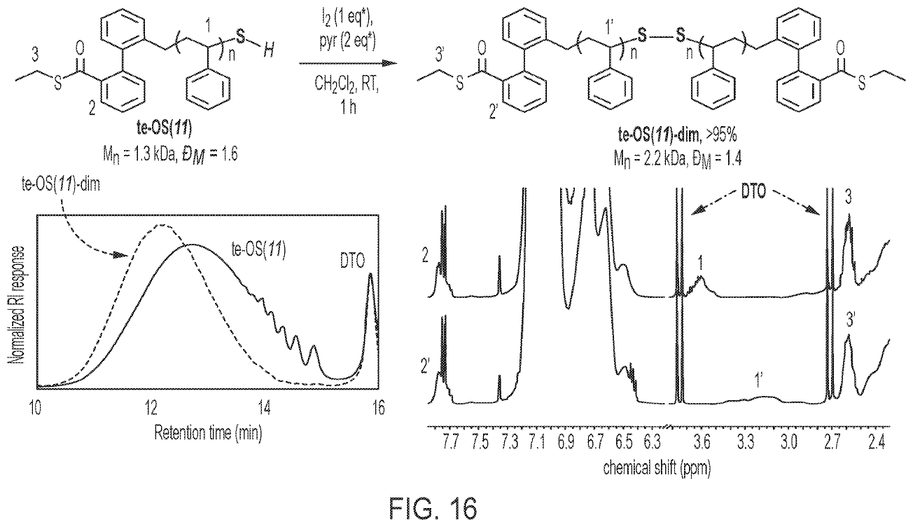

Since near-quantitative disulfide formation is required for an efficient step-growth polymerization, a range of common thiol oxidants was first screened in a model small molecule system (Table 3), which was chosen to emulate the alpha-terminal thiol in thiol-OS(11). The most promising reagent was then applied to the dimerization te-OS(11) as a model for the omega-terminal SH group (FIG. 16).

TABLE 3
Small-molecule model system for disulfide formation.

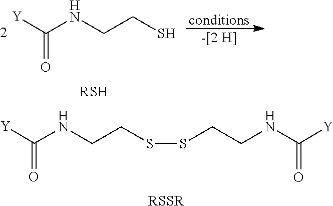

| | | | Consumption | Yield of | |
|---|---|---|---|---|---|
| Entry | X | Conditions | of RSH^{a} | RSSR^{a} | Comments |
| 1 | O^{t}Bu | I₂ (0.6 eq), | >99% | 36% | Yield drops to 16% |
| | | CD₂Cl₂, 1.5 h, RT | | | after 24 h. Rest is |
| | | | | | complex mixture. |
| | | | | | Partial Boc group |
| | | | | | cleavage. |
| 2 | Me | I₂ (0.6 eq), | 94% | <1% | Only 6% of mass |
| | | CD₂Cl₂, 1.5 h, RT | | | balance observable |
| | | | | | by ¹H NMR; brown |
| | | | | | oil separates |
| 3 | O^{t}Bu | I₂ (0.6 eq), pyr (1.2 | >99% | >99% | Reaction likely |
| | | eq) CD₂Cl₂, 1.5 h, RT | | | complete at end of |
| | | | | | I₂/pyr addition. No |
| | | | | | change in yield after |
| | | | | | 24 h. Order of |
| | | | | | addition is not |
| | | | | | important. |
| 4 | O^{t}Bu | I₂ (0.6 eq), pyr (1.2 | >99% | 69% | Yield after 24 h was |
| | | eq), C₆D₆, 1.5 h, RT | | | 64%. RSSR is the |
| | | | | | sole observable |
| | | | | | species. |
| 5 | O^{t}Bu | I₂ (0.6 eq), pyr (1.2 | >99% | >99% | Same observations |
| | | eq), CD₂Cl₂/C₆D₆ | | | as 3 |
| | | (1:1), 1.5 h, RT | | | |
| 6 | O^{t}Bu | (pyrS)₂ (0.6 eq), | >99% | 79% | Hypothesized other |
| | | CD₂Cl₂, 48 h, RT | | | product is the |
| | | | | | unsymmetrical |
| | | | | | disulfide RS-Spyr |
| | | | | | (~21%). After 24 h, |
| | | | | | RSH consumption |
| | | | | | and RSSR yield |
| | | | | | were 89% and 63%, |
| | | | | | respectively. |
| 7 | O^{t}Bu | (pyrS)₂ (0.6 eq), | >99% | 78% | Hypothesized other |
| | | AcOH (0.3 eq), | | | product is the |
| | | CD₂Cl₂, 48 h, RT | | | unsymmetrical |
| | | | | | disulfide RS-Spyr |
| | | | | | (~22%). After 24 h, |
| | | | | | RSH consumption |
| | | | | | and RSSR yield |
| | | | | | were 93% and 70%, |
| | | | | | respectively. |
| 8 | O^{t}Bu | NEt₃ (2 eq), air | 5% | <1% | |
| | | CD₂Cl₂, 24 h, RT | | | |
| 9 | O^{t}Bu | FeCl₃ (1.1 eq), | 99% | 8% | Only 10% of mass |
| | | CD₂Cl₂, 24 h, RT | | | balance observable |
| | | | | | by ¹H NMR. Boc |
| | | | | | group was probably |
| | | | | | cleaved² |
| 10 | Me | FeCl₃ (1.1 eq), | 99% | <1% | <10% of mass |
| | | CD₂Cl₂, 1.5 h, RT | | | balance observable |
| | | | | | by ¹H NMR |

All experiments were conducted at 0.3M concentration of RSH.
(pyrS)₂ = 2,2′-dipyridyl disulfide.
^{a}Measured by ¹H NMR spectroscopy using mesitylene as internal standard.

### Theoretical Basis for “Molecular Weight Memory” in the Repolymerization of OS Fragments

Consider a single polymer chain of a given molecular weight M with N cleavable units dispersed throughout. If all cleavable units in this chain are cleaved, we are left with N−2 bifunctional fragments and 2 monofunctional fragments (assuming a negligible amount of cleavable comonomer dyads, triads, etc.). The number average molecular weight of each fragment will be equal to M/N. Assuming no deleterious side reactions occurred in the cleavage event, for a step growth polymerization of this mixture of bi- and mono-functional fragments, there is an average fragment functionality, f_{n,avg}, of (2N−2)/N. For a step growth polymerization with extent of functional group conversion, p, the number average degree of polymerization is:

$${\overline{X}}_{n} = \frac{2}{2 - p * {f}_{n , a v g}}$$

Inserting our calculated value of f_{n,avg} into this expression, we get the following:

$${\overline{X}}_{n} = \frac{1}{1 - p + p / N}$$

When we consider the limit of full functional group conversion we find that we recover the same number average degree of polymerization as the degradation fragments (N−2 bifunctional fragments plus 2 monofunctional fragments).

$${lim}_{p \to 1} {\overline{X}}_{n} = {lim}_{p \to 1} \frac{1}{1 - p + p / N} = N$$

This result can also be explained intuitively because we are not changing the number of chains during the repolymerization (the number of chain ends remains constant, and each chain must have 2 ends).

To calculate the weight average molecular weight of repolymerized strands, we need information about the entire molecular weight distribution. If we consider the repolymerization of OS fragments, the distribution of OS fragments per polymer chain is described by the Flory-Schultz distribution, as is the case for step-growth polymerizations in general. For the re-polymerization of OS fragments, we know the mean number of OS fragments per chain in the limit of full end group conversion approaches N. Given this, the fractions of bifunctional and monofunctional OS fragments are (N−2)/N and 2/N, respectively. With this proportion of components reacted at full conversion, the number fraction, nᵢ, and weight fraction, wᵢ, of chains containing i OS fragments is:

$$\begin{matrix}{n}_{i} = {2}^{i - 1} {( \frac{2}{N - 2} )}^{2} {( \frac{2 N - 2}{N - 2} )}^{- ( i + 1 )} \\ {w}_{i} = i {2}^{i - 1} {( \frac{2}{N - 2} )}^{2} {( \frac{2 N - 2}{N - 2} )}^{- ( i + 1 )}\end{matrix}$$

The dispersity of the repolymerized chains can then be calculated by summing these functions over all values of i and taking their ratio:

$${X}_{n} = {\sum }_{i} {n}_{i} = N$$

$${X}_{w} = {\sum }_{i} i * {w}_{i} = {\sum }_{i} {i}^{2} {2}^{i - 1} {( \frac{2}{N - 2} )}^{2} {( \frac{2 N - 2}{N - 2} )}^{- ( i + 1 )}$$

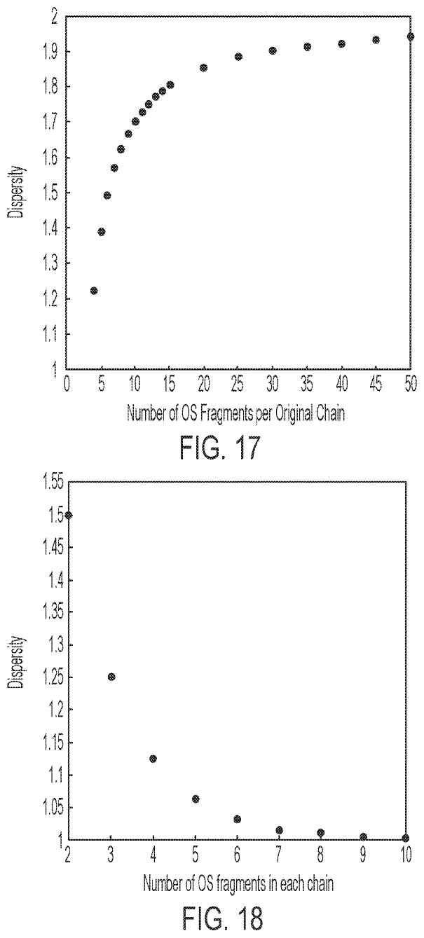

The dispersity value for different values of N is shown in FIG. 17. We emphasize here that the above calculation is for dispersity of the number of OS fragments per chain, and not the dispersity of molecular weight for repolymerized polymers. To now determine the molecular weight dispersity of the repolymerized polymers, we can consider the dispersity of polymers in the sample which contain a given number of OS fragments. Each repolymerized polymer containing m OS fragments will have an average molecular weight and dispersity dependent on the population of OS fragments. To illustrate this point, we first consider the molecular weight and dispersity of repolymerized chains with 2 OS fragments. If the original OS fragment population has a number average molecular weight M_{n,OS} and dispersity D_{OS}, a repolymerized chain containing 2 fragments will have number average molecular weight 2*M_{n,OS} and a dispersity given by:

$${D}_{2} = \frac{{D}_{OS} + 1}{2}$$

Similarly, the population of repolymerized chains containing K OS fragments will have a number average molecular weight of K*M_{n,OS} and its dispersity can be calculated by iteratively applying the above formula:

$${D}_{3} = \frac{{D}_{2} + 1}{2} ; {D}_{4} = \frac{{D}_{3} + 1}{2} ; {D}_{5} = \frac{{D}_{4} + 1}{2} ; and so on$$

As N increases, the dispersity of the population of repolymerized chains with a specific value of N quickly approaches unity as shown in FIG. 18 (assuming OS fragments with a dispersity of 2):

Based on this calculation, we find that the dispersity of molecular weight for repolymerized chains with a given number of OS fragments will be very narrow, and thus the dispersity of the entire population of repolymerized chains is dominated by the dispersity in number of OS fragments per chain (as shown in FIG. 17). Overall, the repolymerization of OS fragments will produce chains with the same number average molecular weight as the original polymer, and with a dispersity dependent on the number of OS fragments resulting from a single original polymer:

$${M}_{n , r e p o l y m e r i z e d} = {M}_{n , original}$$

$${D}_{repo l y m e r i z e d} = \frac{{\sum }_{i} {i}^{2} {2}^{i - 1} {( \frac{2}{N - 2} )}^{2} {( \frac{2 N - 2}{N - 2} )}^{- ( i + 1 )}}{N} \approx 2 for large N$$

### On the Presence of Cyclic Oligomers

We observe a small fraction (˜5-10% by mass) of low molecular weight species from OS fragment repolymerization. As these cyclic oligomers don't contain any monofunctional fragments, they serve to decrease the molecular weight of the linear repolymerized chains. We can estimate their effect on the number average molecular weight in this way. If we consider a sample of polymers which contain on average N OS fragments each with an average molecular weight M_{n,OS}, the fraction of mono- to bi-functional OS fragments will be as before equal to

$$\frac{2}{N - 2} .$$

If some fraction, x, of bifunctional OS fragments exist in cyclic oligomers, the ratio of mono- to bi-functional OS fragments which make up the linear strands is then modified:

$$\frac{monofunctional}{bifunctional} = \frac{2}{x ( N - 2 )}$$

This new ratio can be used to calculate a modified value of f_{n,avg}:

$${f}_{a v g} = \frac{2 + 2 x ( N - 2 )}{2 + x ( N - 2 )}$$

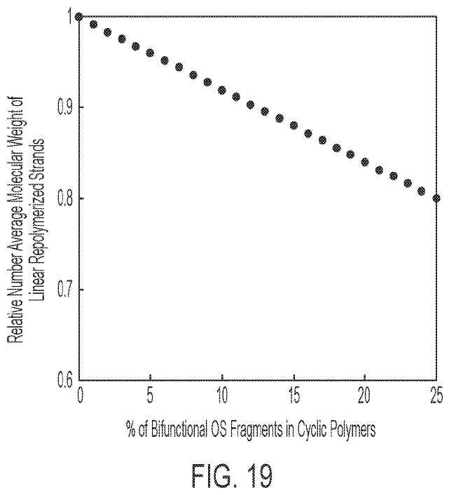

From this we can calculate by what fraction the number average molecular weight of the linear repolymerized strands decreases as x is increased. Graphically, this effect is shown in FIG. 19 for an initial N value of 10:

We note that cyclic oligomers will not significantly change the dispersity of repolymerized linear polymers from what we previously calculated above since the distribution of these linear polymers will still follow the Flory-Schultz distribution.

### Development of Bulk Polymerization Conditions for Accessing High M_{w} Deconstructable PS

The high concentrations achievable only in bulk, suspension, or emulsion polymerizations are typically preferred for obtaining high M_{w} due to faster kinetics and lesser chain transfer. Thus, we explored copolymerization under a range of conditions (Table 4). Remarkably, with one exception (see below), f_{DOT}≈F_{DOT} for all conditions screened.

TABLE 4
Development of scalable and reproducible bulk polymerization conditions.

| | | | f_{DOT} | | | Scale | | DOT | St | F_{DOT} | Mₙ | M_{w} | |
|---|---|---|---|---|---|---|---|---|---|---|---|---|---|
| Entry | Initiator | | (%) | Temp, Time | | (g) | Vessel/Stir? | conv (%) | conv (%) | (%) | (kDa) | (kDa) | Ð_{M} |
| 1 | ACHN | (1.0%) | 2.57 | 100° | C., 24 h | 1.0 | 20 mL tube/yes | 99 | 99 | 2.37 | 52.0 | 144 | 2.77 |
| 2 | ACHN | (1.0%) | 2.46 | 100° | C., 1 h | 1.0 | 20 mL tube/yes | 65 | 70 | 2.24 | 35.9 | 62.6 | 1.74 |
| 3 | ACHN | (0.22%) | 2.45 | 100° | C., 4 h | 1.0 | 20 mL tube/yes | 93 | 93 | 2.49 | 101 | 254 | 2.51 |
| 4 | BPO | (1.0%) | 2.60 | 75° | C., 48 h | 1.0 | 20 mL tube/yes | 46 | 17 | ND | 8.16 | 40.2 | 4.93 |

| | | | | | | | | | | | | |
|---|---|---|---|---|---|---|---|---|---|---|---|---|
| 5 | None | — | 150° | C., 2 h | 1.0 | 20 mL tube/yes | N/A | 70 | — | 145 | 271 | 1.87 |
| 6 | None | 2.50 | 150° | C., 2 h | 1.0 | 20 mL tube/yes | 75 | 71 | 2.46 | 116 | 221 | 1.91 |
| 7 | None | 5.17 | 150° | C., 2 h | 1.0 | 50 mL RB/yes | ND | ND | 5.84 | 102 | 189 | 1.85 |
| 8 | None | 10.1 | 150° | C., 2 h | 1.0 | 20 mL tube/yes | ND | ND | 10.5 | 88.5 | 167 | 1.89 |
| 9 | None | — | 150° | C., 3 h | 5.0 | 100 mL RB/yes | N/A | 76 | — | 144 | 281 | 1.95 |
| 10 | None | 2.46 | 125° | C., 12 h | 5.3 | 100 mL RB/no | 77 | 75 | 2.43 | 145 | 278 | 1.92 |
| 11 | None | 4.97 | 125° | C., 13.5 h | 5.6 | 100 mL RB/no | 80 | 77 | 4.94 | 120 | 221 | 1.84 |
| 12 | None | 9.78 | 125° | C., 12.5 h | 5.3 | 100 mL RB/no | 75 | 71 | 9.72 | 107 | 193 | 1.80 |
| 13 | None | — | 155° | C., 3 h | 21 | 200 mL RB/no | N/A | 86 | — | 128 | 250 | 1.95 |
| 14 | None | 2.45 | 130° | C., 15 h | 21 | 200 mL RB/no | 89 | 88 | 2.45 | 159 | 312 | 1.96 |
| 15 | None | 5.03 | 130° | C., 15 h | 21 | 200 mL RB/no | 87 | 85 | 4.97 | 138 | 248 | 1.80 |

f_{DOT} = molar equiv of DOT in monomer feed, calculated by integration the ¹H NMR spectrum of an aliquot before heating; Conversions were measured by ¹H NMR analysis using 1,3,5-trimethoxybenzene as internal standard. F_{DOT} = molar equiv of ring-opened, DOT-derived units in the isolated polymer; Mₙ, M_{w} = number and weight average molar mass of isolated polymer; Ð_{M} = Molar mass dispersity of isolated polymer.

First, the standard conditions with ACHN as initiator were repeated in the absence of solvent (Table 4, entry 1). As expected, total conversion, Mₙ, and Ð_{M} were all notably higher than in the analogous solution polymerization. The relatively high Ð_{M} is common for bulk styrene polymerizations using azo initiators, and is thought to result from a switch of the dominant termination mechanism in a highly viscous high-conversion medium from PS—PS combination to chain transfer (e.g. to initiator). Thus, in pursuit of a lower Ð_{M}, the reaction was halted at a lower conversion (74%, Entry 2). These conditions were subsequently applied at a lower ACHN concentration (0.2 mol %, Entry 3) to afford a polymer with an M_{w} value on par with that of commercially relevant PS; however, the molecular weight distribution of the polymer proved difficult to reproduce, perhaps due to onset of the Trommsdorff effect.

When benzoyl peroxide (BPO) as initiator at 75° C. (Entry 4), the rate of the copolymerization was retarded (17% overall conversion) and the isolated polymer had a bimodal distribution with a high Ð_{M} of 4.9 and low M_{w}. A control experiment indicated that this was due an oxidation/reduction reaction between BPO and DOT to form DTO. This has previously been observed for thiocarbonyl compounds in the context of RAFT. Peroxide initiators were not further explored.

The best overall results (in terms of conversion, M_{w}, and Ð_{M}) were obtained in the absence of an added initiator. Interestingly, despite a previous observation of the thermal isomerization of DOT in DMSO-de solvent, temperatures of at least 150° C. could be employed with no observable isomerization side product (DTO). First, such polymerizations were carried out on a 1 g scale for F_{DOT}=0, 2.5, 5.2, and 10.1% at 150° C. for 3 h (Entries 5-8). Next, the polymerizations were scaled up to 5 grams each (Entries 9-12). A lower oil bath temperature of 125° C. was used for the DOT-containing samples and, as expected based on precedent for PS, there was a notable increase in M_{w} at this lower temperature. Finally, these reactions were scaled up as shown in Entries 13-15, which are the samples that were used for the recycling studies discussed in the main text.

### Evidence for the Formation of Cyclic Polymers in the Synthesis of rPS

To assess whether the shoulder in the SEC traces of rPS(2.5)-hMW and rPS(5.0)-hMW could arise from cyclic polymers, we conducted the polymerization under the standard conditions described herein, except at 50× dilution (FIG. 20). The dramatic increase in intensity of the low molecular weight peak supports this hypothesis. These data are consistent with previous observations of cyclization of thiol-terminated PS.

### Synthetic Details and Basic Structural Characterization

### Naming Conventions

Monomers, oligomers, and polymers synthesized herein are named as shown in the scheme below. F_{X-Y-DOT} represents the mol % of X-Y-DOT comonomer incorporated into a copolymer (e.g., the copolymer of styrene and X-Y-DOT). When X or Y=H, it is omitted from the name. For example, the DOT derivative with X=F and Y=H would be called F-DOT and the copolymer that incorporates 9.1% of this comonomer would be called F-dPS(9.1). The deconstruction product derived after treatment of this polymer with cysteamine gives a thiol at the a terminus and would thus be called thiol-F—OS(9.1). Finally, the recycled polymer obtained from oxidative polymerization of thiol-F—OS(9.1) would be called F-rPS(9.1). Lastly, for simplicity, molecular weights are broken up into two categories: low M_{w} (first part of the manuscript) and high M_{w} (second part of the manuscript). For the latter, “-hMW” is appended onto the name, e.g. the high M_{w} version of F-rPS(9.1) would be called F-rPS(9.1)-hMW.

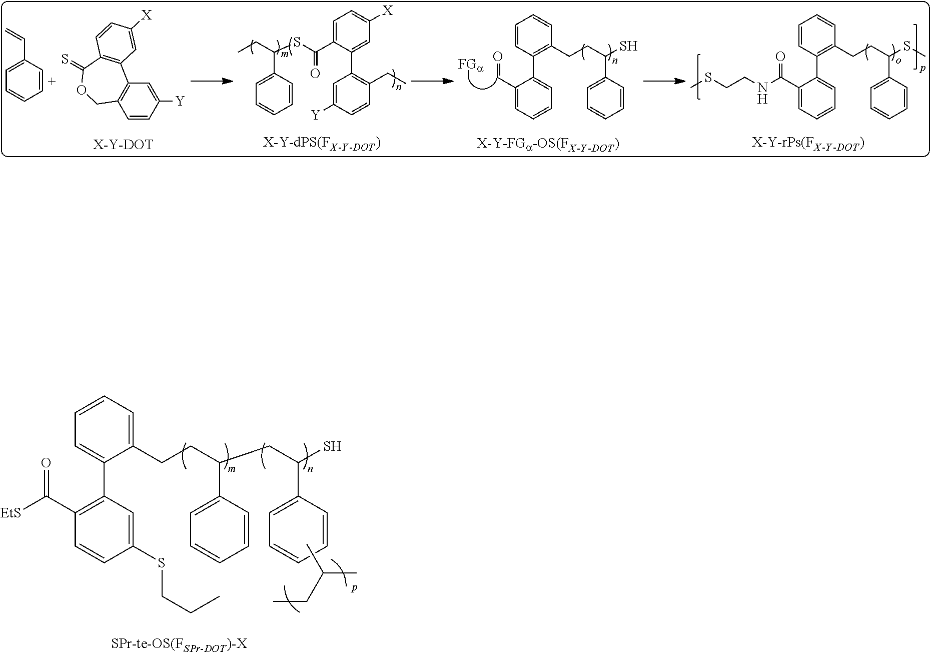

### DOT

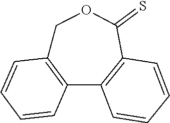 [SMILES: S=C1OCc2ccccc2-c2ccccc21]

IUPAC Name: dibenzo[c,e]oxepine-5(7H)-thione

Procedure: To improve scalability, the published procedure was modified as follows: 1) increased concentration; 2) addition of a work-up step for decomposition of byproducts from Lawesson's reagent. An oven-dried, two-neck, 200 mL round-bottomed flask was equipped with a magnetic stirbar, reflux condenser, and N₂ inlet. The flask was charged with DOO (9.00 g, 42.8 mmol, 1.0 equiv) and Lawesson's reagent (10.4 g, 25.7 mmol, 0.60 equiv), the system was evacuated and backfilled with N₂, then anhydrous toluene (43 mL) was added. The stirred mixture was heated at 115° C. for 5 h under light N₂ flow, then volatile materials were removed via rotary evaporation at 60° C. The residue was dissolved in CH₂Cl₂ (50 mL), then mixture was diluted with MeOH (150 mL) and stirred vigorously for 12 h. * The suspension was concentrated to a total mass of ˜20 g, diluted with MeOH (50 mL), filtered, and the solid was washed with MeOH (2×30 mL). The solid subjected to column chromatography (5-30% CH₂Cl₂ in hexanes), ** affording DOT (5.6 g, 58%) as a bright yellow, crystalline solid.

Notes: * The step serves to decompose the byproducts from Lawesson's reagent into easily removable, MeOH-soluble species. ** The low solubility of DOT in this eluent necessitates dry loading. Here, we used 25-30 g of silica for this purpose and ˜300 g total silica for the column. *** While not necessary, we have found it convenient to isolate this solid as follows (this also serves as a rapid, high recovery recrystallization). The product-containing fractions were concentrated to dryness, then the solid was dissolved in CH₂Cl₂ (50 mL). The solution was diluted with hexanes (300 mL), then the suspension was concentrated to a total mass of ˜100 g and filtered. The solid was washed with hexanes (2×30 mL) and dried under high vacuum. Recovery: 5.3 g bright yellow crystalline solid.

Characterization: Basic characterization data (¹H and ¹³C NMR, and IR spectrum) matches that in the literature (M. Bingham, N.; J. Roth, P. Degradable Vinyl Copolymers through Thiocarbonyl Addition-Ring-Opening (TARO) Polymerization. Chem. Commun. 2019, 55 (1), 55-58. https://doi.org/10.1039/C8CC08287A).

### SPr—F-Dot

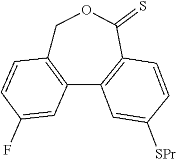

IUPAC Name: 10-fluoro-2-(propylthio)dibenzo[c,e]oxepine-5(7H)-thione

Procedure: The following is a modified version of the procedure reported by Roth and coworkers for a similar compound. The primary differences were with regard to concentration, reaction time, and equiv of Lawesson's reagent. A 15 mL Teflon-stoppered flask was loaded with SPr—F-DOO (0.700 g, 2.31 mmol, 1.0 equiv), Lawesson's reagent (0.562 g, 1.39 mmol, 0.60 equiv), and anhydrous toluene (2.3 mL). The flask was sealed, and the stirred mixture was heated at 110° C. for 3 h. The mixture was transferred to a round-bottomed flask with the aid of CH₂Cl₂, then solvents were removed via rotary evaporation. The residue was purified by column chromatography (5-25% EtOAc in hexanes) to afford SPr—F-DOT (0.426 g, 58%) as bright yellow/orange solid along with starting SPr—F-DOO (0.145 g, 21%) as a pale-yellow solid. The yield adjusted for recovered starting material was 73%.

Characterization: ¹H NMR (chloroform-d, 400 MHZ): δ=8.10 (d, J=8.4 Hz, 1H), 7.43 (dd, J=8.4, 5.5 Hz, 1H), 7.36-7.27 (m, 3H), 7.14 (td, J=8.3, 2.6 Hz, 1H), 5.24-5.04 (m, 2H), 3.02 (t, J=7.2 Hz, 2H), 1.77 (h, J=7.3 Hz, 2H), 1.08 (t, J=7.4 Hz, 3H); ¹⁹F {¹H} NMR (chloroform-d, 376 MHz): δ=−110.2; ¹³C {¹H}NMR (chloroform-d, 101 MHz): δ=214.92, 163.78 (d, J=249 Hz), 144.55, 141.04 (d, J=8.3 Hz), 135.58, 134.88, 133.95 (d, J=2.0 Hz), 130.85 (d, J=3.1 Hz), 130.55 (d, J=8.8 Hz), 126.42, 125.97, 115.92 (d, J=21.7 Hz), 115.38 (d, J=23.1 Hz), 72.87, 34.12, 22.27, 13.60; HRMS-DART-TOF (m/z): [M+H]⁺ calcd. for C₁₇H₁₆OFS₂, 319.0621; found, 319.0645.

### SPr-DOT

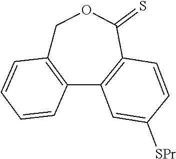

IUPAC Name: 2-(propylthio)dibenzo[c,e]oxepine-5(7H)-thione

Procedure: This compound was prepared according to the procedure for SPr—F-DOT. The solid obtained from column chromatography was further purified as follows. The solid was dissolved in CH₂Cl₂ (1.0 mL) and hexanes (10 mL) was added, producing a crystalline precipitate. The suspension was cooled to −20° C. for 1 h and filtered. The solid was washed with hexanes (2×3 mL), affording SPr-DOT (635 mg, 60%) as yellow/orange* crystalline solid.

Characterization: ¹H NMR (chloroform-d, 400 MHZ): δ=8.10 (d, J=8.4 Hz, 1H), 7.63 (d, J=7.7 Hz, 1H), 7.58-7.50 (m, 1H), 7.48-7.42 (m, 2H), 7.33 (d, J=1.9 Hz, 1H), 7.30 (dd, J=8.4, 1.9 Hz, 1H), 5.25-5.12 (m, 2H), 3.01 (t, J=7.2 Hz, 2H), 1.77 (h, J=7.3 Hz, 2H), 1.08 (t, J=7.4 Hz, 3H); ¹³C {¹H} NMR (chloroform-d, 101 MHz:) δ=215.47, 144.20, 138.83, 135.64, 135.11, 134.79, 134.74, 130.42, 129.09, 128.54, 128.44, 126.21, 125.98, 73.81, 34.13, 22.31, 13.61; HRMS-DART-TOF (m/z): [M+H]⁺ calcd. for C₁₇H₁₇OS₂, 301.0715; found, 301.0731.

### F-DOT

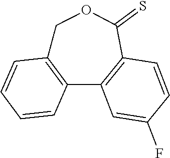 [SMILES: Fc1ccc2c(c1)-c1ccccc1COC2=S]

IUPAC Name: 2-fluorodibenzo[c,e]oxepine-5 (7H)-thione

Procedure: This compound was prepared according to the procedure for SPr—F-DOT. The solid obtained from column chromatography was further purified as follows. The solid was dissolved in CH₂Cl₂ (1.0 mL) and hexanes (10 mL) was added, producing an immediate crystalline precipitate. The suspension was cooled to −20° C. for 1 h and filtered. The solid was washed with hexanes (2×3 mL), affording F-DOT (220 mg, 41%) as a bright yellow crystalline solid.

Characterization: ¹H NMR (chloroform-d, 400 MHZ): δ=8.22 (dd, J=8.8, 5.8 Hz, 1H), 7.63 (d, J=7.6 Hz, 1H), 7.60-7.52 (m, 1H), 7.52-7.44 (m, 2H), 7.21 (dd, J=9.5, 2.6 Hz, 1H), 7.15 (ddd, J=8.7, 7.7, 2.6 Hz, 1H), 5.44-4.92 (m, 2H); ¹⁹F {¹H} NMR (chloroform-d, 376 MHz): δ=−106.68; ¹³C {¹H} NMR: see spectrum below; HRMS-DART-TOF (m/z): [M+H]⁺ calcd. for C₁₄H₁₀FOS, 245.0431; found, 245.0423.

### F2-DOT

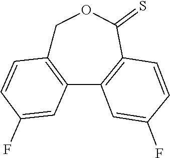 [SMILES: Fc1ccc2c(c1)-c1cc(F)ccc1C(=S)OC2]

IUPAC Name: 2,10-difluorodibenzo[c,e]oxepine-5 (7H)-thione

Procedure: This compound was prepared according to the procedure for SPr—F-DOT. The yellow solid (224 mg) obtained from column chromatography had ˜2% impurity and was further purified as follows. The solid was dissolved in CH₂Cl₂ (1.0 mL) and hexanes (10 mL) was added, producing an immediate crystalline precipitate. The suspension was cooled to −20° C. for 1 h and filtered. The solid was washed with cold hexanes (2×3 mL), affording F2-DOT (203 mg, 38%) as a bright yellow powder.

Characterization: ¹H NMR (chloroform-d, 400 MHZ): δ=8.22 (dd, J=9.6, 5.7 Hz, 1H), 7.46 (dd, J=8.4, 5.4 Hz, 1H), 7.34 (dd, J=9.2, 2.6 Hz, 1H), 7.23-7.12 (m, 3H), 5.30-5.02 (m, 2H); ¹⁹F NMR (chloroform-d, 376 MHz): δ=−106.28 (td, J=8.4, 5.6 Hz), −109.74 (td, J=8.8, 5.5 Hz); ¹³C {¹H} NMR (chloroform-d, 101 MHZ): δ=214.05, 164.67 (d, J=255.4 Hz), 163.83 (d, J=249.8 Hz), 140.34 (dd, J=8.4, 1.7 Hz), 137.34 (d, J=9.1 Hz), 136.10 (dd, J=8.4, 2.1 Hz), 135.65 (d, J=3.2 Hz), 130.77 (d, J=8.9 Hz), 130.68 (d, J=3.0 Hz), 116.45 (d, J=11.0 Hz), 116.24 (d, J=10.9 Hz), 115.51 (d, J=23.2 Hz), 115.02 (d, J=23.0 Hz), 72.90; HRMS-DART-TOF (m/z): [M+H]⁺ calcd. for C₁₄H₉F₂OS, 263.0337; found, 263.0321.

### OMe₂-DOT

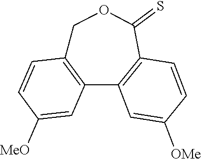 [SMILES: COc1ccc2c(c1)-c1cc(OC)ccc1C(=S)OC2]

IUPAC Name: 2,10-dimethoxydibenzo[c,e]oxepine-5 (7H)-thione

Procedure: This compound was prepared according to the procedure for SPr—F-DOT. The crude mixture was purified by column chromatography (35-65% CH₂Cl₂ in hexanes) followed by precipitation of the desired product from a concentrated CH₂Cl₂ solution (˜1 mL) with hexanes (5 mL). The isolated yield of OMe₂-DOT, a bright yellow solid, was 75 mg (14%).

Characterization: ¹H NMR (chloroform-d, 400 MHZ): δ=8.22-8.15 (m, 1H), 7.36 (d, J=8.3 Hz, 1H), 7.14 (d, J=2.6 Hz, 1H), 7.01-6.93 (m, 3H), 5.19-5.06 (m, 2H), 3.92 (s, 3H), 3.88 (s, 3H); ¹³C NMR (chloroform-d, 101 MHZ): δ=215.89, 162.58, 161.03, 140.54, 136.99, 136.85, 132.33, 129.91, 127.41, 114.21, 114.14, 114.03, 113.24, 73.35, 55.81, 55.69; HRMS-DART-TOF (m/z): [M+H]⁺ calcd. for C₁₆H₁₅O₃S, 287.0736; found, 287.0753.

### DOO

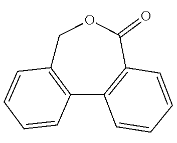 [SMILES: O=C1OCc2ccccc2-c2ccccc21]

IUPAC Name: dibenzo[c,e]oxepin-5 (7H)-one

Procedure: This compound was prepared by a slightly modified literature procedure (Brandmeier, V.; Feigel, M. A Macrocycle Containing Two Biphenyl and Two Alanine Subunits, Synthesis and Conformation in Solution. Tetrahedron 1989, 45 (5), 1365-1376). Yield: 21 g (86%).

Characterization: ¹H and ¹³C NMR data matches that in the literature (M. Bingham, N.; J. Roth, P. Degradable Vinyl Copolymers through Thiocarbonyl Addition-Ring-Opening (TARO) Polymerization. Chem. Commun. 2019, 55 (1), 55-58. https://doi.org/10.1039/C8CC08287A).

### F2-DOO

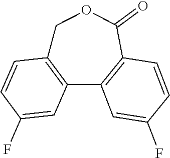 [SMILES: O=C1OCc2ccc(F)cc2-c2cc(F)ccc21]

IUPAC Name: 2,10-difluorodibenzo[c,e]oxepin-5(7H)-one

Procedure: The following is an adaptation of the methodology developed by Miyagawa and Akiyama. The primary modifications were with regard to concentration, workup, and purification. An oven-dried, 500 mL Schlenk flask was charged with 2-bromo-4-fluorobenzaldehyde (10.0 g, 49.3 mmol, 1.0 equiv), activated Zn powder (5.16 g, 78.9 mmol, 1.6 equiv), tetrabutylammonium iodide (36.4 g, 98.6 mmol, 2.0 equiv), and Ni(PPh₃)₂Cl₂ (1.62 g, 2.47 mmol, 0.05 equiv), then the flask was sealed with a rubber septum and deoxygenated with three vacuum/N₂ cycles. Anhydrous, N₂-sparged o-xylene (150 mL) was added via cannula, then the stirred mixture was heated to 135° C. (internal temperature). The rubber septum was exchanged for a ground-glass stopper and the stirred mixture was heated at 135° C. for 18 h. The hot, biphasic mixture was then transferred to a separatory funnel and the top, transparent layer (o-xylene) was set aside. The dark brown and viscous bottom layer (primarily tetrabutylammonium iodide) was extracted with toluene (50 mL). The combined o-xylene/toluene layers were filtered through a plug of silica gel (˜20 g), the plug was flushed with CH₂Cl₂ (250 mL), and the filtrate was concentrated via rotary evaporation at RT followed by 70-80° C. The residue was dissolved in the minimal amount of boiling CH₂Cl₂ (15-20 mL), the solution was diluted with MeOH (150 mL), then the volume of the resulting mixture was reduced to ˜50 mL via rotary evaporation. The precipitate was collected on a fritted funnel, washed with MeOH (3×20 mL), and dried under high vacuum to afford F2-DOO (2.80 g, 46%) as an off-white solid.

Characterization: ¹H NMR (chloroform-d, 400 MHz): δ=8.04 (dd, J=8.6, 5.8 Hz, 1H), 7.47 (dd, J=8.4, 5.5 Hz, 1H), 7.33 (dd, J=9.3, 2.6 Hz, 1H), 7.30-7.22 (m, 2H), 7.16 (td, J=8.3, 2.6 Hz, 1H), 5.00 (d, J=4.5 Hz, 2H); 19F {1H} NMR (chloroform-d, 376 MHz): δ=−105.3, −110.1; ¹³C {¹H} NMR: see spectrum below; HRMS-DART-TOF (m/z): [M+H]⁺ calcd. for C₁₄H₉O₂F₂, 247.0565; found, 247.0584.

### F-DOO

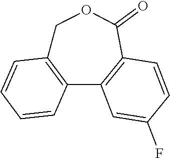 [SMILES: O=C1OCc2ccccc2-c2cc(F)ccc21]

IUPAC Name: 2-fluorodibenzo[c,e]oxepin-5 (7H)-one

Procedure: A 100 mL Schlenk flask was charged with methyl 2-bromo-4-fluorobenzoate (10.0 g, 42.9 mmol, 1.0 equiv), 2-formylphenylboronic acid (8.36 g, 55.8 mmol, 1.3 equiv), powdered anhydrous K₃PO₄ (11.8 g, 55.8 mmol, 1.3 equiv), and Pd(PPh₃)₄ (0.50 g, 0.43 mmol, 0.01 equiv). The flask was sealed with a rubber septum and deoxygenated with three vacuum/N₂ cycles. Anhydrous, N₂-sparged DMF (43 mL) was added via syringe, then the stirred mixture was heated at 120° C. (oil bath temperature) under light N₂ flow for 24 h.* The mixture was partitioned between EtOAc (200 mL) and water (200 mL), then the organic layer was washed with water (200 mL) and saturated aqueous NaCl (200 mL), dried with MgSO₄, filtered into a 500 mL round-bottomed flask, and concentrated via rotary evaporation. Residual volatile materials were removed under high vacuum (˜1 h), affording 11.4 g of a golden yellow oil. To the flask was then added a magnetic stirbar and absolute EtOH (200 mL). The resulting homogeneous solution was cooled to ˜2° C. with an ice/water bath, then NaBH₄ (3.16 g, 83.6 mmol, 2 equiv) was added portionwise over 5-10 min, such that the temperature did not rise above 10° C. At the end of addition, the cold bath was removed, and the mixture was allowed to warm to RT and stirred for a further 2 h. The reaction was quenched by the careful addition water (300 mL), then the precipitate was collected by filtration and washed with water (3×50 mL). The resulting brown solid was dissolved in CH₂Cl₂ (125 mL), the solution was treated with MgSO₄, then the mixture was filtered through a plug of silica gel (20 g). The plug was eluted with CH₂Cl₂ until TLC indicated complete elution of the desired compound. Solvents were removed via rotary evaporation, then the resulting solid was further purified as follows. The crude solid was suspended in MeOH (75 mL), then the stirred suspension was brought to a boil for ˜3 min. The mixture was allowed to cool to RT, then the solid was collected by filtration, washed with MeOH (2×30 mL), and dried under high vacuum. This afforded F-DOO (5.20 g, 53%) as a crystalline white solid.

Notes: * Analysis of aliquots after 1 h, 3 h, and 24 h by ¹H NMR spectroscopy indicated that starting material conversions were 76%, 85%, and 100%, respectively.

Characterization: ¹H NMR (chloroform-d, 400 MHZ): δ=8.05 (dd, J=8.7, 5.9 Hz, 1H), 7.65 (d, J=7.7 Hz, 1H), 7.61-7.55 (m, 1H), 7.53-7.46 (m, 2H), 7.33 (dd, J=9.7, 2.6 Hz, 1H), 7.27-7.21 (m, 1H), 5.20-4.88 (m, 2H); ¹⁹F {¹H} NMR (chloroform-d, 376 MHz): δ=−105.85; ¹³C {¹H} NMR: see spectrum below. ¹H NMR data is consistent with that reported in the literature (Zhang, X.-S.; Zhang, Y.-F.; Li, Z.-W.; Luo, F.-X.; Shi, Z.-J. Synthesis of Dibenzo[c,e]Oxepin-5(7H)-Ones from Benzyl Thioethers and Carboxylic Acids: Rhodium-Catalyzed Double C—H Activation Controlled by Different Directing Groups. Angew. Chem. Int. Ed. 2015, 54 (18), 5478-5482).

### SPr—F-DOO

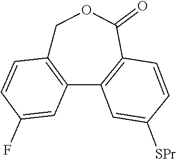

IUPAC Name: 10-fluoro-2-(propylthio)dibenzo[c,e]oxepin-5(7H)-one

Procedure: A 100 mL Teflon-stoppered flask was loaded with F2-DOO (1.40 g, 5.69 mmol, 1.0 equiv), K₂CO₃ (2.36 g, 17.1 mmol, 3.0 equiv), and anhydrous DMF (21 mL). The flask was crudely deoxygenated with three rapid vacuum/N₂ cycles (˜15 seconds each), then 1-propanethiol (0.477 g, 6.26 mmol, 1.10 equiv) was added via syringe. The flask was sealed, and the vigorously stirred mixture was heated at 90° C. for 1 h. The mixture was cooled to RT, diluted with EtOAc (100 mL), washed with water (2×100 mL) and saturated aqueous NaCl (100 mL), dried with MgSO₄, and filtered. Solvents were removed from the filtrate via rotary evaporation, then the residue was purified by column chromatography (50-100% CH₂Cl₂ in hexanes) to afford SPr—F-DOO (1.41 g, 82%) as a white solid.

Characterization: ¹H NMR (chloroform-d, 400 MHZ): δ=7.93-7.88 (m, 1H), 7.44 (dd, J=8.4, 5.5 Hz, 1H), 7.42-7.37 (m, 2H), 7.33 (dd, J=9.5, 2.6 Hz, 1H), 7.13 (td, J=8.3, 2.6 Hz, 1H), 5.09-4.89 (m, 2H), 3.03 (t, J=7.3 Hz, 2H), 1.78 (sext, J=7.3 Hz, 2H), 1.09 (t, J=7.3 Hz, 3H); ¹⁹F {¹H} NMR (chloroform-d, 376 MHz): δ=−110.6; ¹³C {¹H} NMR (chloroform-d, 101 MHz): δ=169.76, 163.72 (d, J=249 Hz), 144.83, 140.98 (d, J=8.1 Hz), 136.71 (d, J=2.2 Hz), 132.75, 131.19 (d, J=3.1 Hz), 130.70 (d, J=8.8 Hz), 127.03, 126.86, 126.39, 115.78 (d, J=22.3 Hz), 115.54 (d, J=23.0 Hz), 68.35, 34.18, 22.26, 13.61; HRMS-DART-TOF (m/z): [M+H]⁺ calcd. for C₁₇H₁₆O₂FS, 303.0850; found, 303.0867.

### SPr-DOO

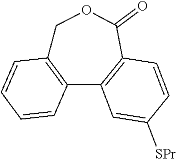

IUPAC Name: 2-(propylthio)dibenzo[c.e]oxepin-5 (7H)-one

Procedure: This compound was prepared according to the procedure for SPr—F-DOO, except 1.2 equiv of 1-propanethiol was used and 100% CH₂Cl₂ was used for column chromatography. The yield of SPr-DOO, a white solid, was 2.02 g (81%).

Characterization: ¹H NMR (chloroform-d, 400 MHZ): δ=7.92 (d, J=8.3 Hz, 1H), 7.68-7.62 (m, 1H), 7.56 (ddd, J=7.8, 6.3, 2.5 Hz, 1H), 7.52-7.41 (m, 3H), 7.39 (dd, J=8.3, 1.9 Hz, 1H), 5.18-4.88 (m, 2H), 3.04 (t, J=7.2 Hz, 2H), 1.79 (sext, J=7.3 Hz, 2H), 1.10 (t, J=7.4 Hz, 3H); ¹³C NMR (chloroform-d, 101 MHz): δ=170.11, 144.39, 138.76, 137.81, 135.08, 132.59, 130.27, 129.00, 128.72, 128.59, 127.06, 126.60, 126.41, 69.23, 34.20, 22.31, 13.61; HRMS-DART-TOF (m/z): [M+H]⁺ calcd. for C₁₇H₁₇O₂S, 285.0944; found, 285.0951.

### OMe₂-DOO

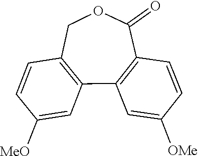 [SMILES: COc1ccc2c(c1)-c1cc(OC)ccc1C(=O)OC2]

IUPAC Name: 2,10-dimethoxydibenzo[c,e]oxepin-5(7H)-one

Procedure: This compound was prepared according to the procedure for F2-DOO, except the combined o-xylene/toluene extracts were concentrated via rotary evaporation at 70-80° C. and purified by column chromatography (50-100% CH₂Cl₂ in hexanes) to afford OMe₂-DOO as a white solid (0.77 g, 25%).

Characterization: The ¹H NMR spectrum matches that presented in the literature (Dana, S.; Chowdhury, D.; Mandal, A.; Chipem, F. A. S.; Baidya, M. Ruthenium (II) Catalysis/Noncovalent Interaction Synergy for Cross-Dehydrogenative Coupling of Arene Carboxylic Acids. ACS Catal. 2018, 8 (11), 10173-10179).

Deconstructable Polystyrene (dPS)

### Assessment of Solvents for Synthesis of dPS

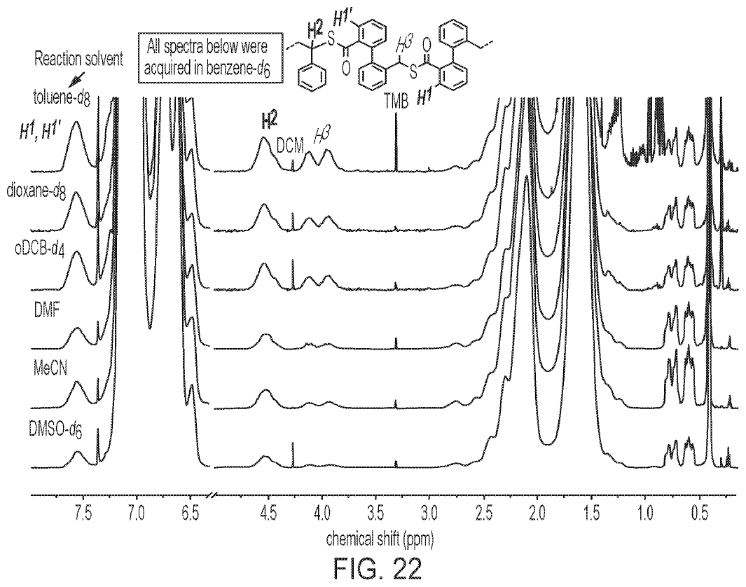

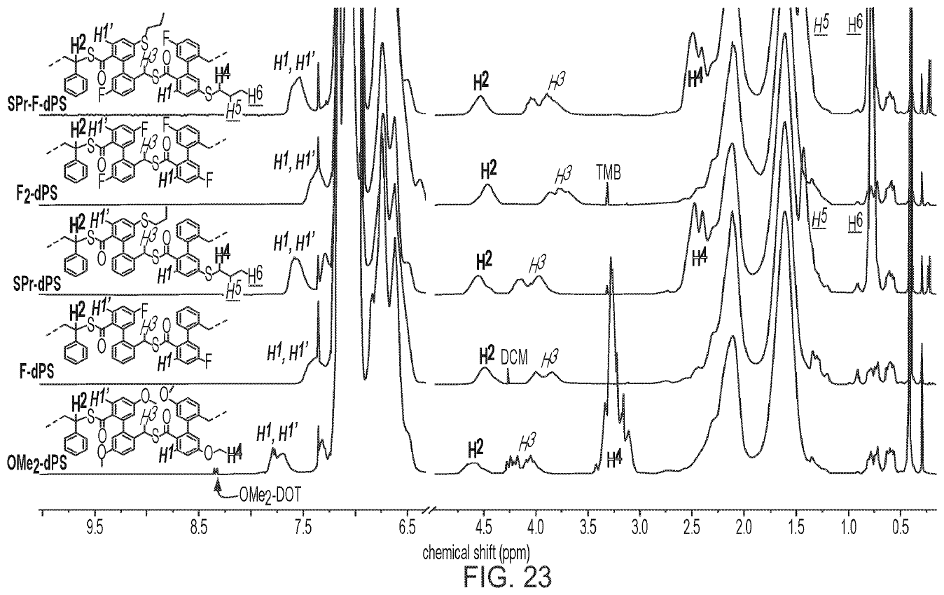

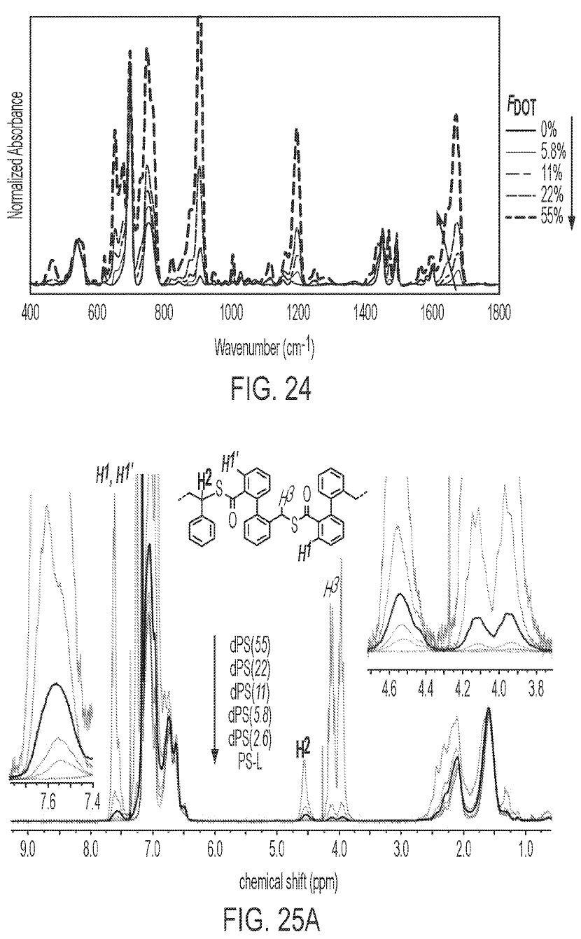

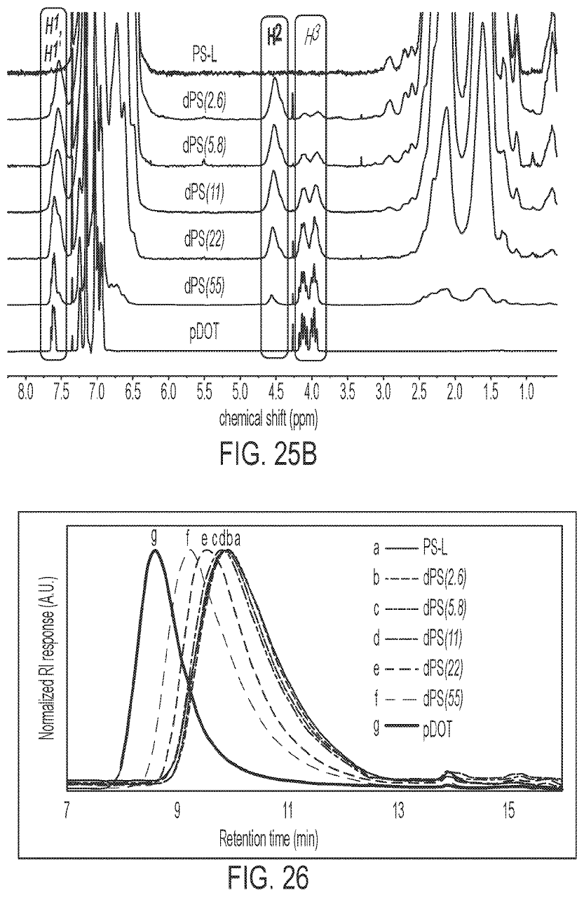

Procedure for solvent screen (Table 1, Entries 1-6): A 4 mL vial containing DOT (0.150 mmol) was charged with a stock solution of styrene (1.50 mmol), AIBN (0.015 mmol), and TMB (0.045 mmol, internal standard) (added by mass). To this mixture was then added the relevant solvent (0.75 mL). The vial was capped, then the mixture was vortexed until homogeneous and transferred to a J-Young NMR tube. The contents of the tube were deoxygenated with three free-pump-thaw cycles, then backfilled with N₂. A baseline ¹H NMR spectrum was acquired (d₁=10 s), then the mixture was placed in an oil bath pre-set to 70° C. for 18 h. A second ¹H NMR spectrum was then acquired to determine conversion values. In the cases of MeCN and DMSO-do, a precipitate had formed, so these mixtures were homogenized by addition of CDCl₃ before analysis. The polymer was isolated by precipitation into MeOH (2-3×, using CH₂Cl₂ as solvent) to give a pale-yellow to white powder, which was analyzed by ¹H NMR spectroscopy and SEC, and degraded as described in FIG. 22.

### Assessment of DOT Substituents (X-Y-DOT): Synthesis of X-Y-dPS

Procedure for DOT derivative (X-Y-DOT) screen (Table 1, Entries 7-11), including kinetic analysis: These studies were performed concurrently. First, a stock solution of styrene (703 mg), TMB (37.8 mg), and AIBN (12.3 mg) was prepared. Next, a vial was charged with X-Y-DOT (0.075 mmol) followed by 75 mg of the above-described stock solution (representing 0.675 mmol of styrene, 0.0075 of AIBN, and 0.0225 mmol of TMB) and toluene-ds (0.65 mL). The vial was capped, then the mixture was vortexed until homogeneous and transferred to a J-Young NMR tube. The contents of the tube were deoxygenated with three free-pump-thaw cycles, then backfilled with N₂. A baseline ¹H NMR spectrum was acquired (d₁=10 s), then the mixture was placed in an oil bath pre-set to 70° C. for 1 h. A second 1H NMR spectrum was acquired to determine conversion values. This process was repeated and 1H NMR spectra were acquired after 3, 5.5, and 30 h at 70° C. The copolymer (X-Y-dPS) was isolated by precipitation into MeOH (2-3×, using CH₂Cl₂ as solvent) to give a pale-yellow to white powder, which was analyzed by 1H NMR spectroscopy and SEC, and degraded as described below. The results of the kinetic analyses, which provide a more detailed look at the data presented in Table 1 of the main text, are displayed in FIGS. 8A to 8B.

Low M_{w} dPS with Variable Composition Via ACHN-Initiated Solution Polymerization

Procedure: A 150 mL Teflon-stoppered flask was loaded with DOT (1.30 g, 5.74 mmol, 10 equiv), styrene (5.39 g, 51.7 mmol, 90 equiv), 1,1′-azobis(cyanocyclohexane) (0.140 g, 0.574 mmol, 1.00 equiv), 1,3,5-trimethoxybenzene (0.0965 g, 0.574 mmol, 1.00 equiv, internal standard), and toluene (52 mL). The mixture was deoxygenated with three free-pump-thaw cycles and backfilled with N₂. The stirred, homogeneous mixture was heated at 100° C. for 24 h (note: the contents of the flask were allowed to equilibrate for 15 min under a light N₂ flow before the flask was sealed to avoid pressure buildup). Aliquots were taken before and after heating for quantification of DOT and styrene consumption by 1H NMR spectroscopy (88% and 80%, respectively). The polymer was isolated as follows. The reaction mixture was added dropwise over 5-10 min to rapidly stirred MeOH (600 mL) in a 1000 mL erlenmeyer flask. The residual was transferred using CH₂Cl₂ (2×5 mL). The precipitate was collected on a 60 mL medium porosity fritted funnel. Two more 50 mL portions of MeOH were used for quantitative transfer of the solid from the flask to the frit. Three more precipitations were performed with the same quantities of solvents, using CH₂Cl₂ in place of toluene. A pale-yellow color indicates the presence of DOT. The solid was dried under high vacuum for ˜24 h, affording dPS(11) (5.05 g, 74%) as a free-flowing white powder. F_{DOT}=11%, M_{n,SEC}=12.5 kDa, M_{w,SEC}=20.8 kDa, Ð_{M}=1.66.

The analogous polymers PS-L (0.57 g, 67%), dPS(2.6) (0.73 g, 68%), dPS(5.8) (0.33 g, 66%), dPS(22) (0.18 g, 61%), dPS(55) (0.22 g, 74%), and pDOT (0.53 g, 87%), all of which were white powders (except pDOT, which was initially a flocculent white solid, could be powdered with grinding), were prepared by an identical procedure except where noted here. Reaction times were 32, 24, 36, 36, 40, and 20 h, respectively (note that conversion essentially halts after 24 h due to depletion of initiator, so these differences in time were found to be insignificant). The amount of ACHN initiator was 1.0 mol % of the total amount of monomer. For dPS(22) and dPS(55), the heterogeneity of the initial reaction mixture necessitated that the first aliquot was taken after a brief period (<1 min) of mild heating to provide a representative sample for analysis. Several controls were performed in the absence of 1,3,5-trimethoxybenzene internal standard and provided identical results.

Characterization: Specific numerical values are provided in Table 2 of the main text, and corresponding spectra are provided in the Figures.

High M_{w} dPS Via Bulk Polymerization with No Added Initiator

Procedure 1 (1-5 g scale): This procedure corresponds to that for Table 4, Entry 10.* A 100 mL Teflon-stoppered, round-bottom flask was charged with a mixture of DOT (0.278 g, 1.23 mmol, 2.5 equiv) and styrene (5.00 g, 48.0 mmol, 97.5 equiv) (premixed in a vial to ensure homogeneity), an aliquot was drawn and analyzed by 1H NMR spectroscopy to determine the precise value of f_{DOT} (2.46%), and the contents of the flask were freed from oxygen with three freeze-pump-thaw cycles. The flask was sealed ** and submersed to its midpoint *** in an oil bath pre-set to 125° C. and the mixture was gently agitated to ensure homogeneity ****. The mixture was allowed to stand at this temperature for 12 h, after which time it had immobilized. The solid mass was dissolved in CH₂Cl₂ (50 mL) and an aliquot was analyzed by 1H NMR spectroscopy to obtain DOT and styrene conversion values (77% and 75%, respectively). The polymer was then subjected to the same precipitation procedure as described for dPS(11), affording dPS(2.4)-hMW (3.4 g, 64%) as a fibrous and flocculent white solid. F_{DOT}=2.43%, M_{n,SEC}=145 kDa, M_{w,SEC}=278 kDa, Ð_{M}=1.92.

Procedure 2 (>20 g scale): This procedure corresponds to that for Table 4, Entry 14.* The primary difference here (compared to Procedure 1) is the apparatus, which was changed for safety reasons (an open system was employed due to the larger scale). A 200 mL pear-shaped flask was charged with a mixture of DOT (1.11 g, 4.92 mmol, 2.5 equiv) and styrene (20.0 g, 192 mmol, 97.5 equiv) (premixed in a vial to ensure homogeneity), an aliquot was drawn and analyzed by 1H NMR spectroscopy to determine the precise value of f_{DOT} (2.45%), and the flask was affixed with a Vigreux column and N₂ inlet (all with lightly greased ground-glass joints). The contents of the apparatus were freed from oxygen with three freeze-pump-thaw cycles, then the apparatus was left under a gentle flow of N₂ for the remainder of the reaction. The flask was submersed to its midpoint ** in an oil bath pre-set to 130° C. and the mixture was gently agitated to ensure homogeneity ***. The mixture was allowed to stand at this temperature for 15 h, after which time it had immobilized. The solid mass was dissolved in CH₂Cl₂ (150 mL) and an aliquot was analyzed by 1H NMR spectroscopy to obtain DOT and styrene conversion values (89% and 88%, respectively). The polymer was then subjected to the same precipitation procedure as described for dPS(11), but with different relative quantities of solvents (275 mL of CH₂Cl₂ and 1500 mL of MeOH for each precipitation), affording dPS(2.5)-hMW (16.7 g, 64%) as a fibrous and flocculent white solid. F_{DOT}=2.45%, M_{n,SEC}=159 kDa, M_{w,SEC}=312 kDa, Ð_{M}=1.96.

Notes: * All other dPS(F_{DOT})-hMW samples described in Table 4 were prepared by one of these two procedures. ** We recommend the use of a blast shield; *** Since temperature is the primary determinant of molecular weight parameters in a thermally-initiated styrene polymerization, any factor that affects heat transfer will affect the results; **** Some DOT precipitates out during the freeze-pump-thaw procedure.

### Deconstruction Studies

Degradation of X-Y-dPS(Table 1, Entries 1-11) with n-Propylamine in Air

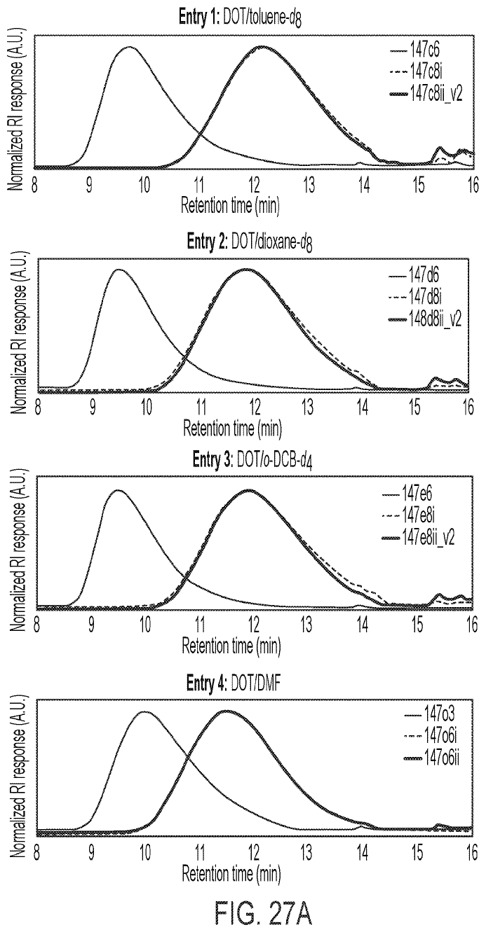

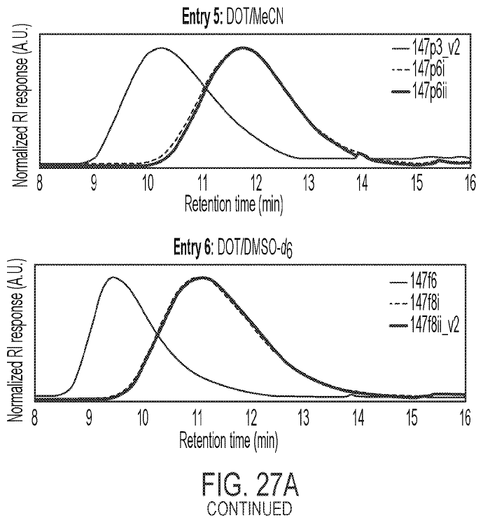

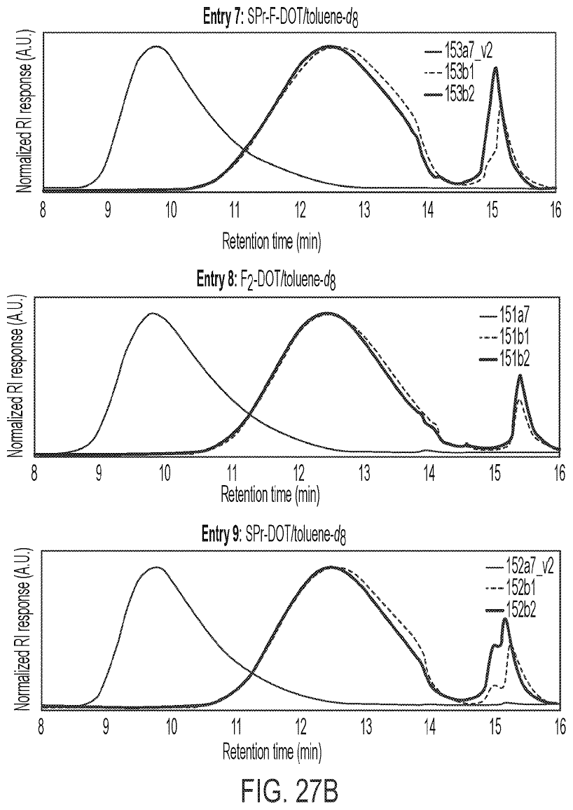

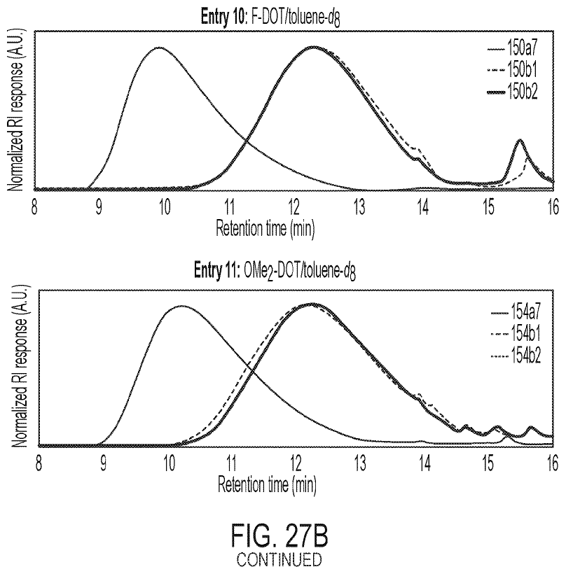

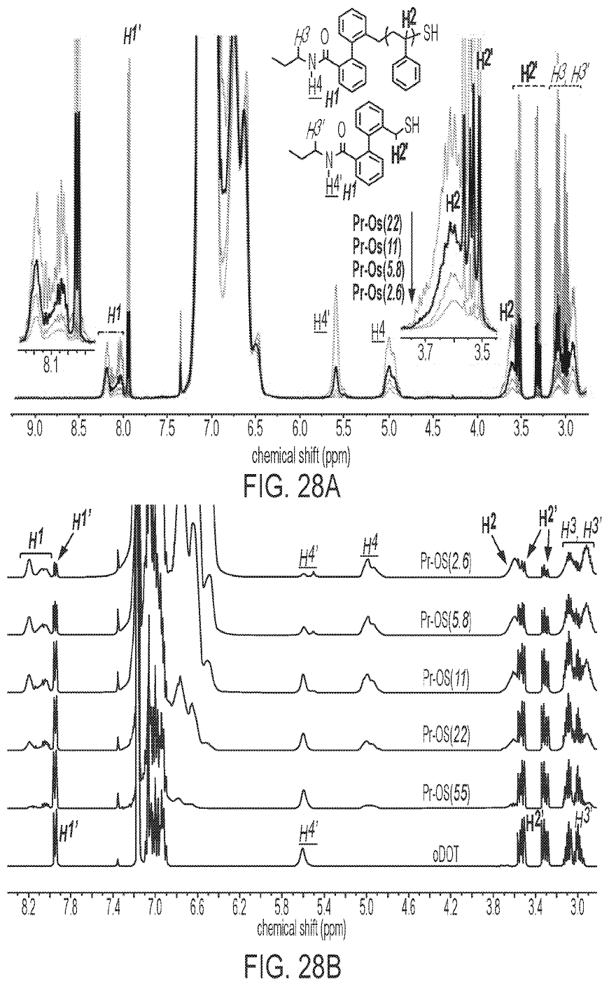

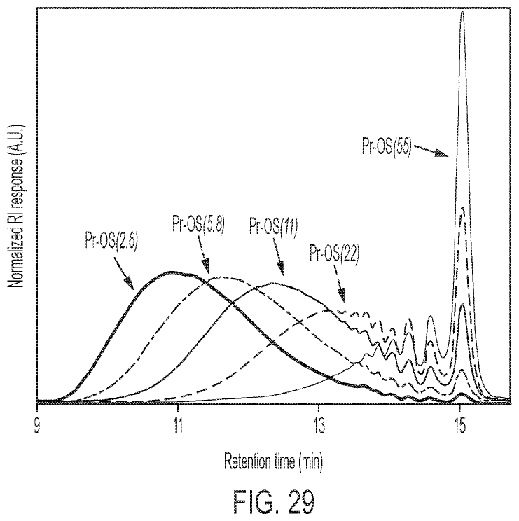

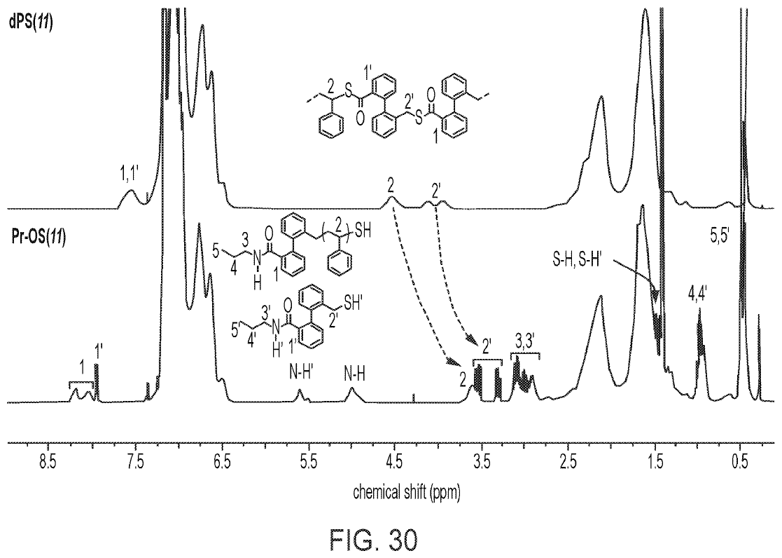

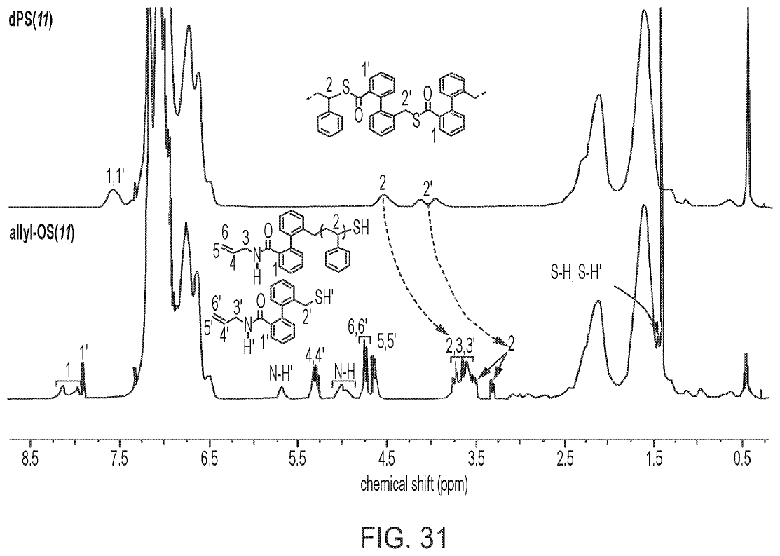

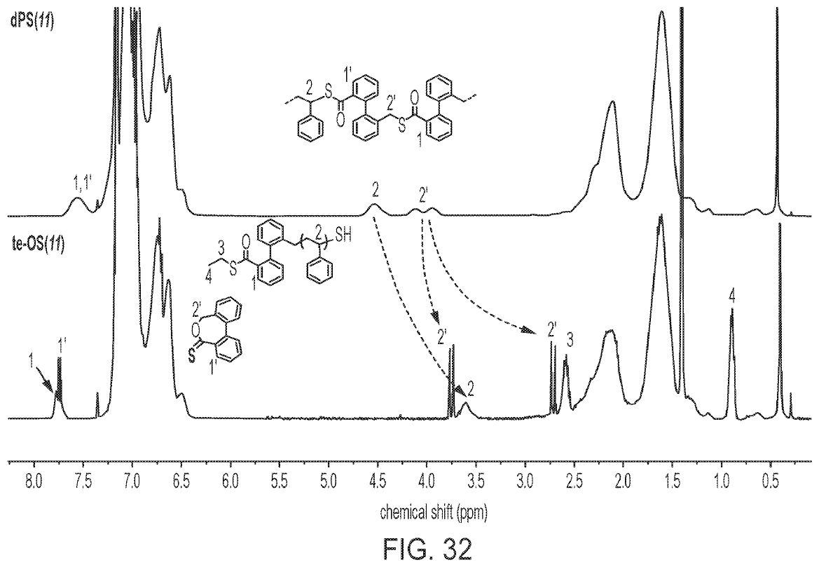

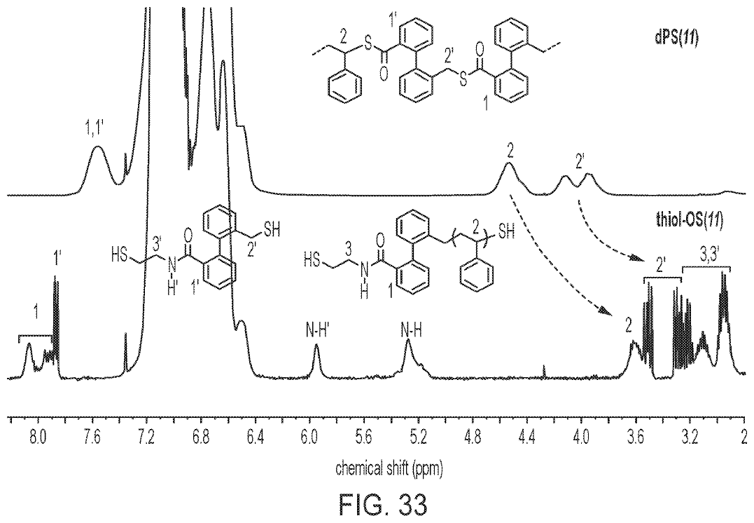

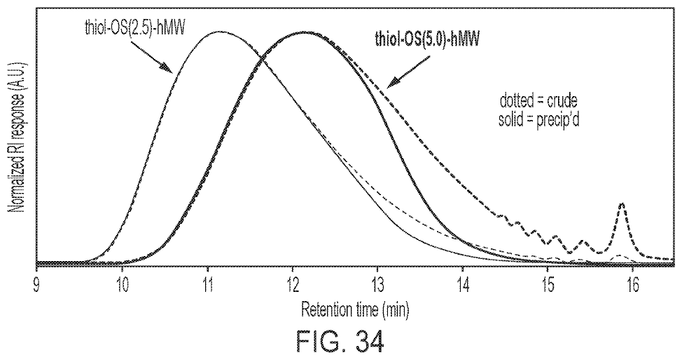

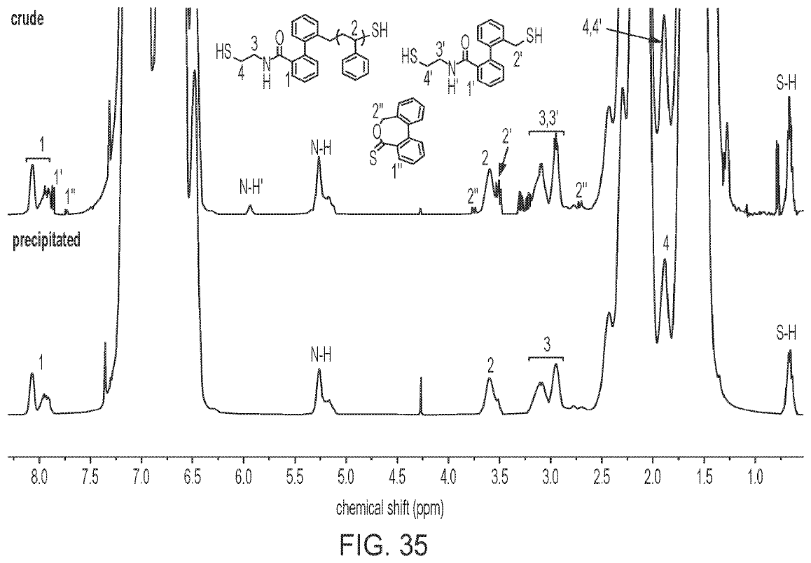

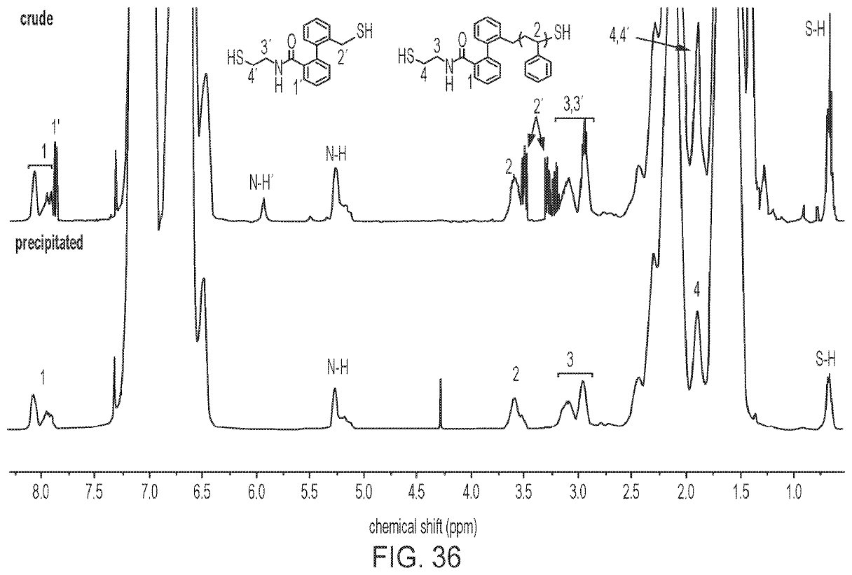

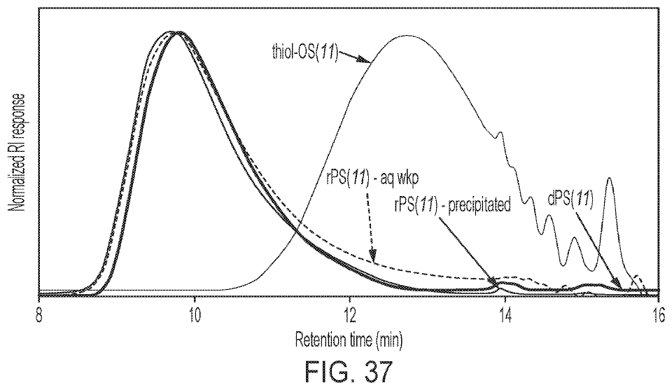

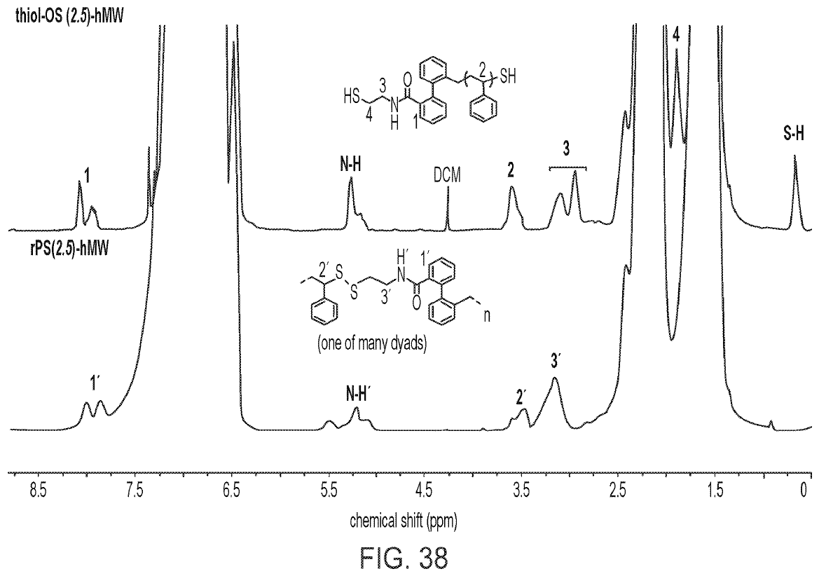

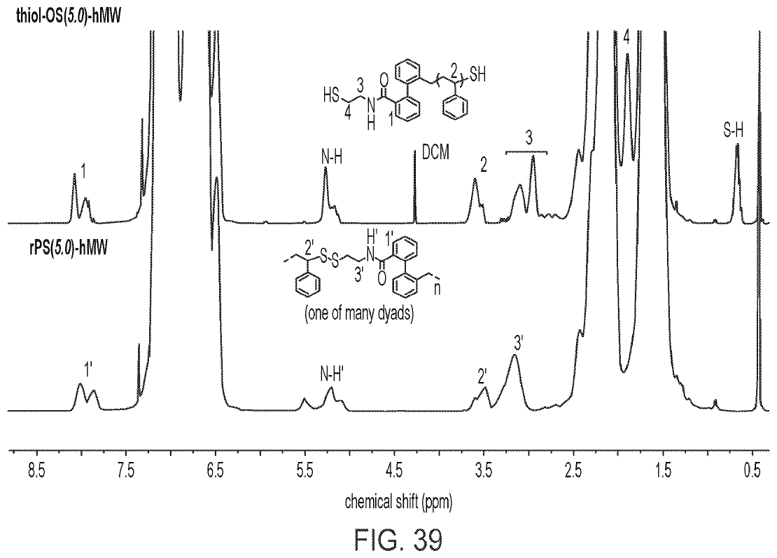

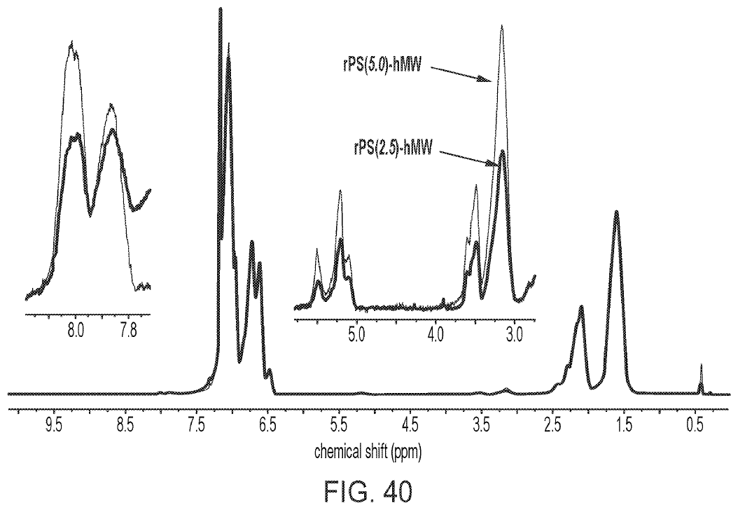

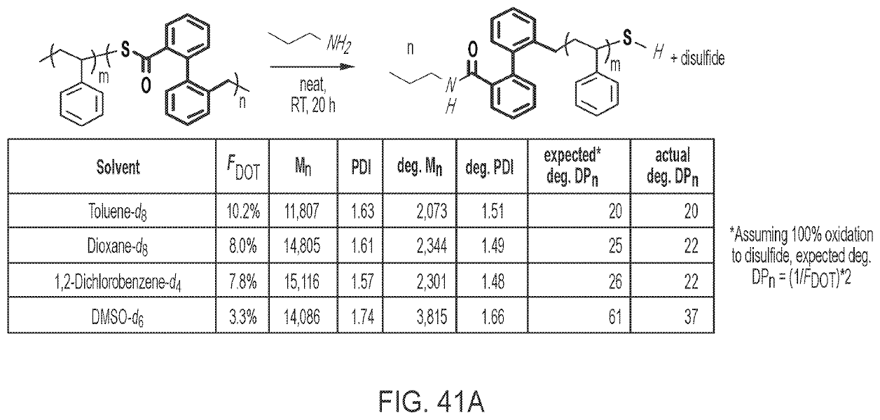

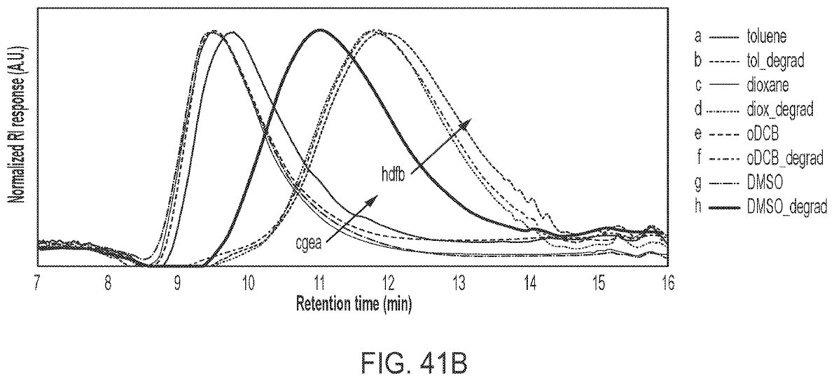

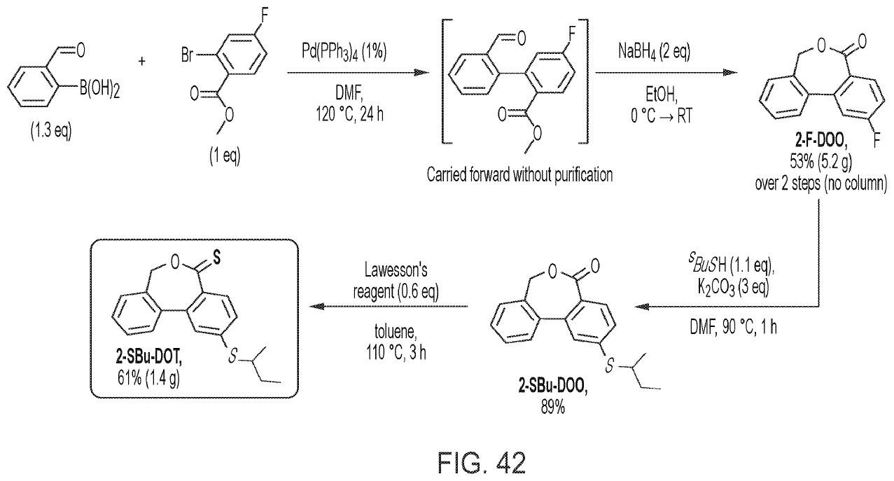

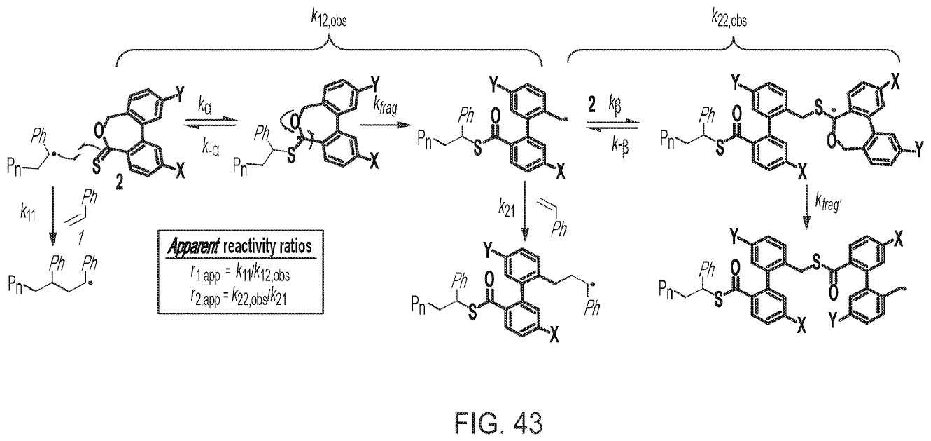

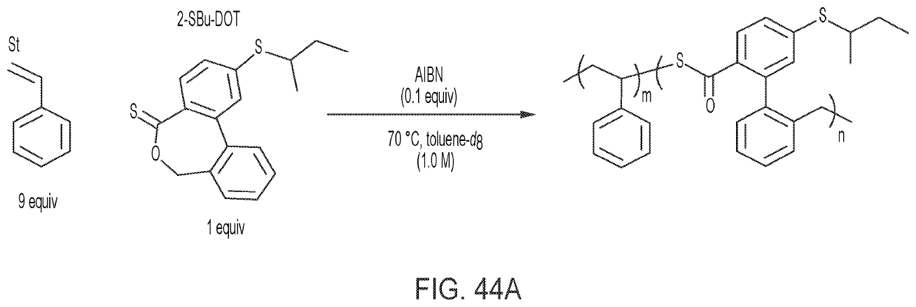

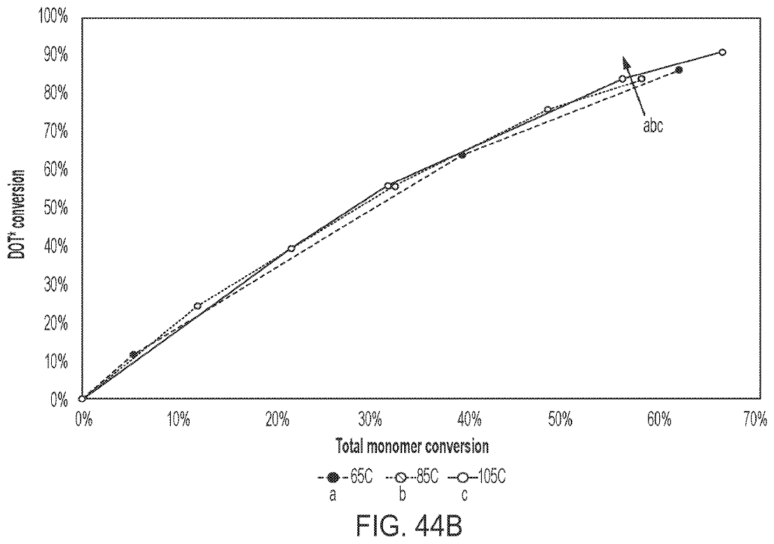

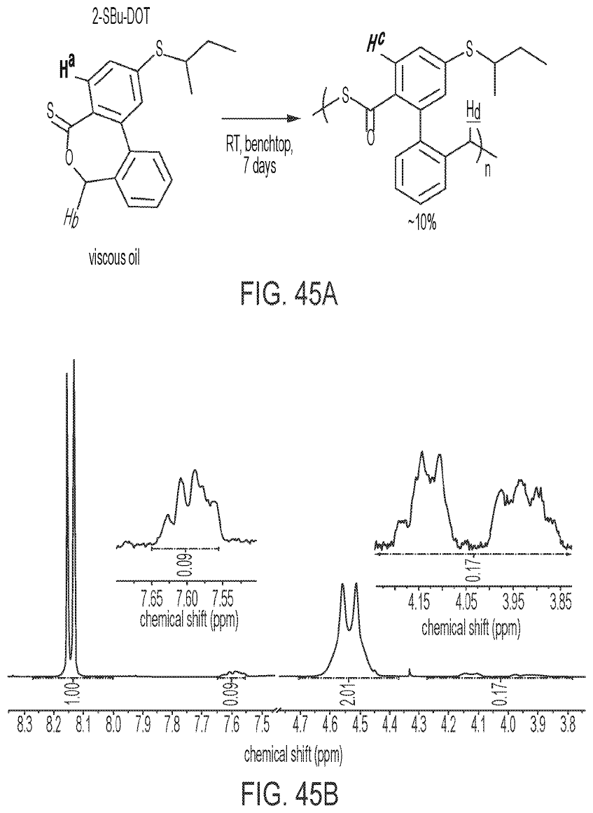

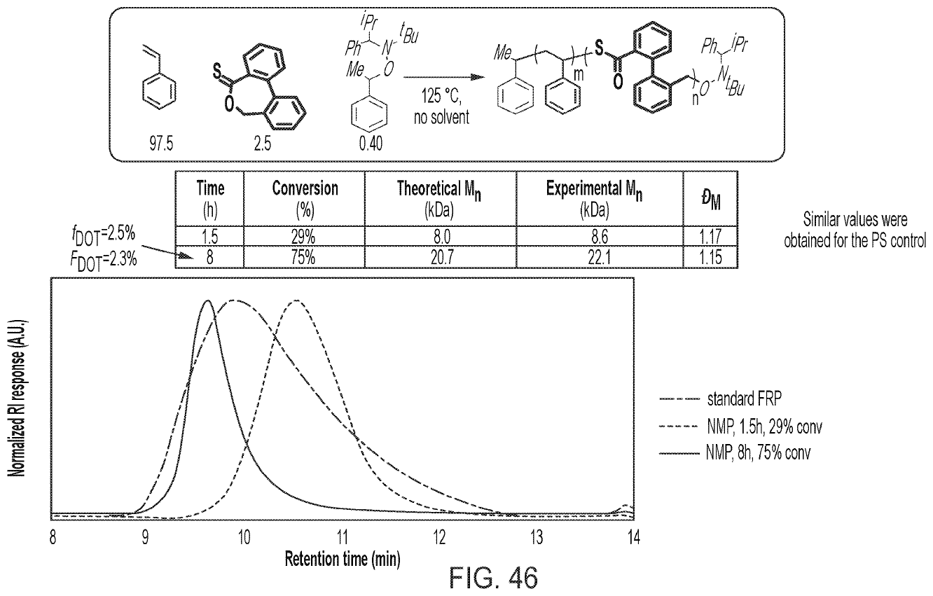

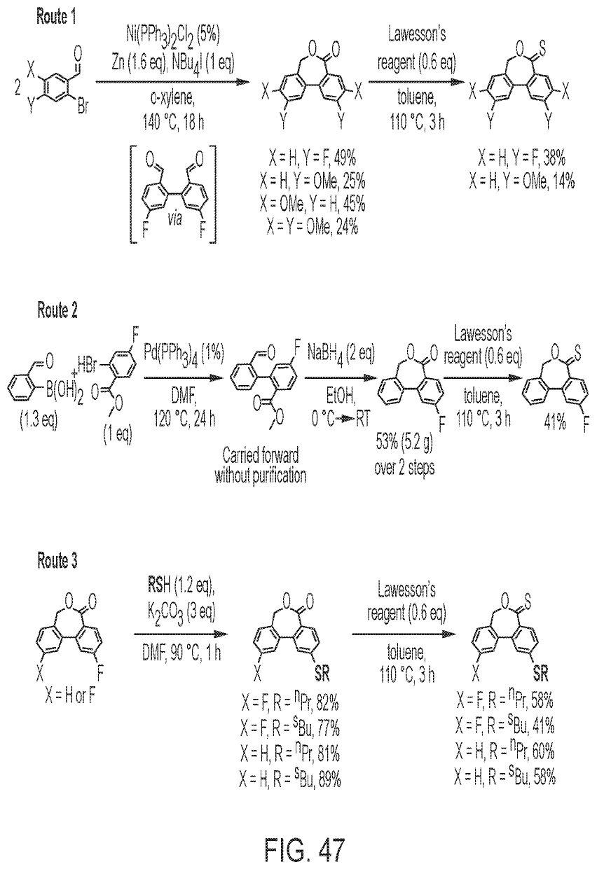

In air, a 4 mL vial containing the relevant X-Y-dPS(6 mg) and n-propylamine (0.5 mL). The vial was capped and the resulting homogeneous mixture was allowed to stand at RT. After 3 days, an 0.25 mL aliquot was concentrated to dryness via rotary evaporation. To remove residual n-propylamine, the residue was dissolved in CHCl₃ (0.5 mL) and the solution concentrated to dryness via rotary evaporation. This isolation process was repeated on the remaining mixture after 7 days at RT, then each sample was analyzed by SEC. In all cases, the SEC traces after 3 and 7 days were nearly indistinguishable (FIG. 27), suggesting that each reaction had gone to completion.

Pr—OS(F_{DOT}) from Deconstruction of dPS(F_{DOT})

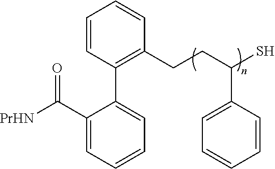

Procedure: A 10 mL Teflon-stoppered flask was loaded with dPS(11) (305 mg, 0.267 mmol of thioester units, 1.0 equiv). The flask was deoxygenated* with 3 vacuum/N₂ cycles, then deoxygenated n-propylamine (2.0 mL) was added via syringe. The resulting homogeneous, stirred mixture was submersed in an oil bath pre-set to 50° C. for 6 h. The mixture was allowed to cool to RT and concentrated to dryness under high vacuum. The residue was dissolved in deoxygenated CH₂Cl₂ (2 mL) and volatile materials were again removed under vacuum. ** This was repeated 1×. Finally, the residue was quantitatively transferred to a 20 mL vial with CH₂C12 (˜1 mL) and cyclohexane *** (˜6 mL), the mixture was concentrated to dryness via rotary evaporation and dried under high vacuum for ˜1 h, then the foam was pulverized with a spatula. The contents of the vial were placed under high vacuum overnight, affording Pr—OS(11) (329 mg, >98% ****) as a free-flowing, colorless solid. M_{n,SEC}=1.1 kDa, M_{w,SEC}=2.1 kDa, Ð_{M}=1.9. The analogous fragments Pr—OS(2.6), Pr—OS(5.8), Pr—OS(22), Pr—OS(55), and oDOT were prepared in an identical fashion as colorless solids in similarly high yields. The only differences were reaction times for Pr—OS(2.6) and Pr—OS(5.8) (36 h each).

Notes: * Performing this reaction in air yields a complex mixture of end groups resulting from initial oxidation of thiol to disulfide followed by further unidentified degradation reactions. Until all n-propylamine has been removed, it is preferred to exclude air. ** The purpose of this dissolution/evaporation step is to ensure full evaporation of n-propylamine before exposure to air. *** This transfer solvent was chosen for the following reasons: 1) its relatively high boiling point (81° C.) ensures removal of other volatile materials, which may have resonances that obscure important regions of the ¹H NMR spectrum (cyclohexane gives one singlet in an unimportant region); 2) We have found that complete removal of solvent from these oligomers is very difficult, and residual cyclohexane was expected to be inert in virtually any subsequent transformation; 3) the physical nature of the solid produced from cyclohexane evaporation is a somewhat voluminous, easily-weighable powder. **** Contains ˜10 mg of cyclohexane.

allyl-OS(11)

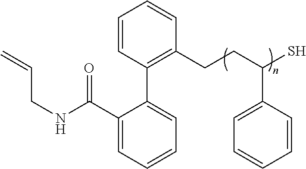

Procedure: The procedure was identical to Pr—OS(11) and afforded allyl-OS(11) (333 mg, >98%) as a free-flowing, colorless solid. M_{n,SEC}=1.1 kDa, M_{w,SEC}=2.0 kDa, Ð_{M}=1.8.

te-OS(11)

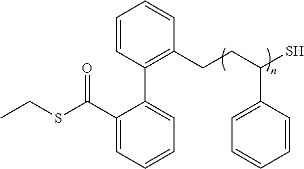

Procedure: A 20 mL Teflon-stoppered flask was loaded with dPS(11) (503 mg, 0.440 mmol of thioester units, 1.0 equiv) and EtSH (1.00 mL, 862 mg, 13.9 mmol, 31 equiv). The solution was deoxygenated with 3 free-pump-thaw cycles, then deoxygenated DBU (7.9 mg, 0.052 mmol, 0.12 equiv) was added via syringe, resulting in an immediate color change from colorless to light yellow. The flask was sealed and the mixture was stirred at RT for 22 h. The reaction was quenched by addition of deoxygenated AcOH (30 μL, 0.53 mmol, 1.2 equiv) against N₂ flow. Within 15 min, the mixture turned from pale yellow to colorless, after which time it was diluted with EtOAc (30 mL), washed with water (3×30 mL) and saturated aqueous NaCl (30 mL), dried with Na₂SO₄, and filtered. Solvents were removed from the filtrate via rotary evaporation, then the residue was transferred to a 20 mL vial as described for Pr—OS(11) (with linearly adjusted volumes), affording 537 mg of a free-flowing, colorless solid, which was determined—by ¹H NMR spectroscopy—to be 90% te-OS(11) by mass. The remainder of the mass was DTO (6%) and cyclohexane (4%). Adjusting for these known components, the isolated yield of te-OS(11) was 483 mg (93%). M_{n,SEC}=1.3 kDa, M_{w,SEC}=2.1 kDa, Ð_{M}=1.6.

DTO from Self-Immolation of pDOT

Procedure: A J-Young NMR tube was charged with a solution of pDOT (50 mg, 0.22 mmol of repeat unit, 1.0 equiv) and mesitylene (18 mg, 0.15 mmol, 0.7 equiv, internal standard) in DMF (0.7 mL), then a baseline 1H NMR was acquired. The solution was subjected to 2 freeze-pump-thaw cycles, then 1-propanethiol (6.2 μL, 5.1 mg, 0.66 mmol, 0.30 equiv) and triethylamine (9.2 μL, 6.7 mg, 0.66 mmol, 0.30 equiv) were rapidly added to the frozen solution under a cone of N₂. The mixture was subjected to 2 further free-pump-thaw cycles, backfilled with N₂, and allowed to stand at RT. After 20 min and 13 h, 1H NMR indicated the formation of DTO in 50% and >98% yield, respectively. The mixture was poured into a vial, the tube was rinsed with CH₂Cl₂, then volatile materials were removed via rotary evaporation at RT followed by 70° C. The residue was subjected to preparatory TLC (1:1 hexanes: CH₂Cl₂), affording DTO (47 mg, 94%) as a colorless oil. 1H NMR (benzene-d₆, 400 MHZ): δ=7.74 (dd, J=7.7, 1.5 Hz, 1H), 7.06 (td, J=7.5, 1.5 Hz, 1H), 7.02-6.92 (m, 5H), 6.74-6.68 (m, 1H), 3.75 (d, J=14.0 Hz, 1H), 2.71 (d, J=14.1 Hz, 1H).

¹³C NMR (chloroform-d, 101 MHz): δ=199.03, 139.22, 138.27, 138.10, 137.53, 132.21, 130.84, 130.47, 128.78, 128.63, 128.56, 128.34, 126.50, 34.16.

thiol-OS(11)

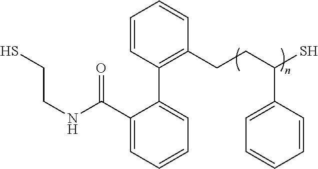

Procedure: A 20 mL Teflon-stoppered flask was loaded with dPS(11) (520 mg, 0.455 mmol of thioester units, 1.0 equiv), cysteamine hydrochloride (78 mg, 0.68 mmol, 1.5 equiv), and DMF (1.5 mL). The solution was deoxygenated with 3 free-pump-thaw cycles, then deoxygenated DBU (125 mg, 0.82 mmol, 1.8 equiv) was added dropwise via syringe against N₂ flow. The flask was sealed and the mixture was stirred at RT for 18 h. The reaction was quenched by addition of AcOH (94 μL, 1.64 mmol, 3.6 equiv) against N₂ flow. After 15 min, the colorless mixture was diluted with EtOAc (30 mL), washed with water (3×30 mL) and saturated aqueous NaCl (30 mL), dried with Na₂SO₄, and filtered. Solvents were removed from the filtrate via rotary evaporation, then the residue was transferred to a 20 mL vial as described for Pr—OS(11) (with linearly adjusted volumes), affording 580 mg of free-flowing, colorless solid which was determined—by ¹H NMR spectroscopy—to be 94% thiol-OS(11) by mass (the remainder was cyclohexane). Thus, the isolated yield of thiol-OS(11) was 544 mg (98%). M_{n,SEC}=1.1 kDa, M_{w,SEC}=2.0 kDa, Ð_{M}=1.8.

Thiol-OS(2.5)-hMW and Thiol-OS(5.0)-hMW

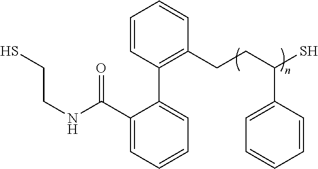

Procedure 1 (purification by precipitation): A 250 mL round bottom Schlenk flask was loaded with dPS(2.5)-hMW (8.00 g, 1.83 mmol of thioester units, 1.0 equiv) and a magnetic stirbar, sealed with a rubber septum, and placed under an N₂ atmosphere with three vacuum/N₂ cycles. A separate 100 mL round bottom Schlenk flask was similarly charged with cysteamine hydrochloride (0.416 g, 3.66 mmol, 2.0 equiv) and deoxygenated DMF (37 mL), then DBU (0.836 g, 5.49 mmol, 3.0 equiv) was added dropwise via syringe. The contents of the flask were transferred via cannula to the flask containing dPS(2.5)-hMW, and the resulting mixture was stirred* at RT under N₂ for 24 h. The reaction was quenched by addition of deoxygenated AcOH (0.66 mL, 11.5 mmol, 6.3 equiv). After 15 min, the mixture was transferred to a 1 L separatory funnel with the aid of EtOAc (350 mL), washed with water (3×350 mL) and saturated aqueous NaCl (350 mL), dried with Na₂SO₄, and filtered. Solvents were removed from the filtrate via rotary evaporation and the oligomer was purified as follows. The residue was dissolved CH₂Cl₂ (40 mL) and the solution was added dropwise to stirred MeOH (400 mL). The precipitate was collected by filtration and washed with MeOH (30 mL). The precipitation procedure was repeated 1×, then the solid was placed under high vacuum at RT until a constant mass was obtained. This afforded thiol-OS(2.5)-hMW (7.06 g, 88%) as a white powder. M_{n,SEC}=5.49 kDa, M_{w,SEC}=9.59 kDa, Ð_{M}=1.75.

Precipitated thiol-OS(5.0)-hMW was prepared in an identical fashion in 83% yield (5.71 g). M_{n,SEC}=3.29 kDa, M_{w,SEC}=5.18 kDa, Ð_{M}=1.57.

Procedure 2 (isolation of crude): Same as Procedure 1, but with the following differences. 3.03 g of dPS(2.5)-hMW was used and the other quantities were scaled linearly. After rotary evaporation, the residue was isolated by solvent transfer as described for Pr—OS(11) (with linearly adjusted volumes), affording 3.38 g of free-flowing, colorless solid, which was determined—by 1H NMR spectroscopy—to be 89% thiol-OS(2.5)-hMW by mass (the remainder was cyclohexane). Thus, the isolated yield of thiol-OS(2.5)-hMW was 3.02 g (98%). M_{n,SEC}=4.40 kDa, M_{w,SEC}=9.06 kDa, Ð_{M}=2.06.

Crude thiol-OS(5.0)-hMW was prepared in an identical fashion in >98% yield (0.73 g). M_{n,SEC}=2.11 kDa, M_{w,SEC}=4.49 kDa, Ð_{M}=2.13.

Notes: * Immediately after addition, manual agitation was preferred in order to obtain a homogeneous solution.

Recycled Polystyrene (rPS)

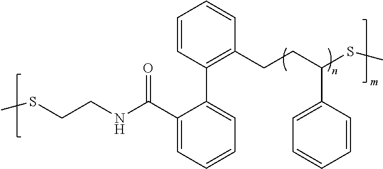

### I₂/Pyr Stock Solution (Representative Procedure).

A 5.00 mL volumetric flask was charged with a small magnetic stirbar, powdered 12 (877 mg, 3.46 mmol, 1.0 equiv), pyridine (545 mg, 6.89 mmol, 2.0 equiv), and CH₂Cl₂ (3 mL). The mixture was stirred until homogeneous, then CH₂Cl₂ was carefully added until a volume of 5.00 mL was obtained. The final I₂ concentration was 325 mg/mL (1.28 mmol/mL). This solution was used within 30 min of preparation.

rPS(11)

Procedure 1 (isolation by direct precipitation): A 4 mL vial was charged with a magnetic stirbar, thiol-OS(11) (300 mg, 0.00168 mmol R—SH* per mg polymer, 0.504 mmol R—SH), and CH₂Cl₂ (600 μL). To the stirred solution was then added 236 μL of the above-described I₂/pyr stock solution (0.302 mmol or 0.60 equiv of I₂) dropwise over 2-3 min. The mixture remained colorless until 70-75% of the addition was complete, after which time there was a distinct color change to yellow/brown. The mixture was stirred for a further 1 h at RT, diluted to a total of 4 mL with CH₂Cl₂, and added dropwise to rapidly stirred MeOH (50 mL). The solid was collected on a 15 mL fritted funnel and washed with MeOH (2×5 mL). This precipitation procedure was repeated until a white solid was obtained (typically a total of 3-4×). To avoid excessive mechanical losses, CH₂Cl₂ was used to quantitatively combine all product before subsequent precipitation. The final product was dried in a vacuum oven at 50° C. for 3 h, affording 250 mg (89%) of a white powder. M_{n,SEC}=12.3 kDa, M_{w,SEC}=22.3 kDa, Ð_{M}=1.81.

Notes: * Since it was found that excess I₂ does not impact the outcome of this reaction, for simplicity R—SH concentration was assumed to be 2× that of the thioester concentration in the precursor dPS. The actual value was lower due to the presence of cyclohexane (the yield calculation takes this into account).

Procedure 2 (isolation by aqueous workup): The first part of the procedure was the same as that for Procedure 1. At the completion of the reaction, the mixture was quantitatively transferred to a separatory funnel with EtOAc (50 mL), then washed with 3% aqueous sodium thiosulfate (50 mL), aqueous HCl (1 M, 50 mL), water (50 mL), and brine (50 mL), dried with Na₂SO₄, filtered, and the filtrate was concentrated via rotary evaporation followed by high vacuum. The residue was then analyzed by SEC. M_{n,SEC}=11.4 kDa, M_{w,SEC}=22.6 kDa, Ð_{M}=1.99.

rPS(2.5)-hMW and rPS(5.0)-hMW

From precipitated oligomer: A 40 mL vial was charged with a magnetic stirbar, precipitated thiol-OS(2.5)-hMW (3.00 g, 0.000458 mmol R—SH* per mg of polymer, 1.37 mmol R—SH), and CH₂Cl₂ (6.00 mL).** To the stirred solution was then added, dropwise over 2-3 min, an 12/pyr/CH₂Cl₂ solution (2.36 mL total volume, 0.822 mmol of 12, and 1.64 mmol of pyr) that was prepared analogously to the one described above. The mixture remained colorless until 59% of the addition was complete, after which time there was a distinct color change to yellow/brown.

Right around this time, there was a dramatic increase in viscosity, the magnitude of which is correlated to the molecular weight of the polymeric product. In this case, the mixture halted and a vortexer was needed for mixing for the remainder of the addition. The mixture was allowed to stand for a further 1 h at RT, quantitatively transferred to a separatory funnel with the aid of EtOAc (250 mL final volume), then washed with 3% aqueous sodium thiosulfate (250 mL), aqueous HCl (1 M, 250 mL), water (250 mL), and brine (250 mL), dried with Na₂SO₄, filtered, and the filtrate was concentrated via rotary evaporation. The residue was then dissolved in CH₂Cl₂ (50 mL) and the solution was added dropwise to rapidly stirred MeOH (500 mL). The solid was collected on a 60 mL fritted funnel, washed with MeOH (2×20 mL), and dried under high vacuum at RT to afford rPS(2.5)-hMW (2.87 g, 96%) as a flocculent white solid. An experiment at 0.1× scale (300 mg) afforded a polymer with identical molecular weight distribution, as determined by SEC. From SEC (major peak ***), Mₙ=165 kDa, M_{w}=322 kDa, and Ð_{M}=1.95.

The same procedure was employed for rPS(5.0)-hMW. The concentration of the I₂/pyr/CH₂Cl₂ was adjusted so that the total volume was the same. The mixture remained colorless until 47% of the addition was complete. The isolated yield of rPS(5.0)-hMW was 2.84 g (95%). From SEC (major peak ***), Mₙ=163 kDa, M_{w}=312 kDa, and Ð_{M}=1.91.

From crude oligomer: The procedure was identical to that employing precipitated oligomer, and observations were the same except for the following. Though the mixture was quite viscous, stirring was facile for the entirety of the reaction. The mixture remained colorless until 69% of the addition was complete. The isolated yield of rPS(2.5)-hMW was 95%. From SEC (major peak ***), Mₙ=125 kDa, M_{w}=241 kDa, and Ð_{M}=1.93.

The same procedure was employed for rPS(5.0)-hMW, and observations were the same except that the mixture remained colorless until 69% of the addition was complete. The isolated yield of rPS(5.0)-hMW was 93%. From SEC (major peak ***), Mₙ=100 kDa, M_{w}=184 kDa, Ð_{M}=1.85.

Notes: * Since it was found that excess I₂ does not impact the outcome of this reaction, for simplicity R—SH concentration was assumed to be 2× that of the thioester concentration in the precursor dPS. The actual value is lower. ** Due to the high viscosity of the final reaction mixture, great care was taken to avoid splashing the solution on the sides of the vial. *** As discussed in the main text, there is a shoulder in the SEC trace for each recycled PS sample. The spectra were deconvoluted and the data shown here are for the major peak, which represents 90-95% of the mass. For calculations of M_{w} values, this shoulder was included and the values are comparable.

### REFERENCES

(1) Modern Styrenic Polymers: Polystyrenes and Styrenic Copolymers; Scheirs, J., Priddy, D. B., Eds.; Scheirs, J., Series Ed.; Wiley Series in Polymer Science; John Wiley & Sons, Ltd: Chichester, UK, 2003.
(2) Coates, G. W.; Getzler, Y. D. Y. L. Chemical Recycling to Monomer for an Ideal, Circular Polymer Economy. Nat. Rev. Mater. 2020, 5 (7), 501-516.
(3) Sawaguchi, T.; Seno, M. Controlled Thermal Degradation of Polystyrene Leading to Selective Formation of End-Reactive Oligomers. J. Polym. Sci. Part Polym. Chem. 1998, 36 (1), 209-213.
(4) Shieh, P.; Zhang, W.; Husted, K. E. L.; Kristufek, S. L.; Xiong, B.; Lundberg, D. J.; Lem, J.; Veysset, D.; Sun, Y.; Nelson, K. A.; Plata, D. L.; Johnson, J. A. Cleavable Comonomers Enable Degradable, Recyclable Thermoset Plastics. Nature 2020, 583 (7817), 542-547.
(5) Husted, K. E. L.; Shieh, P.; Lundberg, D. J.; Kristufek, S. L.; Johnson, J. A. Molecularly Designed Additives for Chemically Deconstructable Thermosets without Compromised Thermomechanical Properties. ACS Macro Lett. 2021, 10 (7), 805-810.
(6) Shieh, P.; Hill, M. R.; Zhang, W.; Kristufek, S. L.; Johnson, J. A. Clip Chemistry: Diverse (Bio) (Macro) Molecular and Material Function through Breaking Covalent Bonds. Chem. Rev. 2021, 121 (12), 7059-7121.
(7) Golemba, F. J.; Guillet, J. E. Photochemistry of Ketone Polymers. VII. Polymers and Copolymers of Phenyl Vinyl Ketone. Macromolecules 1972, 5 (2), 212-216.
(8) Hanner, M. J.; McKelvy, M. L.; Sikkema, K.; Priddy, D. B. Photo-Degradable Polystyrene Part IV: Comparison of Photo-Degradation Efficiency of Random Styrene-Co-Vinyl Ketones (SVK) versus Blends of Polystyrene and SVK Concentrates. Polym. Degrad. Stab. 1993, 39 (2), 235-239.
(9)Rimmer, S.; Ebdon, J. R. Synthesis of Telechelic Oligostyrenes by the Ozonoloysis of Poly(Styrene-Stat-Butadiene): Protection of Styrene Units against Ozone Attack by the Use of Di-N-Alkyl Amides as Sacrificial Ozone Scavengers. J. Polym. Sci. Part Polym. Chem. 1996, 34 (17), 3573-3583.
(10) Bailey, W. J.; Wu, S.-R.; Ni, Z. Synthesis and Free Radical Ring-Opening Polymerization of 2-Methylene-4-Phenyl-1,3-Dioxolane. Makromol. Chem. 1982, 183 (8), 1913-1920.
(11) Yuan, J.-Y.; Pan, C.-Y. “Living” Free Radical Ring-Opening Copolymerization of 4,7-Dimethyl-2-Methylene-1,3-Dioxepane and Conventional Vinyl Monomers. Eur. Polym. J. 2002, 38 (10), 2069-2076.
(12) Wickel, H.; Agarwal, S. Synthesis and Characterization of Copolymers of 5,6-Benzo-2-Methylene-1,3-Dioxepane and Styrene. Macromolecules 2003, 36 (16), 6152-6159.
(13) Jackson, A. W.; Reddy Mothe, S.; Chennamaneni, L. R.; van Herk, A.; Thoniyot, P. Unraveling the History and Revisiting the Synthesis of Degradable Polystyrene Analogues via Radical Ring-Opening Copolymerization with Cyclic Ketene Acetals. Materials 2020, 13 (10), 2325.
(14) Tardy, A.; Nicolas, J.; Gigmes, D.; Lefay, C.; Guillaneuf, Y. Radical Ring-Opening Polymerization: Scope, Limitations, and Application to (Bio) Degradable Materials. Chem. Rev. 2017, 117 (3), 1319-1406.
(15) Pesenti, T.; Nicolas, J. 100th Anniversary of Macromolecular Science Viewpoint: Degradable Polymers from Radical Ring-Opening Polymerization: Latest Advances, New Directions, and Ongoing Challenges. ACS Macro Lett. 2020, 1812-1835.
(16) M. Bingham, N.; J. Roth, P. Degradable Vinyl Copolymers through Thiocarbonyl Addition-Ring-Opening (TARO) Polymerization. Chem. Commun. 2019, 55 (1), 55-58.
(17) Smith, R. A.; Fu, G.; McAteer, O.; Xu, M.; Gutekunst, W. R. Radical Approach to Thioester-Containing Polymers. J. Am. Chem. Soc. 2019, 141 (4), 1446-1451.
(18) Galanopoulo, P.; Gil, N.; Gigmes, D.; Lefay, C.; Guillaneuf, Y.; Lages, M.; Nicolas, J.; Lansalot, M.; D'Agosto, F. One-Step Synthesis of Degradable Vinylic Polymer-Based Latexes via Aqueous Radical Emulsion Polymerization. Angew. Chem. Int. Ed. n/a (n/a).
(19) Agarwal, S.; Kumar, R.; Kissel, T.; Reul, R. Synthesis of Degradable Materials Based on Caprolactone and Vinyl Acetate Units Using Radical Chemistry. Polym. J. 2009, 41 (8), 650-660.
(20) Tardy, A.; Honoré, J.-C.; Tran, J.; Siri, D.; Delplace, V.; Bataille, I.; Letourneur, D.; Perrier, J.; Nicoletti, C.; Maresca, M.; Lefay, C.; Gigmes, D.; Nicolas, J.; Guillaneuf, Y. Radical Copolymerization of Vinyl Ethers and Cyclic Ketene Acetals as a Versatile Platform to Design Functional Polyesters. Angew. Chem. Int. Ed. 2017, 56 (52), 16515-16520.
(21) Wang, W.; Zhou, Z.; Sathe, D.; Tang, X.; Moran, S.; Jin, J.; Haeffner, F.; Wang, J.; Niu, J. Degradable Vinyl Random Copolymers via Photocontrolled Radical Ring-Opening Cascade Copolymerization **. Angew. Chem. Int. Ed. n/a (n/a), e202113302.
(22) Bingham, N. M.; Nisa, Q. un; Chua, S. H. L.; Fontugne, L.; Spick, M. P.; Roth, P. J. Thioester-Functional Polyacrylamides: Rapid Selective Backbone Degradation Triggers Solubility Switch Based on Aqueous Lower Critical Solution Temperature/Upper Critical Solution Temperature. ACS Appl. Polym. Mater. 2020, 2 (8), 3440-3449.
(23) Ebdon, J. R.; Flint, N. J. Synthesis of Water-Soluble Telechelic Methyl-Ketone-Ended Oligo-N,N-Dimethylacrylamides by the Ozonolysis of Poly(N,N-Dimethylacrylamide-Stat-2,3-Dimethylbutadiene) s. J. Polym. Sci. Part Polym. Chem. 1995, 33 (3), 593-597.
(24) Ebdon, J. R.; Flint, N. J. Preparation of α,β-Aldehyde-Ended Telechelic Methyl Methacrylate Oligomers by the Oxidative Cleavage of Statistical Methyl Methacrylate-Buta-1,3-Diene Copolymers. Eur. Polym. J. 1996, 32 (3), 289-294.
(25) Sawaguchi, T.; Seno, M. Synthesis of Multiblock Copolymers of α,β-Dihydrosilylpolydimethylsiloxane with α,β-Diisopropenyloligopropylenes with Different Stereoregularities. J. Polym. Sci. Part Polym. Chem. 1996, 34 (17), 3625-3629.
(26) Meijs, G. F.; Rizzardo, E.; Le, T. P. T.; Chen, Y.-C. Influence of Thionoesters on the Degree of Polymerization of Styrene, Methyl Acrylate, Methyl Methacrylate and Vinyl Acetate. Makromol. Chem. 1992, 193 (2), 369-378.
(27) T. Worrell, B.; Mavila, S.; Wang, C.; M. Kontour, T.; Lim, C.-H.; K. McBride, M.; B. Musgrave, C.; Shoemaker, R.; N. Bowman, C. A User's Guide to the Thiol-Thioester Exchange in Organic Media: Scope, Limitations, and Applications in Material Science. Polym. Chem. 2018, 9 (36), 4523-4534.
(28) Yardley, R. E.; Kenaree, A. R.; Gillies, E. R. Triggering Depolymerization: Progress and Opportunities for Self-Immolative Polymers. Macromolecules 2019, 52 (17), 6342-6360.
(29) Tsarevsky, N. V.; Matyjaszewski, K. Reversible Redox Cleavage/Coupling of Polystyrene with Disulfide or Thiol Groups Prepared by Atom Transfer Radical Polymerization. Macromolecules 2002, 35 (24), 9009-9014.
(30) Whittaker, M. R.; Goh, Y.-K.; Gemici, H.; Legge, T. M.; Perrier, S.; Monteiro, M. J. Synthesis of Monocyclic and Linear Polystyrene Using the Reversible Coupling/Cleavage of Thiol/Disulfide Groups. Macromolecules 2006, 39 (26), 9028-9034.
(31) Graessley, W. W. The Entanglement Concept in Polymer Rheology. In The Entanglement Concept in Polymer Rheology, Advances in Polymer Science; Springer: Berlin, Heidelberg, 1974; pp 1-179.
(32) www.Matweb.Com/Search/DataSheet.Aspx?MatGUID=1c41e50c2e324e00b0c4e419ca78 0304&ckck=1.
(33) Yardley, R. E.; Kenaree, A. R.; Gillies, E. R. Triggering Depolymerization: Progress and Opportunities for Self-Immolative Polymers. Macromolecules 2019, 52 (17), 6342-6360. (34) Macosko, C. W.; Miller, D. R. A New Derivation of Average Molecular Weights of Nonlinear Polymers. Macromolecules 1976, 9 (2), 199-206.
(35) Schmid, S. A.; Abbel, R.; Schenning, A. P. H.; Meijer, E. W.; Sijbesma, R. P.; Herz, L. M. Analyzing the Molecular Weight Distribution in Supramolecular Polymers. J. Am. Chem. Soc. 2009, 131 (48), 17696-17704.
(36) Neto, N. S.; Jones, D. J.; Wong, W. W. H. Theoretical Aspects of Iterative Coupling for Linear Oligomers and Polymers. Macromol. Theory Simul. 2020, 29 (2), 1900048.
(37) M. Bingham, N.; J. Roth, P. Degradable Vinyl Copolymers through Thiocarbonyl Addition-Ring-Opening (TARO) Polymerization. Chem. Commun. 2019, 55 (1), 55-58.
(38) Whittaker, M. R.; Goh, Y.-K.; Gemici, H.; Legge, T. M.; Perrier, S.; Monteiro, M. J. Synthesis of Monocyclic and Linear Polystyrene Using the Reversible Coupling/Cleavage of Thiol/Disulfide Groups. Macromolecules 2006, 39 (26), 9028-9034.
(39) Brandmeier, V.; Feigel, M. A Macrocycle Containing Two Biphenyl and Two Alanine Subunits, Synthesis and Conformation in Solution. Tetrahedron 1989, 45 (5), 1365-1376.
(40) Miyagawa, M.; Akiyama, T. Tishchenko Reaction Using Substoichiometric Amount of Metallic Zinc. Chem. Lett. 2017, 47 (1), 78-81.
(41) Zhang, X.-S.; Zhang, Y.-F.; Li, Z.-W.; Luo, F.-X.; Shi, Z.-J. Synthesis of Dibenzo[c,e]Oxepin-5 (7H)-Ones from Benzyl Thioethers and Carboxylic Acids: Rhodium-Catalyzed Double C—H Activation Controlled by Different Directing Groups. Angew. Chem. Int. Ed. 2015, 54 (18), 5478-5482.
(42) Dana, S.; Chowdhury, D.; Mandal, A.; Chipem, F. A. S.; Baidya, M. Ruthenium (II) Catalysis/Noncovalent Interaction Synergy for Cross-Dehydrogenative Coupling of Arene Carboxylic Acids. ACS Catal. 2018, 8 (11), 10173-10179.

### Example 2

### Synthesis, Deconstruction, and Reconstruction of Copolymers

### General Route to Substituted DOTs

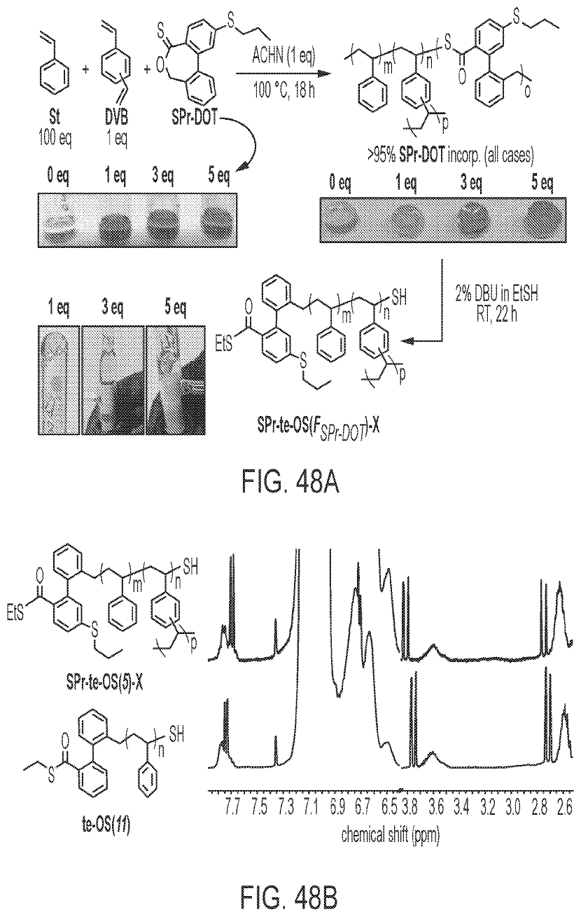

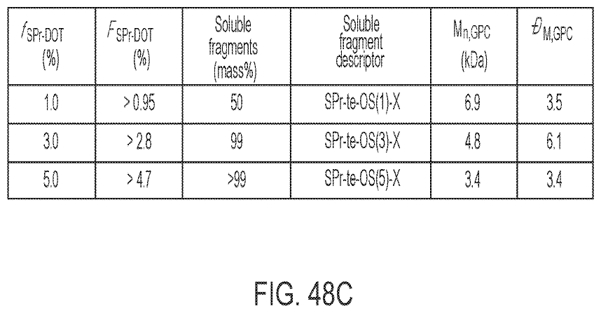

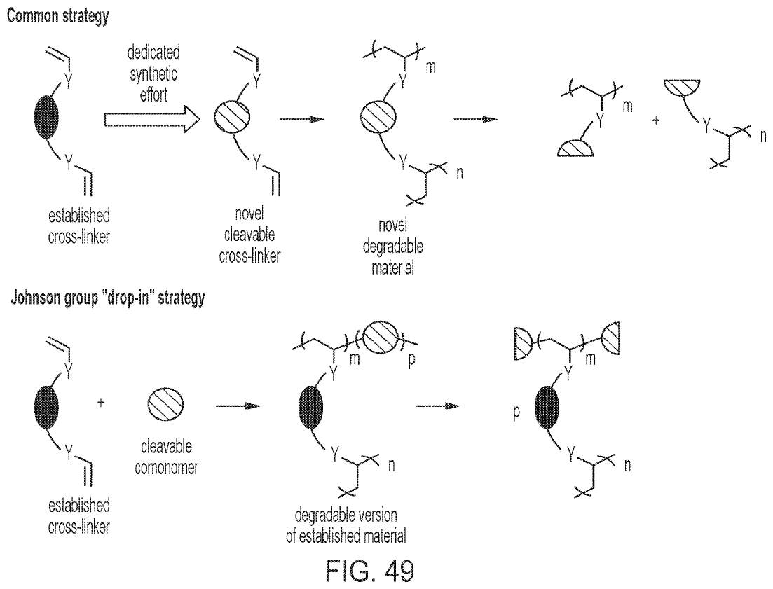

Three different substituted DOT strategies were developed, all culminating in a thionation with Lawesson's reagent to produce the desired DOT derivative (FIG. 48). These only differ in the details of the synthesis of the dibenzo[c, e]oxepin-5 (7H)-one (DOO) precursor to the DOT derivative.

### Determination of the Solubility of DOT in Styrene

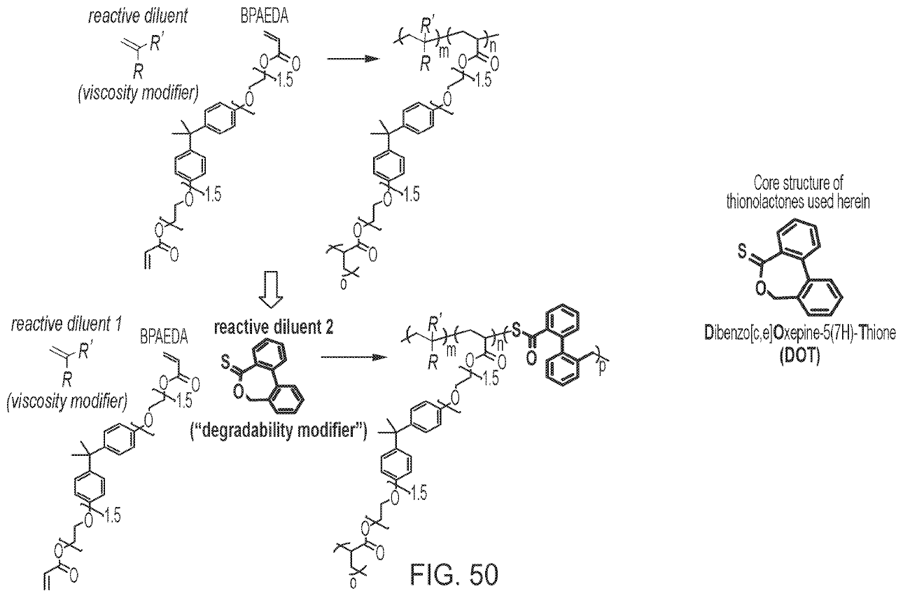

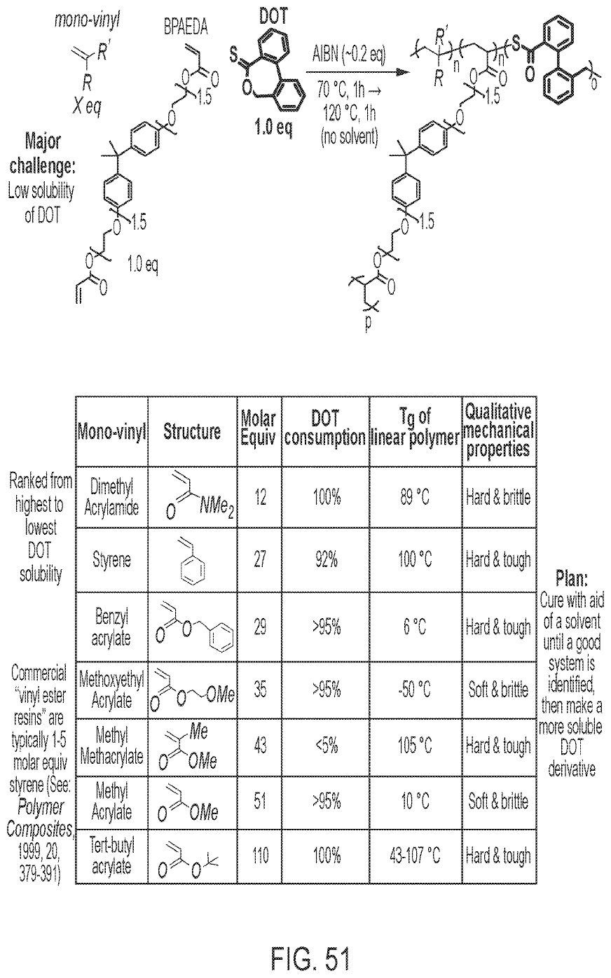

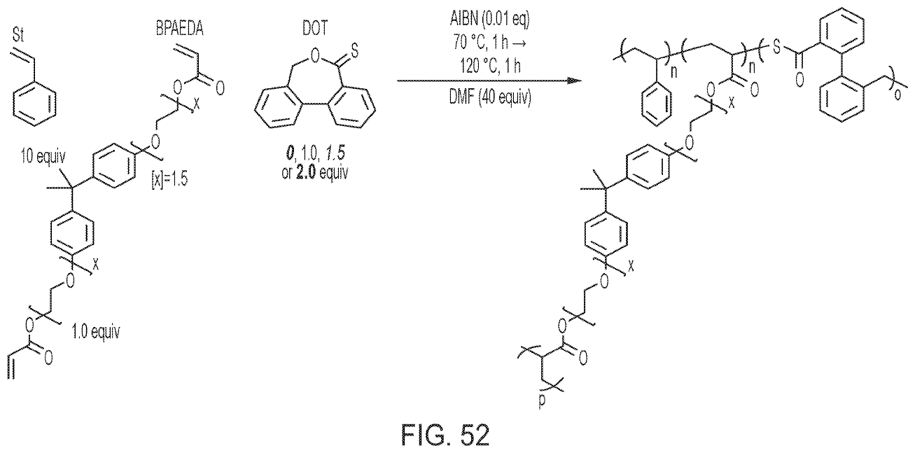

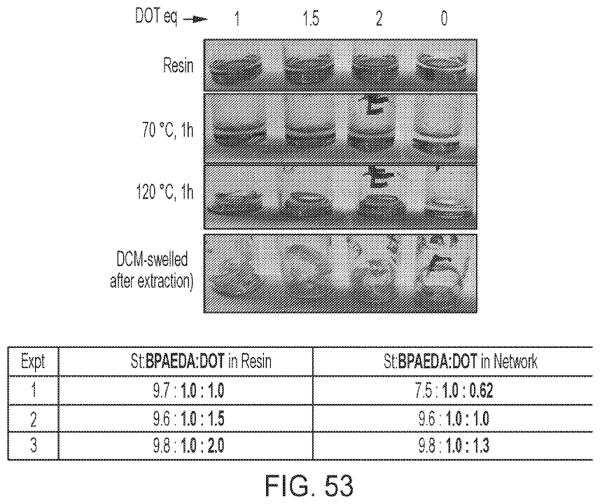

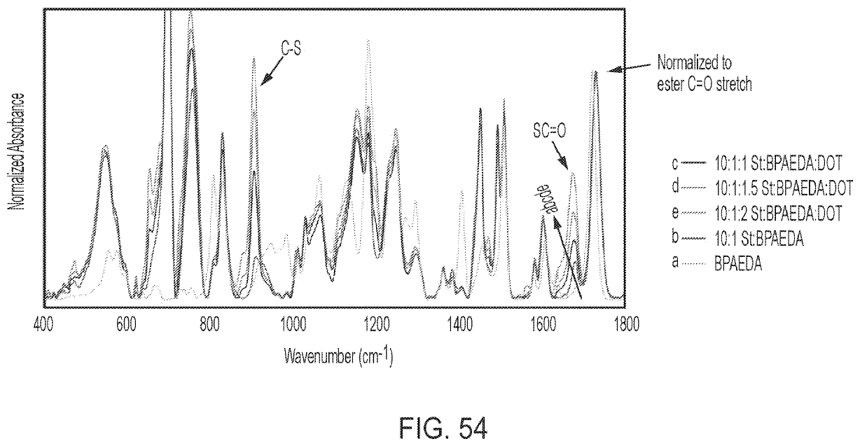

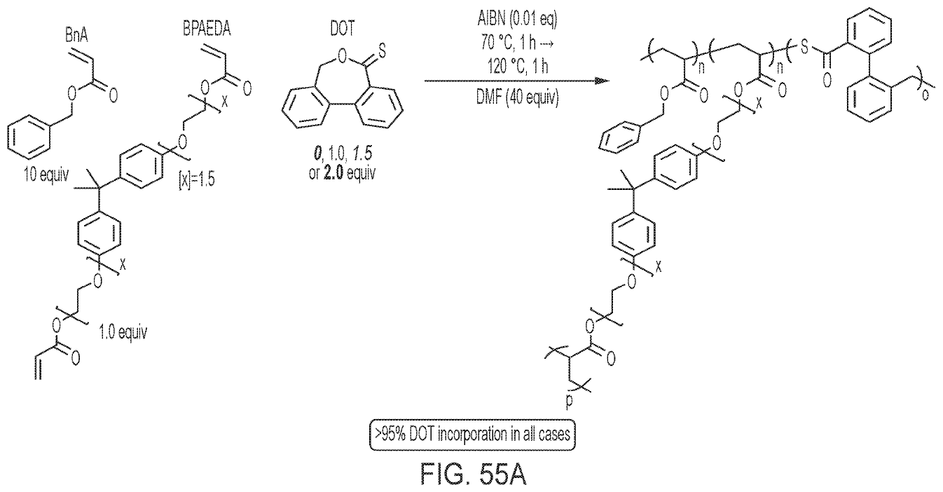

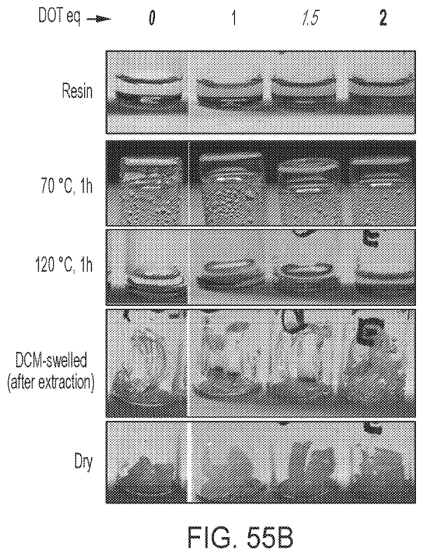

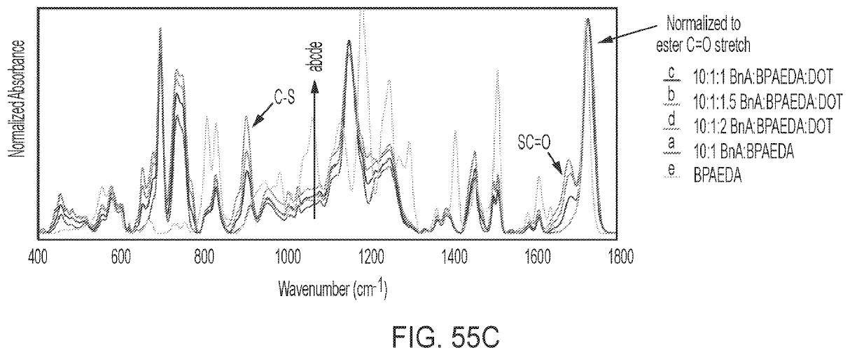

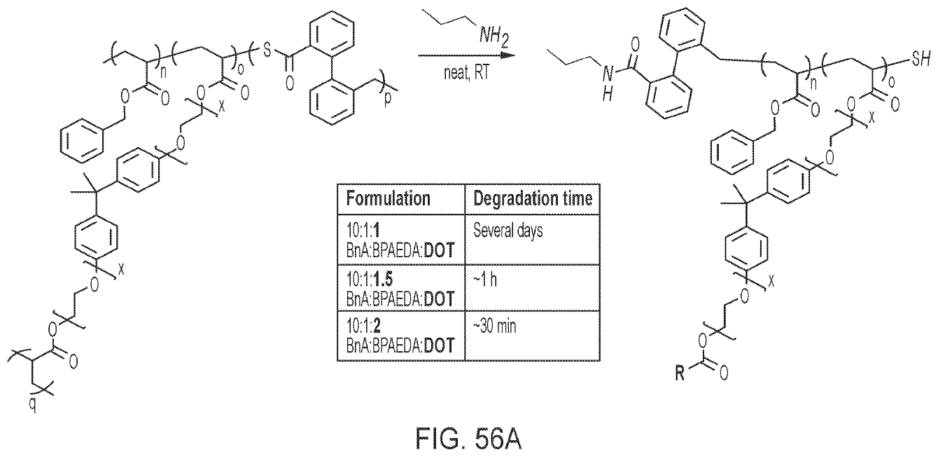

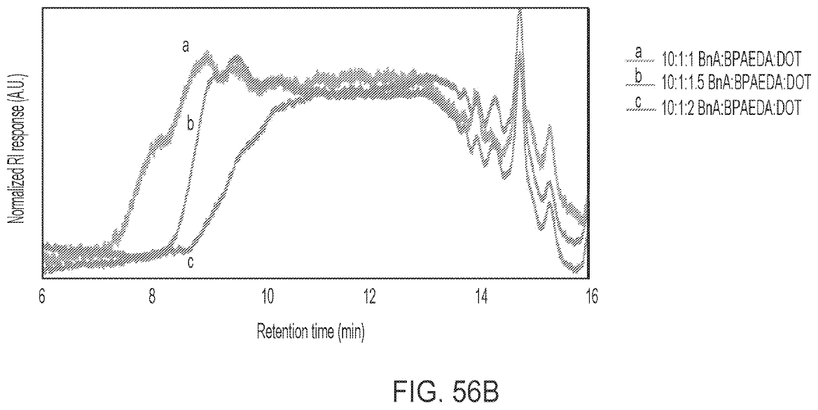

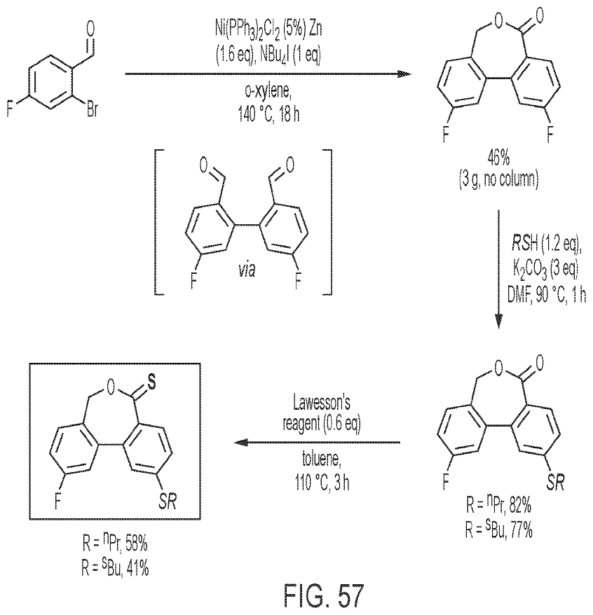

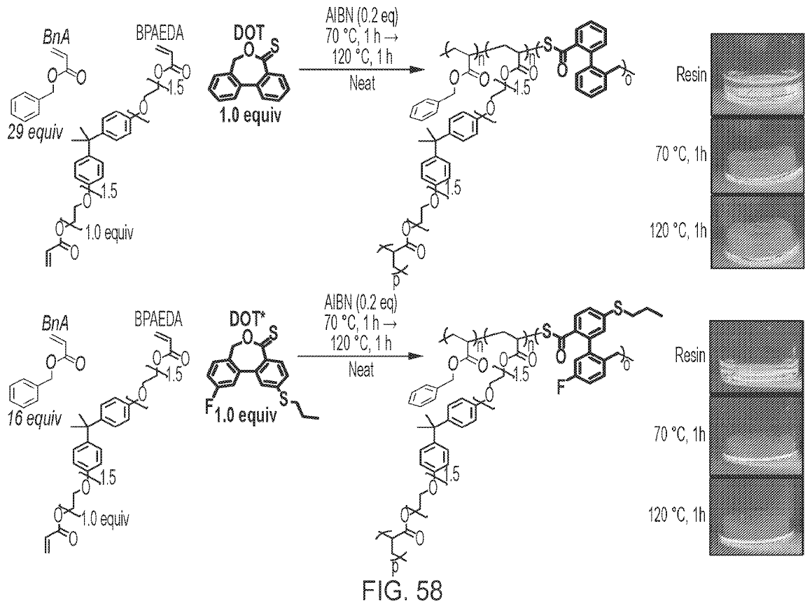

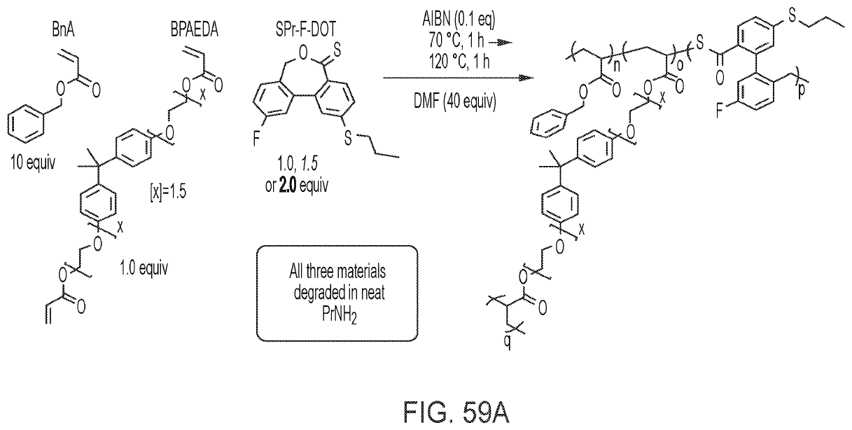

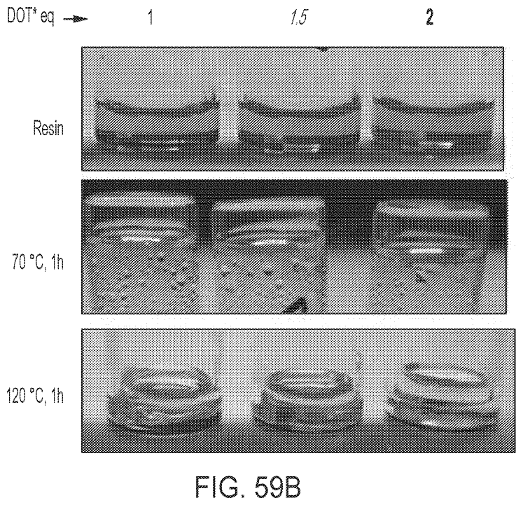

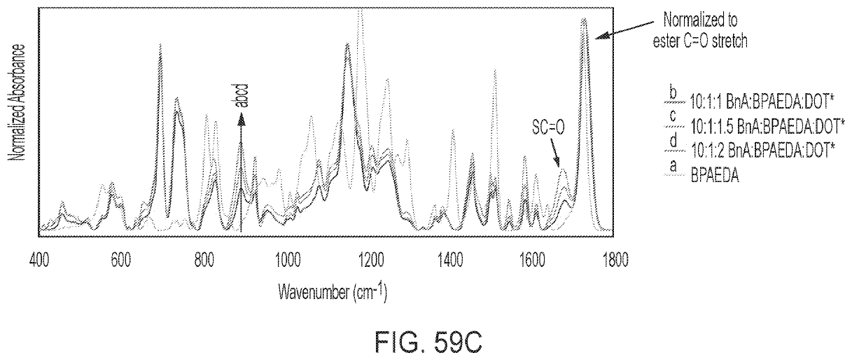

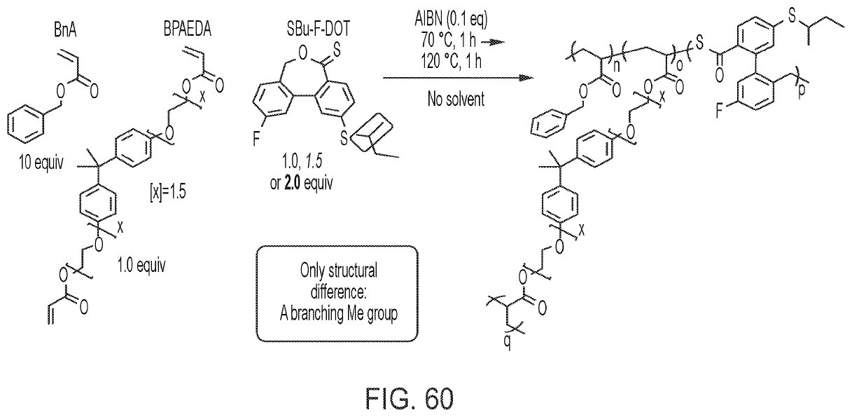

The solubility of DOT in styrene at 22° C. was determined by quantitative 1H NMR spectroscopy to be 1.0 molar equiv of DOT per 35 molar equiv of styrene, as described here. First, a saturated solution of DOT in styrene was prepared. To a vial containing 20 mg (0.088 mmol) of freshly recrystallized DOT was added 145 mg (16 equiv) of styrene. This mixture was vortexed for ˜5 min and then allowed to stand for 10 min. A lot of solid DOT remained. The mixture was passed through a 0.2 μm filter into an NMR tube (the temperature during filtration was 22° C.). The mixture was then diluted with chloroform-d and analyzed by quantitative 1H NMR spectroscopy (FIG. 50).

### Deconstruction of a Cross-Linked Styrenic Copolymer

The results demonstrated in this manuscript should be applicable to any styrenic copolymer. Since cross-linked variations are of enormous commercial importance and are especially difficult to deconstruct, a styrene/divinylbenzene resin system was chosen as a proof-of-concept (FIG. 48A). Notably, the absence of native cleavable bonds makes this perhaps one of the most challenging targets (unlike other networks like styrene-butadiene rubber and “vinyl ester” resins, which contain polysulfide and ester linkages, respectively).

For our proof-of-concept network deconstruction study (FIG. 48A), the more soluble SPr-DOT was employed instead of DOT since it enabled the preparation of homogeneous resins at a broader range of comonomer loadings. Resins containing DVB and ACHN (1 mol % each) were doped with SPr-DOT (f_{SPr-DOT}=1, 3, and 5 mol %) and oven-cured at 100° C. for 18 h, far beyond that needed for completion to ensure maximum cross-linking. In all cases, there was >95% SPr-DOT incorporation into the network, as determined by exhaustive extraction with CH2Cl2 followed by analysis of the extracts by quantitative 1H NMR spectroscopy. Treatment with 3% DBU in EtSH (chosen for its rapid deconstruction kinetics) effected complete dissolution within 1 h for the samples with f_{SPr-DOT}>1%. Partial dissolution (˜50%) was observed at the lowest comonomer loading (f_{SPr-DOT}=1%). The fragments were characterized by ¹H NMR and SEC (FIG. 48C). The former look virtually identical to that for te-OS(11). As expected, the Mₙ values decrease with increasing f_{SPr-DOT}, and the higher than expected Ð_{M} and Mₙ values may be attributable to the inhomogeneities that are notorious for vinylic networks produced by bulk radical polymerization.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1. A copolymer comprising:
m1 instances of the first repeating unit of Formula i: 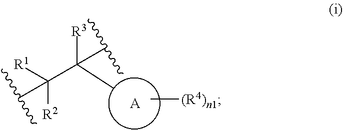
m2 instances of the second repeating unit of Formula ii-A or ii-B: 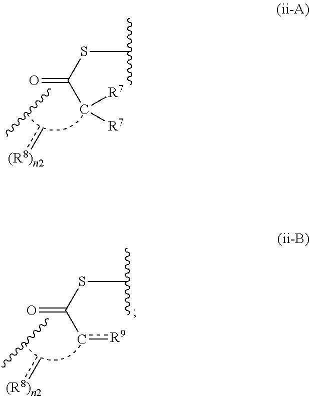
optionally one or more types of additional repeating units;
wherein:
the copolymer is substantially not crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NRC(═O)R^{a}, —NRC(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})³; [symbol]
is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
when attached to a carbon atom: halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, C(═NR^{b})OR^{b}, —C(═NR^{b})SR^{b}, C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, ═O, ═S, or ═NR^{b};
when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, —C(═O)N(R^{b})₂, C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
when attached to a sulfur atom: ═O;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
provided that:
none of R¹, R², R³, R⁴, Ring A, R⁷, and R⁸ comprise one or more non-aromatic unsaturated CC bonds;
none of the additional monomers comprise two or more non-aromatic unsaturated CC bonds;
the second repeating unit is not of the formula; 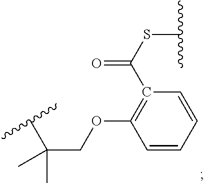
and
if the first repeating unit is of the formula: 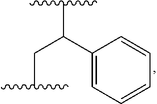
then the second repeating unit is not of the formula:

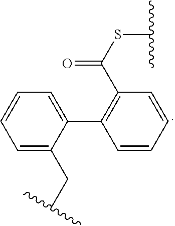

2. The copolymer of claim 1 prepared by a method comprising polymerizing a first monomer, a second monomer, and optionally one or more types of additional monomers, wherein:
the first monomer is of Formula I: 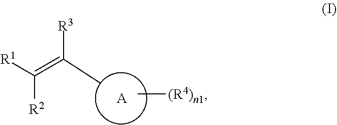
or a tautomer or salt thereof; and
the second monomer is of Formula II-A or II-B: 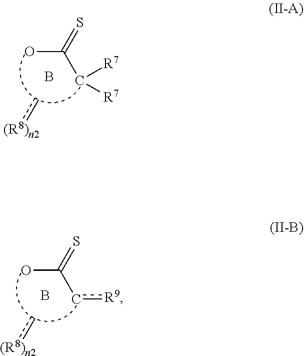
or a tautomer or salt thereof, wherein 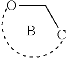
is Ring B, and Ring B is a heterocyclic ring;
provided that:
Ring B does not comprise one or more non-aromatic unsaturated CC bonds;
the second monomer is not of the formula: 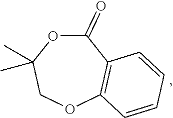
or a tautomer thereof; and
if the first monomer is unsubstituted styrene, then the second monomer is not of the formula: 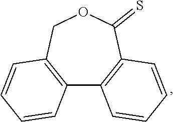 [SMILES: S=C1OCc2ccccc2-c2ccccc21]
or a tautomer thereof.

3. A method of preparing the copolymer of claim 2 comprising polymerizing the first monomer, the second monomer, and optionally one or more types of the additional monomers.

4. A homopolymer of the formula: 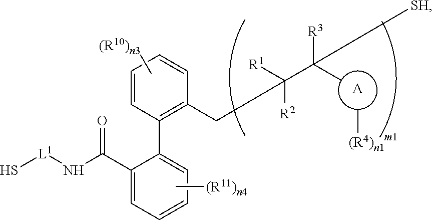
or a salt thereof, wherein:
m1 is an integer between 10 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NRC(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}s (═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n3 is 0, 1, 2, 3, or 4, n4 is 0, 1, 2, 3, or 4, and at least one of n3 and n4 is 1, 2, 3, or 4; and
L¹ is substituted or unsubstituted alkylene or substituted or unsubstituted heteroalkylene;
provided that:
provided that none of R¹, R², R³, R⁴, Ring A, R¹⁰, R¹¹, and L¹ comprise one or more non-aromatic unsaturated CC bonds.

5. A method of preparing the homopolymer of claim 4 comprising reacting the copolymer of claim 1 with a compound of the formula:
HS-L¹-NH₂,
or a salt thereof, in the presence of a base.

6-7. (canceled)

8. A copolymer comprising m3 instances of the repeating unit of Formula iii: 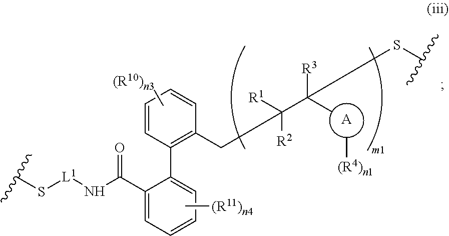
wherein:
m3 is an integer between 10 and 10,000, inclusive;
each instance of m1 is independently an integer between 10 and 1,000,000, inclusive;
R¹, R², and R³ are each independently hydrogen, halogen, or substituted or unsubstituted alkyl;
Ring A is aryl;
each instance of R⁴ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NR^{a}C(═O)SR^{a}, —NR^{a}C(═O)N(R^{a})₂, —NR^{a}C(═NR^{a})R^{a}, —NR^{a}C(═NR^{a})OR^{a}, —NRC(═NR^{a})SR^{a}, —NR^{a}C(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n1 is 0, 1, 2, 3, 4, or 5, as valency permits;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})³;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
n3 is 0, 1, 2, 3, or 4, n4 is 0, 1, 2, 3, or 4, and at least one of n3 and n4 is 1, 2, 3, or 4; and
L¹ is substituted or unsubstituted alkylene or substituted or unsubstituted heteroalkylene;
provided that none of R¹, R², R³, R⁴, Ring A, R¹⁰, R¹¹, and L¹ comprise one or more non-aromatic unsaturated CC bonds.

9. A method of preparing the copolymer of claim 8 comprising polymerizing the homopolymer of claim 4 in the presence of I₂ and an H—I scavenger.

10-16. (canceled)

17. A copolymer comprising:
m1 instances of the first repeating unit of Formula i′: 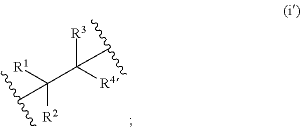
m2 instances of the second repeating unit of Formula ii-A or ii-B: 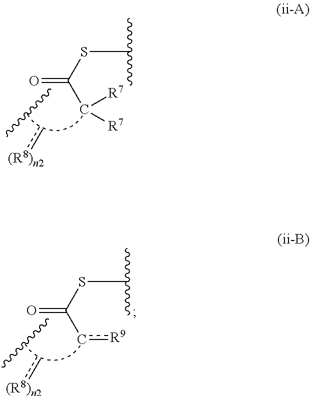
m3′ instances of a crosslinker, wherein the crosslinker is a polyradical of a small molecule, wherein the polyradical is at least tetravalent; and
optionally one or more types of additional repeating units;
wherein:
the copolymer is substantially crosslinked;
m1 is an integer between 10 and 1,000,000, inclusive;
m2 is an integer between 2 and 1,000,000, inclusive;
R¹, R², and R³ are each independently hydrogen, halogen, or substituted or unsubstituted alkyl;
R⁴′ is halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{a}, —SCN, —SR^{a}, —SSR^{a}, —N₃, —NO, —N(R^{a})₂, —NO₂, —C(═O)R^{a}, —C(═O)OR^{a}, —C(═O)SR^{a}, —C(═O)N(R^{a})₂, —C(═NR^{a})R^{a}, —C(═NR^{a})OR^{a}, —C(═NR^{a})SR^{a}, —C(═NR^{a})N(R^{a})₂, —S(═O)R^{a}, —S(═O)OR^{a}, —S(═O)SR^{a}, —S(═O)N(R^{a})₂, —S(═O)₂R^{a}, —S(═O)₂OR^{a}, —S(═O)₂SR^{a}, —S(═O)₂N(R^{a})₂, —OC(═O)R^{a}, —OC(═O)OR^{a}, —OC(═O)SR^{a}, —OC(═O)N(R^{a})₂, —OC(═NR^{a})R^{a}, —OC(═NR^{a})OR^{a}, —OC(═NR^{a})SR^{a}, —OC(═NR^{a})N(R^{a})₂, —OS(═O)R^{a}, —OS(═O)OR^{a}, —OS(═O)SR^{a}, —OS(═O)N(R^{a})₂, —OS(═O)₂R^{a}, —OS(═O)₂OR^{a}, —OS(═O)₂SR^{a}, —OS(═O)₂N(R^{a})₂, —ON(R^{a})₂, —SC(═O)R^{a}, —SC(═O)OR^{a}, —SC(═O)SR^{a}, —SC(═O)N(R^{a})₂, —SC(═NR^{a})R^{a}, —SC(═NR^{a})OR^{a}, —SC(═NR^{a})SR^{a}, —SC(═NR^{a})N(R^{a})₂, —NR^{a}C(═O)R^{a}, —NR^{a}C(═O)OR^{a}, —NRC(═O)SR^{a}, —NR^{a}C(═O)N(R^{a})₂, —NR^{a}C(═NR^{a})R^{a}, —NR^{a}C(═NR^{a})OR^{a}, —NR^{a}C(═NR^{a})SR^{a}, —NRC(═NR^{a})N(R^{a})₂, —NR^{a}S(═O)R^{a}, —NR^{a}S(═O)OR^{a}, —NR^{a}S(═O)SR^{a}, —NR^{a}S(═O)N(R^{a})₂, —NR^{a}S(═O)₂R^{a}, —NR^{a}S(═O)₂OR^{a}, —NR^{a}S(═O)₂SR^{a}, —NR^{a}S(═O)₂N(R^{a})₂, —Si(R^{a})₃, —Si(R^{a})₂OR^{a}, —Si(R^{a})(OR^{a})₂, —Si(OR^{a})₃, —OSi(R^{a})₃, —OSi(R^{a})₂OR^{a}, —OSi(R^{a})(OR^{a})₂, or —OSi(OR^{a})₃;
each instance of R^{a} is independently hydrogen, substituted or unsubstituted alkyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
each instance of R⁷ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃; [symbol]
is alkylene, alkenylene, alkynylene, heteroalkylene, heteroalkenylene, or heteroalkynylene;
n2 is an integer between 0 and 14, inclusive, as valency permits;
each instance of [symbol] is independently a single or double bond;
each instance of R⁸ is independently:
when attached to a carbon atom: halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, —OSi(OR^{b})₃, ═O, ═S, or ═NR^{b};
when attached to a nitrogen atom: substituted or substituted alkyl, substituted or substituted alkenyl, substituted or substituted alkynyl, substituted or substituted heteroalkyl, substituted or substituted heteroalkenyl, substituted or substituted heteroalkynyl, substituted or substituted carbocyclyl, substituted or substituted heterocyclyl, substituted or substituted aryl, substituted or substituted heteroaryl, —OR^{b}, —N(R^{b})₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, or a nitrogen protecting group; or
when attached to a sulfur atom: ═O;
and/or: R⁹ or one instance of R⁷ and one instance of R⁸ are taken together with their intervening atoms to form substituted or unsubstituted carbocyclyl, substituted or substituted heterocyclyl, substituted or substituted aryl, substituted or substituted heteroaryl, and/or two instances of R⁸ are taken together with their intervening atom or atoms to form substituted or unsubstituted carbocyclyl, substituted or substituted heterocyclyl, substituted or substituted aryl, substituted or substituted heteroaryl; and
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom;
provided that if the first repeating unit is of the formula: 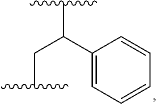
and the crosslinker is of the formula: 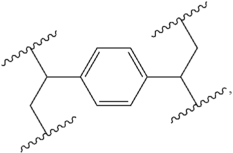 [SMILES: *CC(*)c1ccc(C(*)C*)cc1]
then the second repeating unit is not of the formula:

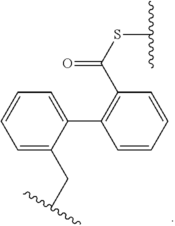

18. The copolymer of claim 17 prepared by a method comprising polymerizing a first monomer, a second monomer, a third monomer, and optionally one or more additional monomers, wherein:
the first monomer is of Formula I′: 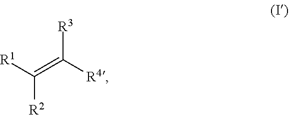
or a tautomer or salt thereof;
the second monomer is of Formula II-A or II-B: 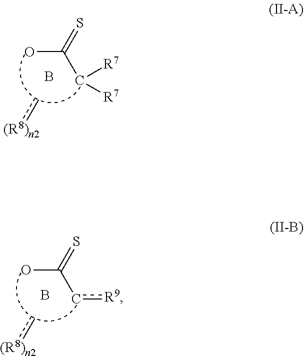
or a tautomer or salt thereof, wherein 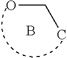
is Ring B, and Ring B is a heterocyclic ring; and
the third monomer is a small molecule comprising two or more non-aromatic unsaturated CC bonds;
provided that if the first monomer is unsubstituted styrene, and the third monomer is unsubstituted 1,4-divinylbenzen, then the second monomer is not of the formula: 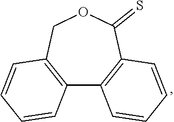 [SMILES: S=C1OCc2ccccc2-c2ccccc21]
or a tautomer thereof.

19. A method of preparing the copolymer of claim 18 comprising polymerizing the first monomer, the second monomer, the third monomer, and optionally one or more types of the additional monomers.

20-89. (canceled)

90. A compound of the formula: 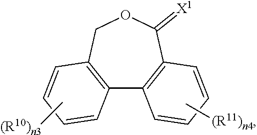
or a tautomer or salt thereof, wherein:
X¹ is S or O;
each instance of R¹⁰ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}S(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R¹¹ is independently halogen, substituted or unsubstituted alkyl, substituted or unsubstituted carbocyclyl, substituted or unsubstituted heterocyclyl, substituted or unsubstituted aryl, substituted or unsubstituted heteroaryl, —CN, —OR^{b}, —SCN, —SR^{b}, —SSR^{b}, —N₃, —NO, —N(R^{b})₂, —NO₂, —C(═O)R^{b}, —C(═O)OR^{b}, —C(═O)SR^{b}, —C(═O)N(R^{b})₂, —C(═NR^{b})R^{b}, —C(═NR^{b})OR^{b}, —C(═NR^{b})SR^{b}, —C(═NR^{b})N(R^{b})₂, —S(═O)R^{b}, —S(═O)OR^{b}, —S(═O)SR^{b}, —S(═O)N(R^{b})₂, —S(═O)₂R^{b}, —S(═O)₂OR^{b}, —S(═O)₂SR^{b}, —S(═O)₂N(R^{b})₂, —OC(═O)R^{b}, —OC(═O)OR^{b}, —OC(═O)SR^{b}, —OC(═O)N(R^{b})₂, —OC(═NR^{b})R^{b}, —OC(═NR^{b})OR^{b}, —OC(═NR^{b})SR^{b}, —OC(═NR^{b})N(R^{b})₂, —OS(═O)R^{b}, —OS(═O)OR^{b}, —OS(═O)SR^{b}, —OS(═O)N(R^{b})₂, —OS(═O)₂R^{b}, —OS(═O)₂OR^{b}, —OS(═O)₂SR^{b}, —OS(═O)₂N(R^{b})₂, —ON(R^{b})₂, —SC(═O)R^{b}, —SC(═O)OR^{b}, —SC(═O)SR^{b}, —SC(═O)N(R^{b})₂, —SC(═NR^{b})R^{b}, —SC(═NR^{b})OR^{b}, —SC(═NR^{b})SR^{b}, —SC(═NR^{b})N(R^{b})₂, —NR^{b}C(═O)R^{b}, —NR^{b}C(═O)OR^{b}, —NR^{b}C(═O)SR^{b}, —NR^{b}C(═O)N(R^{b})₂, —NR^{b}C(═NR^{b})R^{b}, —NR^{b}C(═NR^{b})OR^{b}, —NR^{b}C(═NR^{b})SR^{b}, —NR^{b}C(═NR^{b})N(R^{b})₂, —NR^{b}C(═O)R^{b}, —NR^{b}S(═O)OR^{b}, —NR^{b}S(═O)SR^{b}, —NR^{b}S(═O)N(R^{b})₂, —NR^{b}S(═O)₂R^{b}, —NR^{b}S(═O)₂OR^{b}, —NR^{b}S(═O)₂SR^{b}, —NR^{b}S(═O)₂N(R^{b})₂, —Si(R^{b})₃, —Si(R^{b})₂OR^{b}, —Si(R^{b})(OR^{b})₂, —Si(OR^{b})₃, —OSi(R^{b})₃, —OSi(R^{b})₂OR^{b}, —OSi(R^{b})(OR^{b})₂, or —OSi(OR^{b})₃;
each instance of R^{b} is independently hydrogen, substituted or unsubstituted alkyl, substituted or unsubstituted alkenyl, substituted or unsubstituted alkynyl, substituted or unsubstituted carbocyclyl, substituted or unsubstituted heterocyclyl, substituted or unsubstituted aryl, substituted or unsubstituted heteroaryl, a nitrogen protecting group when attached to a nitrogen atom, an oxygen protecting group when attached to an oxygen atom, or a sulfur protecting group when attached to a sulfur atom; and
n3 is 0, 1, 2, 3, or 4, n4 is 0, 1, 2, 3, or 4, and at least one of n3 and n4 is 1, 2, 3, or 4;
provided that no instance of R¹⁰ and R¹¹ comprises one or more non-aromatic unsaturated CC bonds.

91-100. (canceled)

101. A homopolymer prepared by a method comprising polymerizing a compound of claim 90, or a tautomer or salt thereof.

102-107. (canceled)

108. A composition comprising:
a copolymer of any one of claim 1; and
optionally an excipient.

109. A composition comprising:
a compound of claim 90, or a tautomer or salt thereof; and
optionally an excipient.

110. A composition comprising:
a homopolymer of claim 4; and
optionally an excipient.

111. A kit comprising:
a copolymer of claim 1; and
instructions for using the copolymer.

112. A kit comprising:
a compound of claim 90, or a tautomer or salt thereof; and
instructions for using the compound, tautomer, or salt.

113. A kit comprising:
a homopolymer of claim 4; and
instructions for using the homopolymer.

114. A method of degrading a copolymer of claim 1 comprising reacting the copolymer with a nucleophile.

115-120. (canceled)

121. A composition comprising:
a copolymer of claim 8; and
optionally an excipient.

122. A kit comprising:
a copolymer of claim 8; and
instructions for using the copolymer.

123. A method of degrading a copolymer of claim 8 comprising reacting the copolymer with a nucleophile.

124. A composition comprising:
a copolymer of claim 17; and
optionally an excipient.

125. A kit comprising:
a copolymer of claim 17; and
instructions for using the copolymer.

126. A method of degrading a copolymer of claim 17 comprising reacting the copolymer with a nucleophile.

127. A method of degrading a homopolymer of claim 4 comprising reacting the homopolymer with a nucleophile.

128. A composition comprising:
a homopolymer of claim 101; and
optionally an excipient.

129. A kit comprising:
a homopolymer of claim 101; and
instructions for using the homopolymer.

130. A method of degrading a homopolymer of claim 101 comprising reacting the homopolymer with a nucleophile.
